(19) United States
(12) Patent Application Publication
(10) Pub. No.: US 2025/0282196 A1
(43) Pub. Date: Sep. 11, 2025

(54) VEHICLE CLIMATE CONTROL SYSTEM UTILIZING A FLEXIBLE HEAT PUMP

(71) Applicant: HONEYWELL INTERNATIONAL INC., Charlotte, NC (US)

(72) Inventors: Sanmao BAI, Shanghai (CN); Curt VINCENT, Grand Rapids, MI (US); Michael PETERSEN, Buffalo, NY (US); Tao LIU, Shanghai (CN); Nilesh PUROHIT, Charlotte, NC (US)

(73) Assignee: HONEYWELL INTERNATIONAL INC., Charlotte, NC (US)

(21) Appl. No.: 19/074,282

(22) Filed: Mar. 7, 2025

Related U.S. Application Data
(60) Provisional application No. 63/563,252, filed on Mar. 8, 2024.
(60) Provisional application No. 63/635,746, filed on Apr. 18, 2024.
(60) Provisional application No. 63/635,747, filed on Apr. 18, 2024.
(60) Provisional application No. 63/665,190, filed on Jun. 27, 2024.
(60) Provisional application No. 63/666,460, filed on Jul. 1, 2024.
(60) Provisional application No. 63/666,464, filed on Jul. 1, 2024.

(51) Int. Cl. B60H 1/00

(52) U.S. Cl. CPC B60H 1/00007; B60H 1/00278

(57) ABSTRACT

A heat transfer system to alternatively and/or simultaneously provide heating and cooling in a mobile vehicle that includes an electrical power source requiring heating and/or cooling during charging and/or operation and that includes a cabin that requires heat input during low temperature ambient conditions.

### CROSS REFERENCE TO RELATED APPLICATIONS

The present invention is related to and claims the priority benefit of U.S. Provisional Application No. 63/563,252, filed Mar. 8, 2024 and of U.S. Provisional Application No. 63/635,746, filed Apr. 18, 2024 and of U.S. Provisional Application No. 63/635,747, filed Apr. 18, 2024 and of U.S. Provisional Application No. 63/665,190, filed Jun. 27, 2024 and of U.S. Provisional Application No. 63/666,460, filed Jul. 1, 2024 and of U.S. Provisional Application No. 63/666,464, filed Jul. 1, 2024, each of which is incorporated herein by reference in their entirety.

### FIELD

The present invention relates to thermal management systems for electric vehicles and in particular to a flexible and efficient climate control system arrangement and method utilizing a heat pump for such vehicles.

### BACKGROUND

A vehicle, such as a car or truck, which is propelled solely by one or more electric motors, sometimes referred to as a traction motor, is typically referred to as an electric vehicle or an EV. In a hybrid electric vehicle, or HEV, one or more traction motors are used in conjunction with another power source, such as for example an internal combustion engine, including both gasoline and diesel-powered engines. In both cases, a battery or capacitor bank carried by the vehicle during operation provides an electrical current to the traction motor and other components that are driven by an electric current and which will generally generate heat during operations.

Because the propulsion systems of EVs do not include an internal combustion engine, a traditional internal combustion engine cooling system is not present, and therefore hot liquid coolant is unavailable for heating the interior of the cabin, cab, or passenger compartment of the vehicle. Although an internal combustion engine is included in HEVs, there are times when it may be desirable to operate the HEV without running the internal combustion engine, in which case heat may be unavailable from circulating hot liquid coolant to heating the interior of the cabin, cab, or passenger compartment. Furthermore, it is frequently required that, in addition to the need to heat the cabin, cab, or passenger compartment for the comfort of the occupants, heat is frequently also required to defrost the vehicle windows.

The development of a thermal management system to handle the heating and cooling needs of EVs and HEVs is challenging for several reasons. For example, it has been known to provide another source of heat, such as electric heaters, in EVs to provide at least some of the heat needed by the vehicle as described above. Such electric heaters, however, typically draw electric current from the same on-board source of electricity that supplies current to the traction motor that is used to propel the vehicle. It can be a disadvantage to require the use of such a heating source since it can limit the range of the EV or limit the number of miles in which an HEV is propelled by the traction motor.

Another challenge associated with the development of EVs and HEVs thermal management systems is that such systems also require the ability to cool the cabin, cab, or passenger compartment during warmer weather. In conventional non-electric vehicles, such air conditioning is provided by a compressor that is mechanically driven by the internal combustion engine. Because an EV lacks an internal combustion engine, and because the internal combustion engine of a hybrid electric vehicle may be turned off for periods of time, it is desirable to provide an alternate source of cooling for the cab, cabin, or passenger compartment for such vehicles when air conditioning is desired.

Another challenge involves the potential need to manage the temperature of the battery and/or other electrical components of EVs, and potentially for some HEVs, when the vehicle is stationary, and the battery is being charged by an external source of electrical current, such as would occur at a charging station.

Therefore, heating and cooling of the cab, cabin, or passenger compartment of an EV or an HEV, including defrosting of the vehicle windows, is a challenging task that should provide effective and efficient thermal operation while having the lowest possible impact on the range of the vehicle or on environmental performance of the EV or HEV.

### SUMMARY

The present invention provides heat transfer systems to alternatively and/or simultaneously provide heating and cooling in a mobile vehicle that includes an electrical power source requiring temperature regulation during operation and that includes a cabin that requires heat input during low temperature ambient conditions, said system comprising:
a) a vapor compression refrigeration circuit located in said mobile vehicle comprising:
   (i) a heat transfer composition comprising a first refrigerant,
   (ii) a compressor for compressing said first refrigerant in the vapor state from a first pressure to a higher second pressure, said compressor optionally but preferably being connected upstream to a refrigerant accumulator,
   (iii) an inner condenser for selectively condensing during low temperature ambient conditions at least a portion of said first refrigerant vapor from said compressor by rejecting heat to said cabin,
   (iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
   (v) a first OCE (as defined hereinafter) connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
   (vi) an inside heat exchanger fluidly connectable to said refrigerant downstream of said inner condenser for selectively heating a flow of cabin air;
   (vii) a chiller fluidly connectable to said refrigerant downstream of said inner condenser for selectively heating a flow of liquid coolant;
   (viii) a bypass channel system connected upstream of said first open/closed/expansion device and downstream of said outside heat exchanger for selectively routing said refrigerant from said inner condenser and/or from said outside heat exchanger: (1) around said first expansion device and to either (A) a second OCE fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first OCE operating in the expansion mode through said outside heat exchanger to said accumulator;
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

For the purposes of convenience, the heat transfer system as described in this paragraph is referred to for convenience as Heat Transfer System 1A.

The present invention also provides heat transfer systems as described herein, including Heat Transfer System 1, in which the refrigerant used in the vapor compression refrigeration circuit comprises, or consists essentially of, or consists of, on a weight basis, HFO-1234yf. For the purposes of convenience, the heat transfer system as described in this paragraph is referred to for convenience as Heat Transfer System 1B.

The present invention also provides heat transfer systems as described herein, including Heat Transfer System 1, in which the refrigerant used in the vapor compression refrigeration circuit comprises, or consists essentially of, or consists of, on a weight basis, HFO-1234ze(E). For the purposes of convenience, the heat transfer system as described in this paragraph is referred to for convenience as Heat Transfer System 1C.

The present invention also provides heat transfer systems as described herein, including Heat Transfer System 1, in which the refrigerant used in the vapor compression refrigeration circuit comprises, or consists essentially of, or consists of, on a weight basis, about 21.5% of R32 and about 78.5% of R1234yf. For the purposes of convenience, the heat transfer system as described in this paragraph is referred to for convenience as Heat Transfer System 2A.

The present invention also provides heat transfer systems as described herein, including Heat Transfer System 1, in which the refrigerant used in the vapor compression refrigeration circuit comprises, or consists essentially of, or consists of, on a weight basis, about 3% of carbon dioxide (CO₂), about 21.5% of R32 and about 75.5% of R1234yf. For the purposes of convenience, the heat transfer system as described in this paragraph is referred to for convenience as Heat Transfer System 2B.

The present invention also provides heat transfer systems as described herein, including Heat Transfer System 1, in which the refrigerant used in the vapor compression refrigeration circuit comprises, or consists essentially of, or consists of, on a weight basis, about 23% of R1132(E) and about 77% of R1234yf. For the purposes of convenience, the heat transfer system as described in this paragraph is referred to for convenience as Heat Transfer System 2C.

The present invention also provides heat transfer systems as described herein, including Heat Transfer System 1, in which the refrigerant used in the vapor compression refrigeration circuit comprises, or consists essentially of, or consists of, on a weight basis, about 31.5% of R1132(E) and about 68.5% of R1234yf. For the purposes of convenience, the heat transfer system as described in this paragraph is referred to for convenience as Heat Transfer System 2D.

The present invention also provides heat transfer systems as described herein, including Heat Transfer System 1, in which the refrigerant used in the vapor compression refrigeration circuit comprises, or consists essentially of, or consists of, on a weight basis, about 8.5% of R134a and about 77.5% of R1234yf. For the purposes of convenience, the heat transfer system as described in this paragraph is referred to for convenience as Heat Transfer System 3A.

The present invention also provides heat transfer systems as described herein, including Heat Transfer System 1, in which the refrigerant used in the vapor compression refrigeration circuit comprises, or consists essentially of, or consists of, on a weight basis, about 5% of R152a, about 12% of R32 and about 83% of R1234ze(E). For the purposes of convenience, the heat transfer system as described in this paragraph is referred to for convenience as Heat Transfer System 3B.

The present invention also provides heat transfer systems as described herein, including Heat Transfer System 1, in which the refrigerant used in the vapor compression refrigeration circuit comprises, or consists essentially of, or consists of, on a weight basis, about 78% of R1234yf, about 14.5% of R152a, and about 7.5% of R32. For the purposes of convenience, the heat transfer system as described in this paragraph is referred to for convenience as Heat Transfer System 3C.

The present invention also provides heat transfer systems as described herein, including Heat Transfer System 1, in which the refrigerant used in the vapor compression refrigeration circuit comprises, or consists essentially of, or consists of, on a weight basis, about 82% of R1234yf, about 14% of R152a, and about 4% of R32. For the purposes of convenience, the heat transfer system as described in this paragraph is referred to for convenience as Heat Transfer System 3D.

The present invention also provides heat transfer systems as described above including Heat Transfer Systems 1-3, in which the heat exchange network comprises a coolant circuit that comprises a coolant that absorbs waste heat from an electrical power source located in said vehicle during low temperature ambient conditions and rejects heat to said refrigerant in said chiller.

As used herein, reference to a “Heat Transfer System No.” is an explicit reference to all heat transfer systems having that number, including all heat transfer systems with that number, including any suffix. For example, reference to “Heat Transfer System 1” is a reference to each of Heat Transfer System 1A, 1B and 1C

The systems of the present invention, including each of Heat Transfer Systems 1-3 are particularly well adapted to operate with system pressures that are similar to the pressures that have been present in vapor compression systems that use the refrigerants R-134a, R404A, R22, R507 and R407, but without the substantial environmental disadvantages associated with the use of those refrigerants.

The systems of the present invention, including particularly each of Heat Transfer Systems 2 are particularly well adapted to operate with system pressures that are similar to the pressures that have been present in vapor compression systems that use the refrigerants R404A, R22, R507 and R407, but without the substantial environmental disadvantages associated with the use of those refrigerants.

The systems of the present invention, including particularly each of Heat Transfer Systems 3 are particularly well adapted to operate with system pressures that are similar to the pressures that have been present in vapor compression systems that use the refrigerant R-134a, but without the substantial environmental disadvantages associated with the use of those refrigerants.

As used herein, the term “waste heat from an electrical power source” refers to heat that needs to be and/or can removed from an on-board battery or an electrically powered device or article powered by the on-board battery or an off-board source of electrical power, such as the charging source that is being used to charge the batter. By way of example, such devices include the vehicle battery, motor, inverter and other electrical devices carried by the vehicle.

### BRIEF DESCRIPTION OF THE DRAWINGS

FIG. 1 illustrates a schematic of a thermal management system for an EV or HEV according to one example of the present invention.

FIGS. 2A and 2B illustrate a schematic of a thermal management system for an EV or HEV according to a second example of the present invention.

FIG. 3A illustrates a respective schematic of an exemplary thermal management system, generally as illustrated in FIG. 2.

FIGS. 3B-3C, illustrate preferred generalized alternative modes of operation of the respective schematic generally illustrated in FIG. 3.

FIGS. 3D and 3D1, 3D2-1, 3D2-2, 3D2-3, 3D3-1, 3D3-2, 3F and 3G illustrate a preferred generalized alternative modes of operation of the respective schematic generally illustrated in FIG. 2.

FIG. 3E illustrates the COP and Capacity data from Example 1A.

FIGS. 4-31 illustrate respective schematics of the thermal management system, generally as illustrated in FIG. 2 and FIGS. 3A-3D, for a series of different operating modes as described in Examples 1-30 hereof.

FIGS. 32A and 32B illustrate that data from Example 1B1.

FIGS. 33A and 33B illustrate that data from Example 1B2.

FIGS. 34A and 34B illustrate that data from Example 1B3.

FIGS. 35A and 35B illustrate that data from Example 1B4.

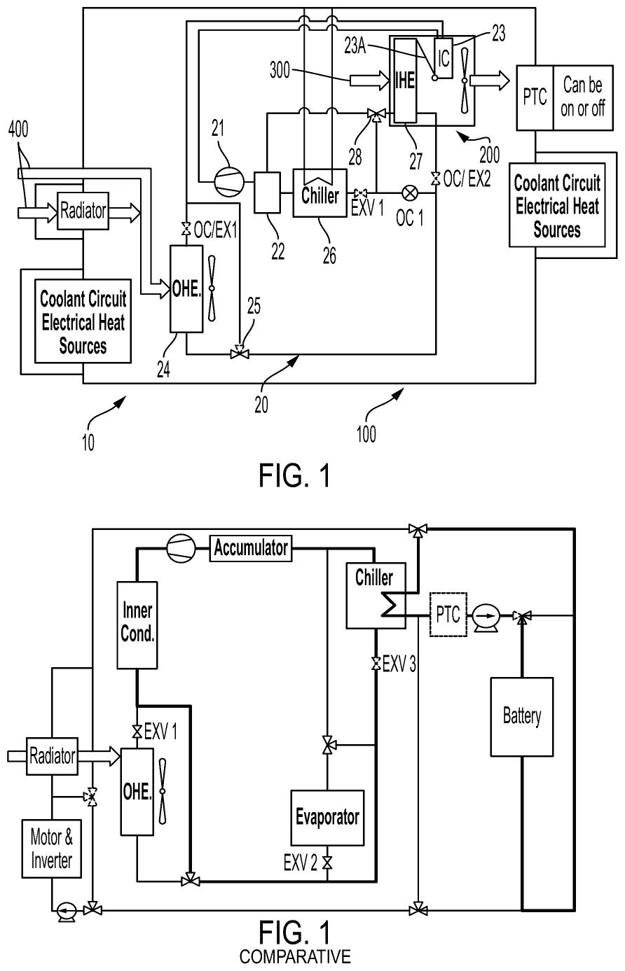

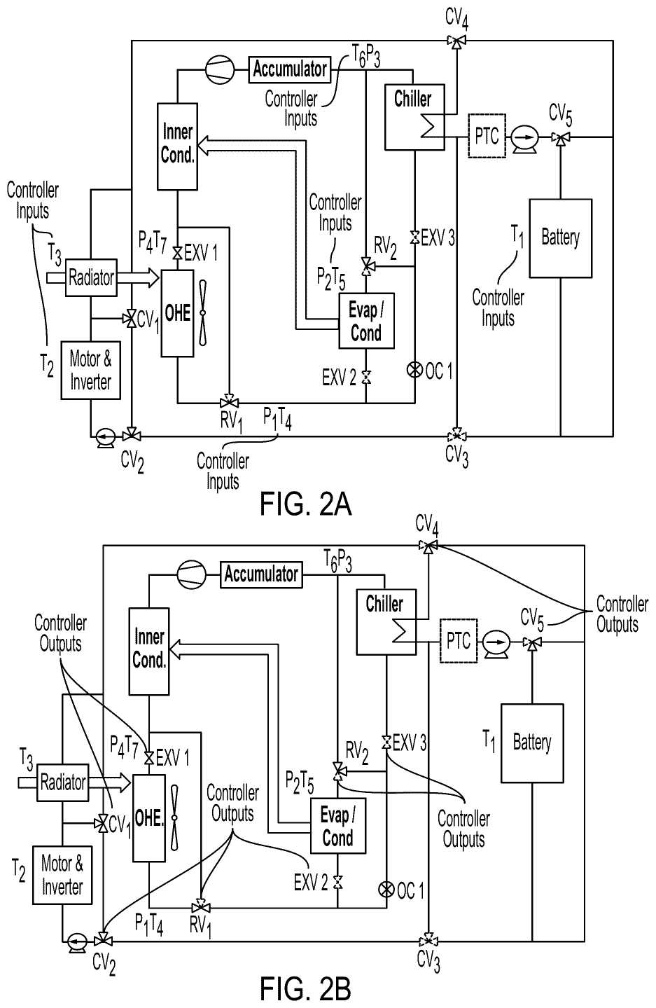

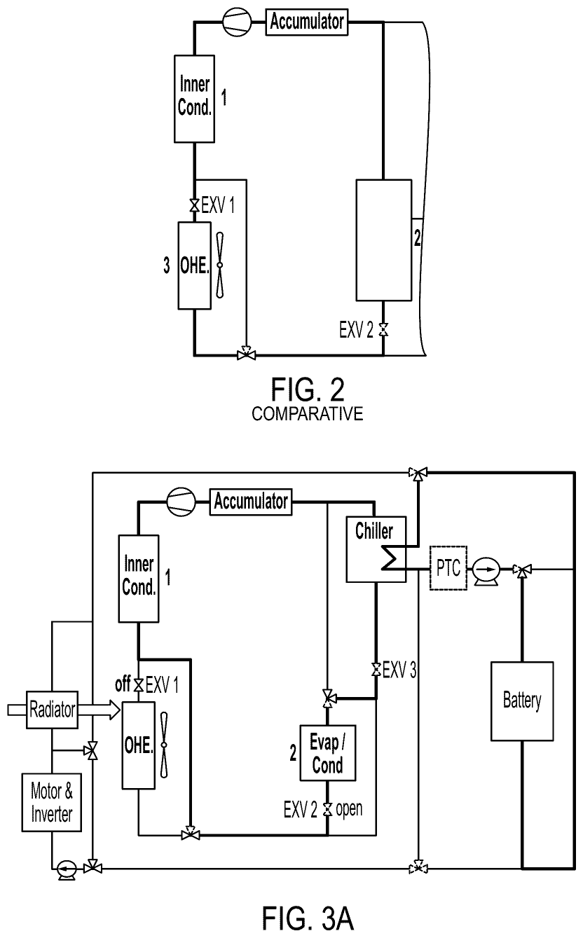

Comparative FIG. 1 and Comparative FIG. 2 illustrate schematics of comparative thermal management systems according to Comparative Examples 1 and Comparative Examples 2.

### Definitions

The phrase “coefficient of performance” (herein abbreviated as “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration, cooling or heating capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R.C. Downing, FLUOROCARBON REFRIGERANTS HANDBOOK, Chapter 3, Prentice-Hall, 1988 which is incorporated herein by reference in its entirety).

The phrase “Global Warming Potential” (herein abbreviated as “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 20141, referred to and abbreviated herein as AR4, except for components that did not have a GWP value measured in AR4 (such as R1234yf), then the values used are according to the Fifth Assessment Report.

As used herein, the terms “positive temperature coefficient heater,” “PTC heater” and “PTC” mean a heating device that provides heat via electrical current input, including preferably a heating device that comprises a ceramic heating element with a positive temperature coefficient.

As used herein, the term OCE refers to a device, such as a valve, that can operate in the open position, the closed position and in an expansion mode in which it operates, for example, as an expansion orifice or valve.

As used herein, the terms 1234yf and R1234yf mean 2,3,3,3-tetrafluoropropene.

As used herein, the terms 1234ze(E) and R1234ze(E) mean the trans isomer of 1,3,3,3-tetrafluoropropene.

As used herein, the terms “R-134a” and “HFC-134a” as used herein each mean 1,1,1,2-tetrafluoroethane.

As used herein, the terms “R-152a” and “HFC-152a” as used herein each mean 1,1-difluoroethane.

As used herein, the terms “R-1132 (E)” and “HFC-1132 (E)” as used herein each mean the trans isomer of 1,2-difluoroethylene. As used herein, the terms “R-32” and “HFC-32” as used herein each mean difluoromethane.

As used herein, the terms “R1132(E)” and “transHFO-1132 (E)” each means the trans isomer of 1,2-difluorethylene.

¹ Myhre, G., D. Shindell, F.-M. Breon, W. Collins, J. Fuglestvedt, J. Huang, D. Koch, J.-F. Lamarque, D. Lee, B. Mendoza, T. Nakajima, A. Robock, G.

Stephens, T. Takemura and H. Zhang, 2013: Anthropogenic and Natural Radiative Forcing. In: Climate Change 2013: The Physical Science Basis.

Contribution of Working Group I to the Fifth Assessment Report of the Intergovernmental Panel on Climate Change [Stocker, T. F., D. Qin, G.-K.

Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA.

https://www.ipcc.ch/pdf/assessmentreport/ar5/wg1/WG1AR5_Chapter08_FINAL.pdf (p. 73-79)

As used herein, the term “R454C” means the refrigerant designated by ASHRAE as 454C and which consists of 21.5%+2/-2% of R-32 and 78.5-+2/-2% of HFC-1234yf.

As used herein, the term “R455A” means the refrigerant designated by ASHRAE as 455A and which consists of 21.5%+2/−1% of R-32, 75.5 of HFC-1234yf+2/−2% and 3%+2/−1% of CO₂.

As used herein, the term “R474A” means the refrigerant designated by ASHRAE as 474A and which consists of about 23% of R-1132 (E) and about 77% of R-1234yf.

As used herein, the term “R474B” means the refrigerant designated by ASHRAE as 474A and which consists of about 31.5% of R-1132 (E) and about 68.5% of R-1234yf.

As used herein, the term “R516A” means the refrigerant designated by ASHRAE as 516A and which consists of about 77.5% of R-1234yf, about 8.5% of R-134a and about 14% R152a.

As used herein, the term “R444A” means the refrigerant designated by ASHRAE as 444A and which consists of about 83% of R-1234ze(E), about 12% of R-32 and about 5% of R-152a.

As used herein, the term “R457C” means the refrigerant designated by ASHRAE as 457C and which consists of about 78% of R-1234yf, about 7.5% of R-32 and about 14.5% R152a.

As used herein, the term “R457D” which consists of about 82% of R-1234ze, about 4% of R-32 and about 14% R152a.

### DETAILED DESCRIPTION

An exemplary thermal management system according to the present invention is illustrated in FIG. 1 hereof. The thermal management system, including the components of the EV of HEV being heated or cooled, are designated generally as 10, and includes an area in which one or more persons would travel, which is referred to generally herein as the “cabin” (not shown) and areas outside the cabin which will generally house the working components of the EV or HEV. Portions of the various thermal management systems of the present invention may be located within the cabin and/or outside the cabin.

The system 10 of the present invention includes heat pump subsystem, which preferably comprises a vapor compression system, designated generally as 20, thermally interconnected with a coolant circuit, designated generally as 100, a cabin climate control module 200 and potentially also independently fluidly connected with a source of ambient air, designated as 300. It will be understood that since some of the components of the vapor compression circuit interface with some components of the coolant circuit and the climate control module 200, those portions may be properly designated as components of each of those portions of the system.

In particular, the heat pump vapor compression system includes a refrigerant, preferably R-1234ze(E), R-1234yf or blends that comprise R-1234yf, or 1234ze(E) or blends that comprise R-1234ze(E) as described herein, that circulates to various components of the present invention, a compressor 21, optionally but preferably an accumulator 22 on the suction side of the compressor and inner condenser 23 located in the climate control module 200. Although it is contemplated that the specific heat exchanger used to for the inner condenser can vary widely according to the particular needs of a particular application, in some embodiments, particularly in which the heating mode of the system is especially important, it is preferred that a four-pass or higher configuration is used, since applicants have found that such a configuration can provide unexpected levels of improvement in COP performance and capacity performance in the heating mode, as well as possible lower compressor discharge temperatures and pressures. The climate control module 200 preferably includes a door 23A on the inner condenser 23 which can be moved to any position between a fully closed position (as shown) in which no cabin air which enters the control module can flow through the inner condenser to a fully open position in which the door permits air from the cabin to flow fully through the inner condenser and to be heated as it condenses at least a portion of the refrigerant which flows into the condenser from the discharge side of the compressor.

Refrigerant which exits the inner condenser is fluidly connected to an OCE (labeled as OC/EX1). The preferred OC/EX1 is a device that can be configured to take one of three possible actions: (1) change the pressure and temperature of the refrigerant flowing therethrough; (2) open fully so as to allow passage of refrigerant therethrough with minimal change in pressure or temperature; or (3) close so as to prevent the flow of refrigerant therethrough. The OCE devices that are used in the present invention may include an electronic actuator-controlled controller (see FIGS. 2A and 2B), which may cause the actuator to position the expansion device in the wide-open position, in the fully closed position, or a throttled position in which flow is permitted but at a substantially reduced pressure and temperature. The throttled position typically is a partially open position where the controller modulates the size of the valve opening to regulate flow through the device. The controller and OCE devices may be configured to continuously or periodically modulate the throttled position in response to system operating conditions. By throttling the position of the expansion device, the controller can regulate flow, pressure, temperature, and state of the refrigerant as needed.

By operating the OC/EX1 in the fully opened position, the outside heat exchanger 24 (which is located outside the passenger cabin) can be used during low temperature ambient conditions in a supplemental condensation mode to condense at least a portion of any refrigerant vapor that is not condensed in the inner condenser 23 by rejecting heat to the relatively low temperature ambient air 400 directly, or preferably indirectly after ambient air has passed through the radiator of the circulating coolant system. During periods of high temperature ambient conditions, for example, the OC/EX1 can be operated in the throttled position and the outside heat exchanger can operate as an evaporator or alternatively the outside condenser can be bypassed by operating the OCEX1 in the fully closed position, which will direct the refrigerant flow from the inner condenser through the bypass conduit and to the divert valve 25.

The refrigerant which flows through diverter valve 25 can be directed to chiller 26 and/or inner heat exchanger 27 or to bypass each of these and flow through diverter valve 28 directly to accumulator 22. An open/closed valve OC 1 may be provided downstream of diverter valve 25 and upstream of EXV1, and in the closed position blocks flow towards EXV1, thereby ensuring that refrigerant flows to OC/EX2. As an alternative in some cases, EXV1 may be provided as an OC/EV and operated in a closed position to prevent flow of refrigerant to the chiller, as illustrated in some of the examples below. A second OCE (labeled as OC/EX2) is provided upstream of the inner heat exchanger and can be operated to allow refrigerant to flow to the inner heat exchanger either in the fully open position (i.e., without substantial pressure reduction) or in the throttling mode. The OC/EX2 can also be operated in the fully closed position to prevent the flow of refrigerant to the inner heat exchanger 27.

As illustrated particularly in the following examples, the many advantages of the systems of the present include, but are not necessarily limited to:
1—eliminate or reduce condensing capacity issues in cold weather;
2—eliminate or reduce icing issues at the outside heat exchanger;
3—eliminate or reduce the need for high voltage PTC (positive temperature coefficient) heaters inside the vehicle;
4—offset heating capacity reduction in cold weather
5—battery warming with PTC, if present, in very cold weather
6—using the inside heat exchanger either as an evaporator or a condenser extension and pre warmer
7—extending the heat pump initial air temperature range for R-1234yf;
8—using the outside heat exchanger (radiator) to reject heat from components instead of the chiller
9—warming the motor and inverter for higher efficiency before cold starts;
10—using the inside condenser for dehumidification reheat, which is more efficient than using PTC;
11—ability to use all sources for the heat pump (in any combination) at the OHE or chiller;
12—ability to cool all heat sources at the Radiator
13—ability to cool all heat sources at the Chiller
14—ability to self-heat motor and inverter and battery independently.
15—ability to self-heat motor and inverter and battery in series; and
16—ability to cool the motor and inverter (at outside heat exchanger (radiator)) and battery (at chiller) concurrently.

The present invention also provides a heat transfer systems as described herein, including in the Examples below and including each of Heat Transfer System 1-3, in which the heat transfer composition further comprises a lubricant.

The present invention also provides a heat transfer systems as described herein, including in the Examples below and including each of Heat Transfer Systems 1-3, in which the heat transfer composition further comprises a polyol ester (“POE”) lubricant.

The present invention also provides a heat transfer systems as described herein, including in the Examples below and including each of Heat Transfer Systems 1-3, in which the heat transfer composition further comprises a poly vinyl ether (“PVE”) lubricant.

### EXAMPLES

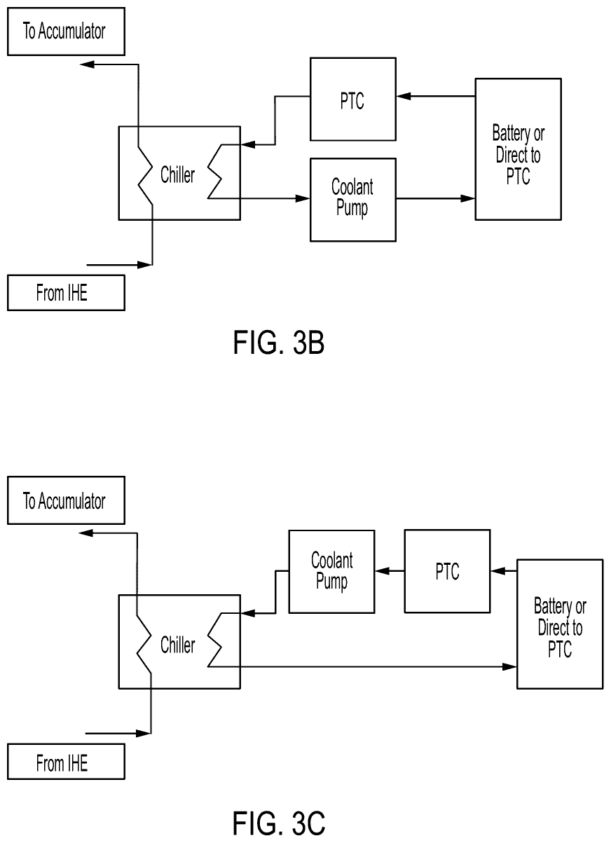

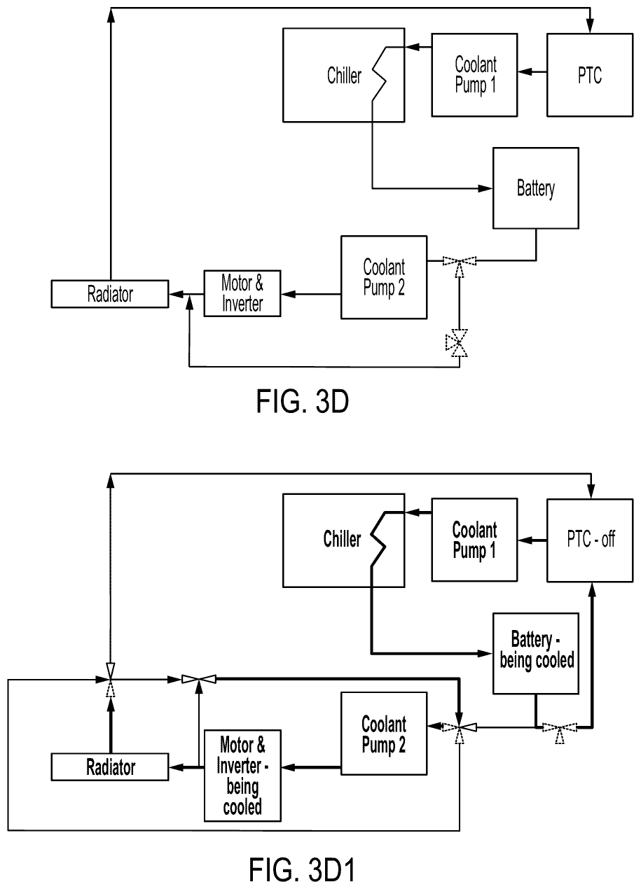

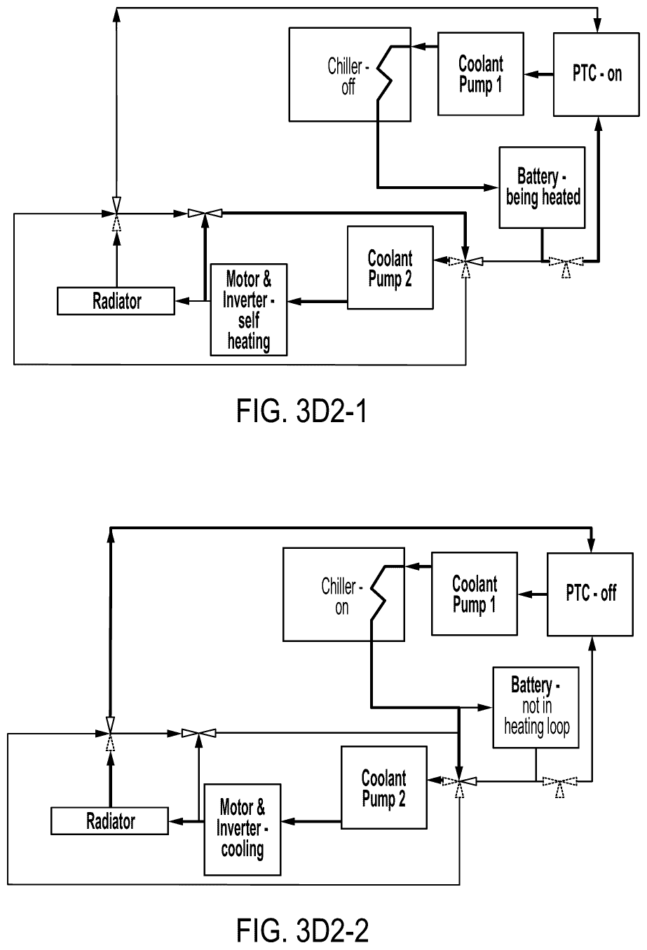

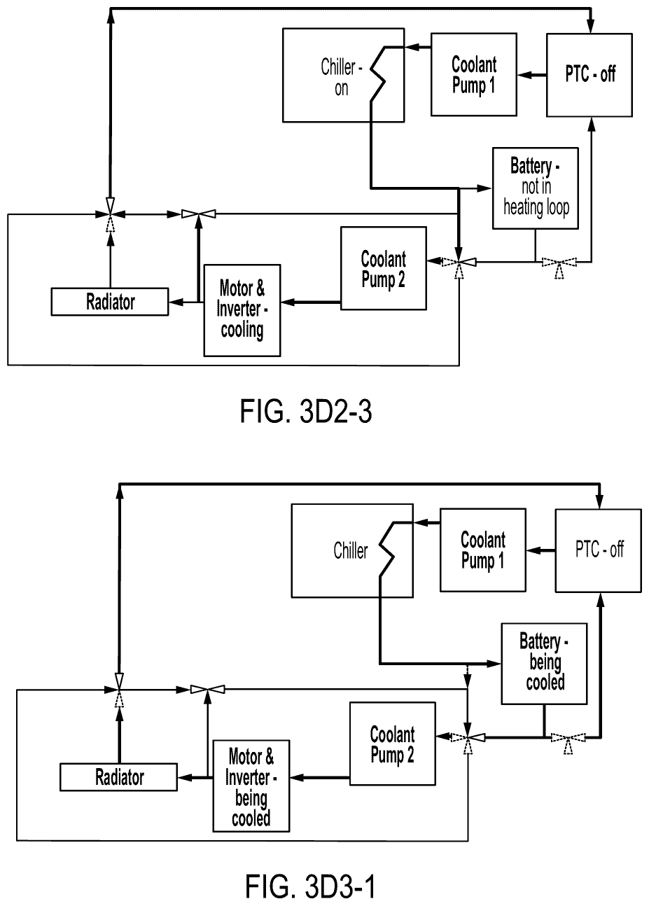

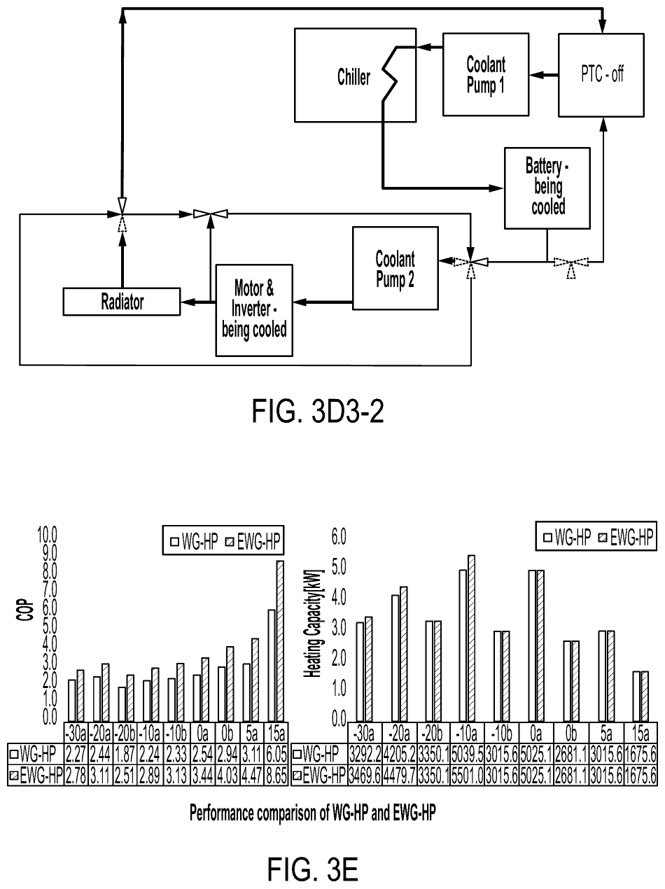

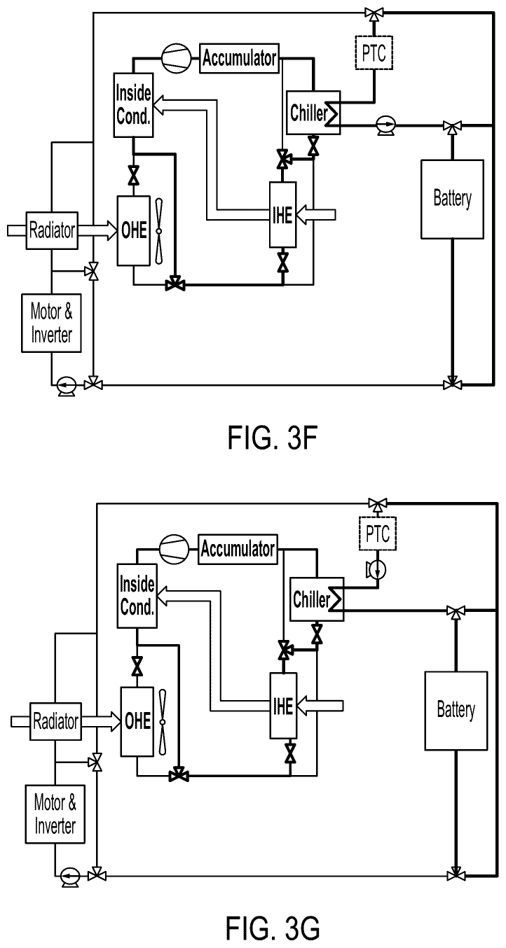

The following examples use a thermal management system according to various embodiments according to the present invention as illustrated, inter alia, in FIGS. 2A-2B and 3A-3D.

The present invention, including embodiments as illustrated in FIGS. 2A and 2B and as referenced in the following examples, is able to provide at least the following advantageous features:
A) the ability to use at least the following four sources of evaporative energy available to use for heating, via heat pump, of an electric vehicle:
   1. Waste (or excess) energy from the motor and inverter
   2. Waste (or excess) energy from the battery
   3. Electrical energy from a heater (PTC)
   4. Free energy from the environment (air)
B) two locations within the system where energy can be absorbed (as the evaporative heat source) and used by the heat pump to warm the vehicle and/or its components:
   1. The outside heat Exchanger (with airflow)
   2. The chiller (with coolant flow)

### Comparative Example 1—Heat Pump Mode to Warm Cabin Air

The operation of a typical prior heat pump system for use in an EV is illustrated in FIG. C1 using the thick solid lines to illustrate the only options available in prior art operation, and the results of the use in this configuration is used as the basis for results of the comparative data reported for this Comparative Example 1 (referred to as “CE1 data”). In this system battery waste heat is carried by a coolant (such as water/glycol for example) away from the battery and the PTC and is used as the evaporative heat source at the chiller of a vapor compression system, as shown in FIG. C1. This configuration may be effective in certain cases, but applicants have come to appreciate that in many circumstances and/or desired modes of operation, including at relatively low ambient temperature conditions, full condensing is frequently not achieved at the inner condenser 1, which detracts from the capacity and effectiveness of such systems in such situations. This Comparative Example 1 and the embodiment of the present invention described in connection with Example 1A which follows, is based upon the use of R-1234yf as the refrigerant.

### Example 1A—Heat Pump Mode with Inner Evaporator/Condenser in the Loop to Warm Cabin Air

Applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). Applicants have found that a system of the present invention as described and illustrated herein can dramatically improve performance with relatively simple and low-cost modifications that provide not only unexpectedly superior performance but also high levels of operability over a wide variety of ambient conditions and of modes of cooling and heating to be carried out by the system. The system of the present invention in accordance with this Example 1A is configured for operation to heat cabin air during periods of low ambient temperatures and is illustrated in FIG. 3A.

In this system, and in the remaining systems illustrated in the Examples, the label “Inner Cond” designates the same heat exchanger referenced in FIG. 1 as the internal condenser 23 or “IC” 23 and the heat exchanger designated as Evap/Cond designates the same heat exchanger designated as “internal heat exchanger” or “IHE” 27, as described and shown in FIG. 1 located in essentially the same relative positions and arrangement, including with presence of a door and cabin air as illustrated and explained in connection with FIG. 1. In addition, each of the Figures according to the present invention will have as needed an open/close valve to prevent the flow of refrigerant to the EXV leading to the chiller, even though such valve is not always illustrated in these figures for convenience. It will be understood that these relative positions and features are present but not always illustrated strictly for the purposes of convenience in this figure and the remaining figures to facilitate easier illustration of the system.

As illustrated in FIG. 3A, the present system allows the ability to selectively alter the flow of refrigerant from the inner condenser 1 to the inner heat exchanger 2 through an open OCE, that is, entering the heat exchanger 2 at substantially the same pressure and temperature at the exit of the inner condenser. In this way, the inner heat exchanger 2 provides additional condensing surface and at the same time serves as a preheater (with door fully open, thereby allowing the preheated cabin air to enter the inner condenser) for the cabin air entering the inner condenser.

The conditions tested and the relative capacity and effectiveness of the two systems operating in this manner are reported in the Tables 1 and 2 and illustrated for convenience as FIG. 3E, with the results from this Example 1A (using 1234yf as the refrigerant) reported as EWG-HP and the results from Comparative Example 1 (using 1234yf as the refrigerant) reported as WG-HP.

TABLE 1
Example operating conditions

| | Outdoor conditions | Indoor conditions | | | Water-Glycol Condition | |
|---|---|---|---|---|---|---|
| | Ambient/Temp | Temp | Air Flow | Target Temp | Temp WG In | |
| Test | Air In | Air In | Rate | at Outlet | Tamb + 5° C. | Flow Rate |
| Name | [° C.] | [° C.] | [kg/min] | [° C.] | [° C.] | [L/min] |
| −30a | −30 | −30 | 4 | 50/Max | −25 | 8 |
| −20a | −20 | −20 | 6 | 50 | −15 | 8 |
| −20b | | 0 | 4 | | | |
| −10a | −10 | −10 | 6 | 50 | −5 | 8 |
| −10b | −10 | 5 | 4 | 50 | −5 | 8 |
| 0a | 0 | 0 | 6 | 50 | 5 | 8 |
| 0b | | 10 | 4 | | | |
| 5a | 5 | 5 | 4 | 50 | 10 | 8 |
| 15a | 15 | 15 | 4 | 40 | 20 | 8 |

TABLE 2
Temperature and pressure data

| | WG-HP (configuration as per solid | | | | | | | | EWG-HP (configuration as per | | | | | | | |
|---|---|---|---|---|---|---|---|---|---|---|---|---|---|---|---|---|
| | thick lines in Comparative FIG. 1) | | | | | | | | thick solid lines in FIG. 3A) | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| Condition | ° C. | ° C. | ° C. | ° C. | bar | bar | bar | bar | ° C. | ° C. | ° C. | ° C. | bar | bar | bar | bar |
| −30a | 27.52 | NA | −34.47 | 27.52 | 9.56 | NA | 0.81 | 9.56 | 18.00 | 5.34 | −35.89 | 18.00 | 5.34 | 18 | 5.34 | 5.34 |
| −20a | 36.2 | NA | −25.88 | 36.2 | 11.88 | NA | 1.18 | 11.88 | 23.49 | 6.54 | −27.82 | 23.49 | 6.54 | 23.49 | 6.54 | 6.54 |
| −20b | 60.59 | NA | −23.07 | 60.59 | 20.71 | NA | 1.33 | 20.71 | 48.35 | 12.52 | −24.87 | 48.35 | 12.52 | 48.35 | 12.52 | 12.52 |
| −10a | 55.27 | NA | −15.76 | 55.27 | 18.84 | NA | 1.78 | 18.84 | 44.99 | 11.53 | −18.22 | 44.99 | 11.53 | 44.99 | 11.53 | 11.53 |
| −10b | 58.94 | NA | −13.89 | 58.94 | 19.99 | NA | 1.92 | 19.99 | 50.44 | 13.16 | −15.30 | 50.44 | 13.16 | 50.44 | 13.16 | 13.16 |
| 0a | 60.37 | NA | −6.43 | 60.37 | 20.61 | NA | 2.52 | 20.61 | 51.42 | 13.47 | −8.29 | 51.42 | 13.47 | 51.42 | 13.47 | 13.47 |
| 0b | 57.33 | NA | −4.45 | 57.33 | 19.3 | NA | 2.71 | 19.3 | 50.73 | 13.25 | −5.32 | 50.73 | 13.25 | 50.73 | 13.25 | 13.25 |
| 5a | 58.95 | NA | −0.02 | 58.95 | 19.99 | NA | 3.15 | 19.99 | 50.64 | 13.22 | −1.04 | 50.64 | 13.22 | 50.64 | 13.22 | 13.22 |
| 15a | 42.57 | NA | 10.78 | 42.57 | 13.84 | NA | 4.48 | 13.84 | 40.57 | 10.33 | 10.49 | 40.57 | 10.33 | 40.57 | 10.33 | 10.33 |

In the table above, the temperature and pressure conditions correspond to those indicated in FIGS. 2A and 2B hereof, where applicable.

From the results reported above and in FIG. 3E, it can be seen that the present thermal management system produces in this operating mode a COP on average 34.1% (22.3%-43.1%) higher than the prior heat pump systems and a heating capacity that is on average 7.0% (5.4%-9.2%) higher than the prior systems, for conditions −30a, −20a and −10a conditions.

### Examples 1B5-1B8

Example 1A is repeated, except that the refrigerant blends identified in Table E1B′ below as Refrigerants RE1B5-RE1B8 are used instead of 1234yf under the same set of conditions identified in Table 1 above. Applicants note that the use of Refrigerants RE1B5 RE1B8 in this configuration of the present invention results in system operation at pressures about the same as when using 1234yf (and also using R134a), that is, the refrigeration system operates at pressures in the ranges typically experience with prior stationary air conditioning that use the refrigerants R404A and R22. The present invention is thus shown to be capable of operating, particularly with Refrigerants RE1B1-RE1B4, within these higher pressure ranges, to achieve advantageous capacity and efficiency at such pressures while at the same time without the substantial environmental disadvantages associated with the use of those high GWP refrigerants.

TABLE E1B
REFRIGERANTS

| | | ASHRAE | COMPONENTS, WT % | | | | GWP |
|---|---|---|---|---|---|---|---|
| Example | Refrigerant | Name | CO₂ | R1234yf | R1132(E) | R32 | (AR4) |
| Ex1B1 | RE1B1 | R454C | 0 | 78.5 | 0 | 21.5 | 148 |
| Ex1B2 | RE1B2 | R455A | 3.0 | 75.5 | 0 | 21.5 | 148 |
| Ex1B3 | RE1B3 | R474A | 0.0 | 77.0 | 23 | 0 | 3 |
| Ex1B4 | RE1B4 | R474B | 0.0 | 68.5 | 31.5 | 0 | 3 |

The temperatures and pressures in the respective systems in accordance with this example operating in this manner are reported in the Tables E1B1 through E1B4, with the results using the refrigerant blends of this Example 1B reported as EWG-HP and the results from the use of the system of Comparative Example 1 (but using R1234yf of the present invention) reported as WG-HP.

TABLE E1B1
Temperature and pressure data - RE1B1 Refrigerant (R454C)

| | WG-HP HP (configuration as per solid thick | | | | | | | | EWG-HP (configuration as per thick | | | | | | | |
|---|---|---|---|---|---|---|---|---|---|---|---|---|---|---|---|---|
| | lines in Comparative FIG. 1 using 1234yf) | | | | | | | | solid lines in FIG. 3A using R454C) | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| Condition | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 9.81 | NA | 0.81 | 9.81 | 17.9 | 17.9 | −35.8 | 17.9 | 9.88 | 9.9 | 1.11 | 9.88 |
| −20a | 36.2 | NA | −25.88 | 36.2 | 12.22 | NA | 1.19 | 12.22 | 23.4 | 23.4 | −27.7 | 23.4 | 11.44 | 11.4 | 1.58 | 11.44 |
| −20b | 60.6 | NA | −23.0 | 60.6 | 21.38 | NA | 1.34 | 21.38 | 48.3 | 48.3 | −24.8 | 48.3 | 20.87 | 20.9 | 1.79 | 20.87 |
| −10a | 55.3 | NA | −15.7 | 55.3 | 19.44 | NA | 1.80 | 19.44 | 44.9 | 44.9 | −18.1 | 44.9 | 19.34 | 19.3 | 2.34 | 19.34 |
| −10b | 58.9 | NA | −13.8 | 58.9 | 20.63 | NA | 1.94 | 20.63 | 50.4 | 50.4 | −15.2 | 50.4 | 21.85 | 21.8 | 2.62 | 21.85 |
| 0a | 60.4 | NA | −6.3 | 60.4 | 21.27 | NA | 2.56 | 21.27 | 51.4 | 51.4 | −8.2 | 51.4 | 22.32 | 22.3 | 3.40 | 22.32 |
| 0b | 57.3 | NA | −4.3 | 57.3 | 19.91 | NA | 2.75 | 19.91 | 50.7 | 50.7 | −5.2 | 50.7 | 21.99 | 22.0 | 3.78 | 21.99 |
| 5a | 58.9 | NA | 0.0 | 58.9 | 20.63 | NA | 3.20 | 20.63 | 50.6 | 50.6 | −0.9 | 50.6 | 21.94 | 21.9 | 4.38 | 21.94 |
| 15a | 42.6 | NA | 10.8 | 42.6 | 14.25 | NA | 4.57 | 14.25 | 40.5 | 40.5 | 10.6 | 40.5 | 17.47 | 17.5 | 6.37 | 17.47 |

It is expected that the present thermal management system produces for each of the conditions using RE1B1 in this operating mode a COP that is about the same as or higher than the prior heat pump systems and a heating capacity that is about the same as or higher than the prior systems.

TABLE E1B2
Temperature and pressure data - RE1B2 Refrigerant (R455A)

| | WG-HP (configuration as per solid thick | | | | | | | | EWG-HP (configuration as per thick | | | | | | | |
|---|---|---|---|---|---|---|---|---|---|---|---|---|---|---|---|---|
| | lines in Comparative FIG. 1 using 1234yf) | | | | | | | | solid lines in FIG. 3A using R455A) | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| Condition | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 9.81 | NA | 0.81 | 9.81 | 17.9 | 17.9 | −35.8 | 17.9 | 11.60 | 11.6 | 1.18 | 11.60 |
| −20a | 36.2 | NA | −25.88 | 36.2 | 12.22 | NA | 1.19 | 12.22 | 23.4 | 23.4 | −27.7 | 23.4 | 13.34 | 13.3 | 1.69 | 13.34 |
| −20b | 60.6 | NA | −23.0 | 60.6 | 21.38 | NA | 1.34 | 21.38 | 48.3 | 48.3 | −24.8 | 48.3 | 23.60 | 23.6 | 1.91 | 23.60 |
| −10a | 55.3 | NA | −15.7 | 55.3 | 19.44 | NA | 1.80 | 19.44 | 44.9 | 44.9 | −18.1 | 44.9 | 21.96 | 22.0 | 2.50 | 21.96 |
| −10b | 58.9 | NA | −13.8 | 58.9 | 20.63 | NA | 1.94 | 20.63 | 50.4 | 50.4 | −15.2 | 50.4 | 24.66 | 24.7 | 2.80 | 24.66 |
| 0a | 60.4 | NA | −6.3 | 60.4 | 21.27 | NA | 2.56 | 21.27 | 51.4 | 51.4 | −8.2 | 51.4 | 25.17 | 25.2 | 3.63 | 25.17 |
| 0b | 57.3 | NA | −4.3 | 57.3 | 19.91 | NA | 2.75 | 19.91 | 50.7 | 50.7 | −5.2 | 50.7 | 24.81 | 24.8 | 4.03 | 24.81 |
| 5a | 58.9 | NA | 0.0 | 58.9 | 20.63 | NA | 3.20 | 20.63 | 50.6 | 50.6 | −0.9 | 50.6 | 24.76 | 24.8 | 4.68 | 24.76 |
| 15a | 42.6 | NA | 10.8 | 42.6 | 14.25 | NA | 4.57 | 14.25 | 40.5 | 40.5 | 10.6 | 40.5 | 19.93 | 19.9 | 6.79 | 19.93 |

It is expected that the present thermal management system produces for each of the conditions using RE1B2 in this operating mode a COP that is about the same as or higher than the prior heat pump systems and a heating capacity that is about the same as or higher than the prior systems.

TABLE E1B3
Temperature and pressure data - RE1B3 Refrigerant (R474A)

| | WG-HP (configuration as per solid thick | | | | | | | | EWG-HP (configuration as per thick solid | | | | | | | |
|---|---|---|---|---|---|---|---|---|---|---|---|---|---|---|---|---|
| | lines in Comparative FIG. 1 using 1234yf) | | | | | | | | lines in FIG. 3A using R474A) | | | | | | | |
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | Bar | bar | bar | bar |
| −30a | 27.5 | NA | −34.4 | 27.5 | 9.81 | NA | 0.81 | 9.81 | 17.9 | 17.9 | −35.8 | 17.9 | 5.70 | 5.7 | 0.76 | 5.70 |
| −20a | 36.2 | NA | −25.88 | 36.2 | 12.22 | NA | 1.19 | 12.22 | 23.4 | 23.4 | −27.7 | 23.4 | 6.69 | 6.7 | 1.19 | 6.69 |
| −20b | 60.6 | NA | −23.0 | 60.6 | 21.38 | NA | 1.34 | 21.38 | 48.3 | 48.3 | −24.8 | 48.3 | 12.88 | 12.9 | 1.24 | 12.88 |
| −10a | 55.3 | NA | −15.7 | 55.3 | 19.44 | NA | 1.80 | 19.44 | 44.9 | 44.9 | −18.1 | 44.9 | 11.85 | 11.9 | 1.64 | 11.85 |
| −10b | 58.9 | NA | −13.8 | 58.9 | 20.63 | NA | 1.94 | 20.63 | 50.4 | 50.4 | −15.2 | 50.4 | 13.54 | 13.5 | 1.84 | 13.54 |
| 0a | 60.4 | NA | −6.3 | 60.4 | 21.27 | NA | 2.56 | 21.27 | 51.4 | 51.4 | −8.2 | 51.4 | 13.86 | 13.9 | 2.39 | 13.86 |
| 0b | 57.3 | NA | −4.3 | 57.3 | 19.91 | NA | 2.75 | 19.91 | 50.7 | 50.7 | −5.2 | 50.7 | 13.64 | 13.6 | 2.67 | 13.64 |
| 5a | 58.9 | NA | 0.0 | 58.9 | 20.63 | NA | 3.20 | 20.63 | 50.6 | 50.6 | −0.9 | 50.6 | 13.60 | 13.6 | 3.10 | 13.60 |
| 15a | 42.6 | NA | 10.8 | 42.6 | 14.25 | NA | 4.57 | 14.25 | 40.5 | 40.5 | 10.6 | 40.5 | 10.61 | 10.6 | 4.53 | 10.61 |

It is expected that the present thermal management system produces for each of the conditions using RE1B3 in this operating mode a COP that is about the same as or higher than the prior heat pump systems and a heating capacity that is about the same as or higher than the prior systems.

TABLE E1B4
Temperature and pressure data - RE1B4 Refrigerant (R474B)

| | WG-HP (configuration as per solid thick | | | | | | | | EWG-HP (configuration as per thick | | | | | | | |
|---|---|---|---|---|---|---|---|---|---|---|---|---|---|---|---|---|
| | lines in Comparative FIG. 1 using 1234yf) | | | | | | | | solid lines in FIG. 3A using R474B) | | | | | | | |
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | Bar | bar | bar | bar |
| −30a | 27.5 | NA | −34.4 | 27.5 | 9.81 | NA | 0.81 | 9.81 | 17.9 | 17.9 | −35.8 | 17.9 | 9.64 | 9.6 | 1.17 | 9.64 |
| −20a | 36.2 | NA | −25.88 | 36.2 | 12.22 | NA | 1.19 | 12.22 | 23.4 | 23.4 | −27.7 | 23.4 | 11.16 | 11.2 | 1.66 | 11.16 |
| −20b | 60.6 | NA | −23.0 | 60.6 | 21.38 | NA | 1.34 | 21.38 | 48.3 | 48.3 | −24.8 | 48.3 | 20.32 | 20.3 | 1.88 | 20.32 |
| −10a | 55.3 | NA | −15.7 | 55.3 | 19.44 | NA | 1.80 | 19.44 | 44.9 | 44.9 | −18.1 | 44.9 | 18.83 | 18.8 | 2.45 | 18.83 |
| −10b | 58.9 | NA | −13.8 | 58.9 | 20.63 | NA | 1.94 | 20.63 | 50.4 | 50.4 | −15.2 | 50.4 | 21.28 | 21.3 | 2.73 | 21.28 |
| 0a | 60.4 | NA | −6.3 | 60.4 | 21.27 | NA | 2.56 | 21.27 | 51.4 | 51.4 | −8.2 | 51.4 | 21.74 | 21.7 | 3.53 | 21.74 |
| 0b | 57.3 | NA | −4.3 | 57.3 | 19.91 | NA | 2.75 | 19.91 | 50.7 | 50.7 | −5.2 | 50.7 | 21.41 | 21.4 | 3.92 | 21.41 |
| 5a | 58.9 | NA | 0.0 | 58.9 | 20.63 | NA | 3.20 | 20.63 | 50.6 | 50.6 | −0.9 | 50.6 | 21.36 | 21.4 | 4.54 | 21.36 |
| 15a | 42.6 | NA | 10.8 | 42.6 | 14.25 | NA | 4.57 | 14.25 | 40.5 | 40.5 | 10.6 | 40.5 | 17.01 | 17.0 | 6.56 | 17.01 |

It is expected that the present thermal management system produces for each of the conditions using RE1B4 in this operating mode a COP that is about the same as or higher than the prior heat pump systems and a heating capacity that is about the same as or higher than the prior systems.

### Examples 1B1-1B4

Example 1A is repeated, except that the refrigerant blends identified in Table E1B below as Refrigerants RE1B5-RE1B8 are used instead of 1234yf under the same set of conditions identified in Table 1 above.

TABLE E1B
REFRIGERANTS

| | | ASHRAE | COMPONENTS, WT % | | | | | GWP |
|---|---|---|---|---|---|---|---|---|
| Examp1e | Refrigerant | Name | R134a | R1234yf | R152a | R32 | R1234ze | (AR4) |
| Ex1B5 | RE1B5 | R516A | 8.5 | 77.5 | 14.0 | 0.0 | 0.0 | 142 |
| Ex1B6 | RE1B6 | R444A | 0.0 | 0.0 | 5.0 | 12.0 | 83.0 | 92 |
| Ex1B7 | RE1B7 | R457C | 0.0 | 78.0 | 14.5 | 7.5 | 0.0 | 72 |
| Ex1B8 | RE1B8 | R457D | 0.0 | 82.0 | 14.0 | 4.0 | 0.0 | 48 |

The temperatures and pressures in the respective systems in accordance with this example operating in this manner are reported in the Table E1B5 below with the results using the refrigerant blends of this Examples 1B5 reported as EWG-HP and the results from the use of the system of Comparative Example 1 (but using R1234yf of the present invention) reported as WG-HP.

TABLE E1B5
Temperature and pressure data - RE1B5 Refrigerant (R516A)

| | WG-HP | | | | | | | | EWG-HP | | | | | | | |
|---|---|---|---|---|---|---|---|---|---|---|---|---|---|---|---|---|
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 9.81 | NA | 0.81 | 9.81 | 17.9 | 17.9 | −35.8 | 17.9 | 5.70 | 5.7 | 0.76 | 5.70 |
| −20a | 36.2 | NA | −25.88 | 36.2 | 12.22 | NA | 1.19 | 12.22 | 23.4 | 23.4 | −27.7 | 23.4 | 6.69 | 6.7 | 1.19 | 6.69 |
| −20b | 60.6 | NA | −23.0 | 60.6 | 21.38 | NA | 1.34 | 21.38 | 48.3 | 48.3 | −24.8 | 48.3 | 12.88 | 12.9 | 1.24 | 12.88 |
| −10a | 55.3 | NA | −15.7 | 55.3 | 19.44 | NA | 1.80 | 19.44 | 44.9 | 44.9 | −18.1 | 44.9 | 11.85 | 11.9 | 1.64 | 11.85 |
| −10b | 58.9 | NA | −13.8 | 58.9 | 20.63 | NA | 1.94 | 20.63 | 50.4 | 50.4 | −15.2 | 50.4 | 13.54 | 13.5 | 1.84 | 13.54 |
| 0a | 60.4 | NA | −6.3 | 60.4 | 21.27 | NA | 2.56 | 21.27 | 51.4 | 51.4 | −8.2 | 51.4 | 13.86 | 13.9 | 2.39 | 13.86 |
| 0b | 57.3 | NA | −4.3 | 57.3 | 19.91 | NA | 2.75 | 19.91 | 50.7 | 50.7 | −5.2 | 50.7 | 13.64 | 13.6 | 2.67 | 13.64 |
| 5a | 58.9 | NA | 0.0 | 58.9 | 20.63 | NA | 3.20 | 20.63 | 50.6 | 50.6 | −0.9 | 50.6 | 13.60 | 13.6 | 3.10 | 13.60 |
| 15a | 42.6 | NA | 10.8 | 42.6 | 14.25 | NA | 4.57 | 14.25 | 40.5 | 40.5 | 10.6 | 40.5 | 10.61 | 10.6 | 4.53 | 10.61 |

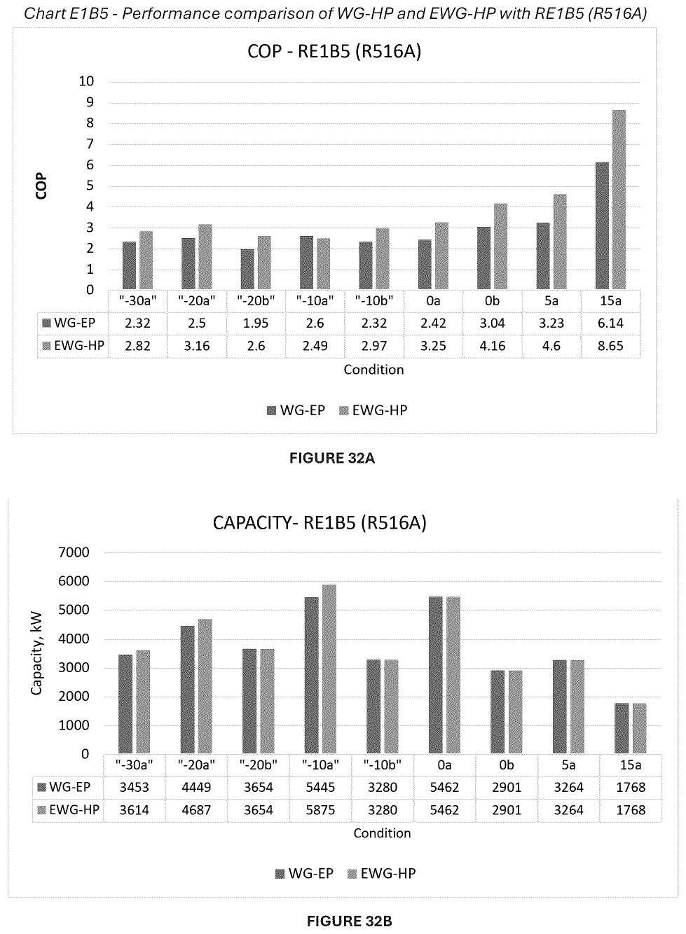

The relative capacity and effectiveness (COP) of the two systems operating in this manner are reported and illustrated in FIGS. 32A and 32B, with the results from this Example 1B reported as EWG-HP and the results from the use of the system of Comparative Example 1 reported as WG-HP.

From the results reported above and in FIGS. 32A and 32B, it can be seen that the present thermal management system produces for each of the conditions using RE1B5 in this operating mode a COP that is about the same as or higher than the prior heat pump systems and a heating capacity that is about the same as or higher than the prior systems.

The temperatures and pressures in the respective systems in accordance with this example operating in this manner with R444A (RE1B6) are reported in the Table E1B6 below with the results using the refrigerant blends of this Example 1B6 reported as EWG-HP and the results from the use of the system of Comparative Example 1 (but using R1234yf of the present invention) reported as WG-HP.

TABLE E1B6
Temperature and pressure data - RE1B6 Refrigerant (R444A)

| | WG-HP | | | | | | | | EWG-HP | | | | | | | |
|---|---|---|---|---|---|---|---|---|---|---|---|---|---|---|---|---|
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 11.29 | NA | 0.63 | 11.29 | 17.9 | 17.9 | −35.8 | 17.9 | 6.73 | 6.7 | 0.59 | 6.73 |
| −20a | 36.2 | NA | −25.8 | 36.2 | 13.90 | NA | 0.95 | 13.90 | 23.4 | 23.4 | −27.7 | 23.4 | 7.84 | 7.8 | 0.87 | 7.84 |
| −20b | 60.6 | NA | −23.0 | 60.6 | 23.61 | NA | 1.08 | 23.61 | 48.3 | 48.3 | −24.8 | 48.3 | 14.62 | 14.6 | 0.99 | 14.62 |
| −10a | 55.3 | NA | −15.6 | 55.3 | 21.59 | NA | 1.48 | 21.59 | 44.9 | 44.9 | −18.1 | 44.9 | 13.51 | 13.5 | 1.33 | 13.51 |
| −10b | 58.9 | NA | −13.8 | 58.9 | 22.83 | NA | 1.60 | 22.83 | 50.4 | 50.4 | −15.2 | 50.4 | 15.33 | 15.3 | 1.51 | 15.33 |
| 0a | 60.4 | NA | −6.3 | 60.4 | 23.50 | NA | 2.15 | 23.50 | 51.4 | 51.4 | −8.2 | 51.4 | 15.68 | 15.7 | 2.00 | 15.68 |
| 0b | 57.3 | NA | −4.3 | 57.3 | 22.09 | NA | 2.32 | 22.09 | 50.7 | 50.7 | −5.2 | 50.7 | 15.43 | 15.4 | 2.25 | 15.43 |
| 5a | 58.9 | NA | 0.0 | 58.9 | 22.83 | NA | 2.73 | 22.83 | 50.6 | 50.6 | −0.9 | 50.6 | 15.40 | 15.4 | 2.64 | 15.40 |
| 15a | 42.6 | NA | 10.8 | 42.6 | 16.09 | NA | 3.99 | 16.09 | 40.5 | 40.5 | 10.6 | 40.5 | 12.16 | 12.2 | 3.95 | 12.16 |

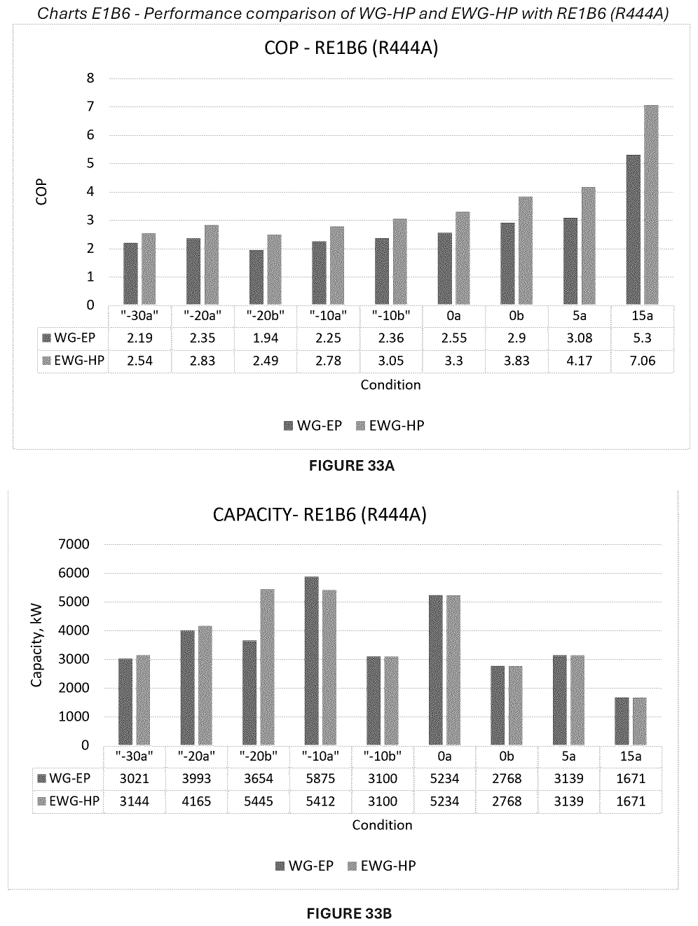

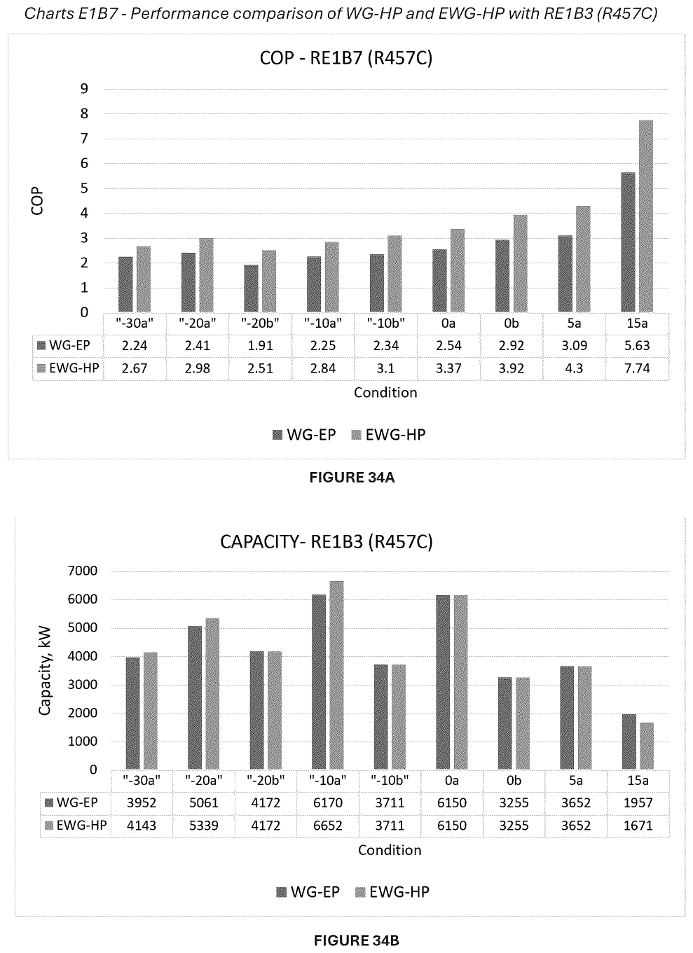

The relative capacity and effectiveness (COP) of the two systems operating in this manner are reported and illustrated in FIGS. 33A and 33B, with the results from this Example 1B6 reported as EWG-HP and the results from the use of the system of Comparative Example 1 reported as WG-HP.

From the results reported above and from FIGS. 33A and 33B, it can be seen that the present thermal management system produces for each of the conditions using RE1B6 in this operating mode a COP that is higher than the prior heat pump systems and a heating capacity that is about the same as or higher than the prior systems.

The temperatures and pressures in the respective systems in accordance with this example operating in this manner with R457C (RE1B7) are reported in the Table E1B7 below with the results using the refrigerant blends of this Example 1B7 reported as EWG-HP and the results from the use of the system of Comparative Example 1 (but using R1234yf of the present invention) reported as WG-HP.

TABLE E1B7
Temperature and pressure data - RE1B7 Refrigerant (R457C)

| | WG-HP | | | | | | | | EWG-HP | | | | | | | |
|---|---|---|---|---|---|---|---|---|---|---|---|---|---|---|---|---|
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 12.18 | NA | 0.92 | 12.18 | 17.9 | 17.9 | −35.8 | 17.9 | 7.27 | 7.3 | 0.86 | 7.27 |
| −20a | 36.2 | NA | −25.8 | 36.2 | 15.00 | NA | 1.34 | 15.00 | 23.4 | 23.4 | −27.7 | 23.4 | 8.47 | 8.5 | 1.24 | 8.47 |
| −20b | 60.6 | NA | −23.0 | 60.6 | 25.52 | NA | 1.51 | 25.52 | 48.3 | 48.3 | −24.8 | 48.3 | 15.77 | 15.8 | 1.40 | 15.77 |
| −10a | 55.3 | NA | −15.6 | 55.3 | 23.32 | NA | 2.02 | 23.32 | 44.9 | 44.9 | −18.1 | 44.9 | 14.58 | 14.6 | 1.84 | 14.58 |
| −10b | 58.9 | NA | −13.8 | 58.9 | 24.68 | NA | 2.18 | 24.68 | 50.4 | 50.4 | −15.2 | 50.4 | 16.54 | 16.5 | 2.06 | 16.54 |
| 0a | 60.4 | NA | −6.3 | 60.4 | 25.41 | NA | 2.86 | 25.41 | 51.4 | 51.4 | −8.2 | 51.4 | 16.92 | 16.9 | 2.68 | 16.92 |
| 0b | 57.3 | NA | −4.3 | 57.3 | 23.86 | NA | 3.08 | 23.86 | 50.7 | 50.7 | −5.2 | 50.7 | 16.65 | 16.7 | 2.98 | 16.65 |
| 5a | 58.9 | NA | 0.0 | 58.9 | 24.68 | NA | 3.58 | 24.68 | 50.6 | 50.6 | −0.9 | 50.6 | 16.62 | 16.6 | 3.47 | 16.62 |
| 15a | 42.6 | NA | 10.8 | 42.6 | 17.36 | NA | 5.10 | 17.36 | 40.5 | 40.5 | 10.6 | 40.5 | 13.12 | 13.1 | 5.06 | 13.12 |

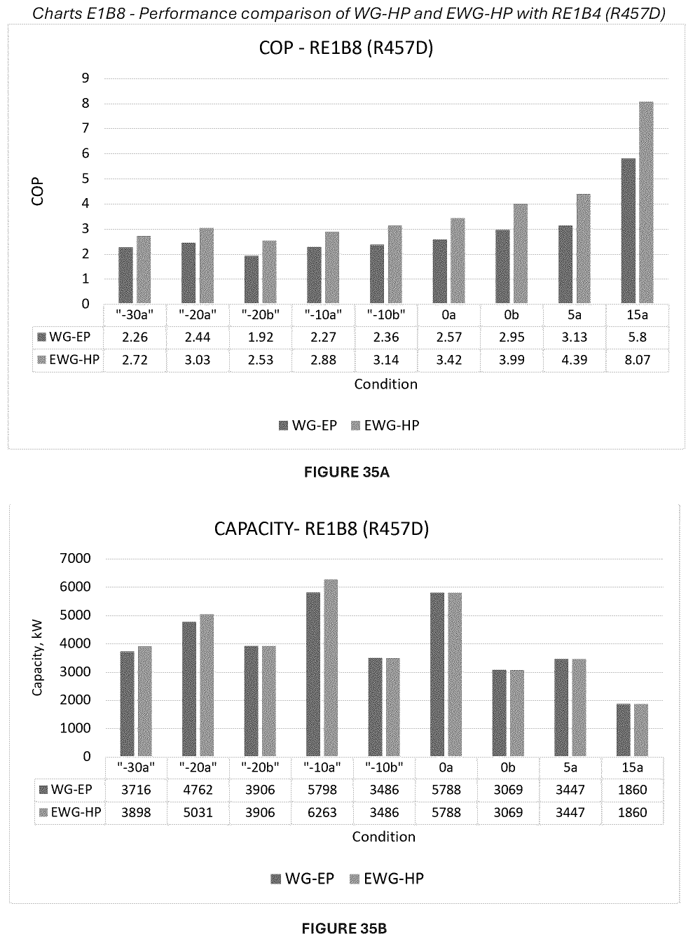

From the results reported above and in FIGS. 35A and 35B, it can be seen that the present thermal management system produces for each of the conditions using RE1B8 in this operating mode a COP that is higher than the prior heat pump systems and a heating capacity that is about the same as or higher than the prior systems.

The temperatures and pressures in the respective systems in accordance with this example operating in this manner are reported in the Table E1B8 below with the results using the refrigerant blends of this Example 1B8 reported as EWG-HP and the results from the use of the system of Comparative Example 1 (but using R1234yf of the present invention) reported as WG-HP.

TABLE E1B8
Temperature and pressure data - RE1B4 Refrigerant (R457D)

| | WG-HP | | | | | | | | EWG-HP | | | | | | | |
|---|---|---|---|---|---|---|---|---|---|---|---|---|---|---|---|---|
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 12.18 | NA | 0.92 | 12.18 | 17.9 | 17.9 | −35.8 | 17.9 | 7.27 | 7.3 | 0.86 | 7.27 |
| −20a | 36.2 | NA | −25.8 | 36.2 | 15.00 | NA | 1.34 | 15.00 | 23.4 | 23.4 | −27.7 | 23.4 | 8.47 | 8.5 | 1.24 | 8.47 |
| −20b | 60.6 | NA | −23.0 | 60.6 | 25.52 | NA | 1.51 | 25.52 | 48.3 | 48.3 | −24.8 | 48.3 | 15.77 | 15.8 | 1.40 | 15.77 |
| −10a | 55.3 | NA | −15.6 | 55.3 | 23.32 | NA | 2.02 | 23.32 | 44.9 | 44.9 | −18.1 | 44.9 | 14.58 | 14.6 | 1.84 | 14.58 |
| −10b | 58.9 | NA | −13.8 | 58.9 | 24.68 | NA | 2.18 | 24.68 | 50.4 | 50.4 | −15.2 | 50.4 | 16.54 | 16.5 | 2.06 | 16.54 |
| 0a | 60.4 | NA | −6.3 | 60.4 | 25.41 | NA | 2.86 | 25.41 | 51.4 | 51.4 | −8.2 | 51.4 | 16.92 | 16.9 | 2.68 | 16.92 |
| 0b | 57.3 | NA | −4.3 | 57.3 | 23.86 | NA | 3.08 | 23.86 | 50.7 | 50.7 | −5.2 | 50.7 | 16.65 | 16.7 | 2.98 | 16.65 |
| 5a | 58.9 | NA | 0.0 | 58.9 | 24.68 | NA | 3.58 | 24.68 | 50.6 | 50.6 | −0.9 | 50.6 | 16.62 | 16.6 | 3.47 | 16.62 |
| 15a | 42.6 | NA | 10.8 | 42.6 | 17.36 | NA | 5.10 | 17.36 | 40.5 | 40.5 | 10.6 | 40.5 | 13.12 | 13.1 | 5.06 | 13.12 |

From the results reported above and from FIGS. 35A and 35B, it can be seen that the present thermal management system produces for each of the conditions using RE1B8 in this operating mode a COP that is higher than the prior heat pump systems and a heating capacity that is about the same as or higher than the prior systems.

### Example 1C—Heat Pump Mode with Inner Evaporator/Condenser in the Loop to Warm Cabin Air and PTC Upstream of the Chiller

As with Example 1A, applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). In addition, Applicants have found that systems of the present invention as described and illustrated herein, particularly in connection with FIG. 3A, can be even further dramatically improved in terms of overall performance with relatively simple and low-cost further modifications involving primarily the relative placement of the chiller, the PTC and the coolant pump. In particular, applicant has come to appreciate that in relatively low ambient temperatures the relative power consumption associated with the operation of the coolant pump located downstream of the PTC, which itself is located downstream of the chiller, as illustrated in FIG. 3A can be undesirably high. This undesirable feature can occur due to the relatively low viscosity at the suction side of the coolant pump, which causes a potentially dramatic and undesirable increase in power consumption in the circuit. In one desirable alternative to this configuration, as illustrated in FIG. 3B, the PTC is moved to a point upstream of the chiller, which results in a reduction in the power consumption associated with the operation of the system. An illustration of using the configuration of FIG. 3B in the system as otherwise configured in FIG. 3A is illustrated in FIG. 3F.

### Example 1D—Heat Pump Mode with Inner Evaporator/Condenser in the Loop to Warm Cabin Air and PTC and Coolant Pump Upstream of the Chiller

In this Example 1D, the configuration of Example 1C is repeated, except that a further modification includes locating the coolant pump upstream of the chiller and downstream of the PTC, as illustrated in FIG. 3C. This configuration is a specially preferred, as with the configuration in Example 1C, in relatively low ambient temperatures conditions in order to minimize or at least reduce the relative power consumption associated with the operation of the coolant pump. Applicants have come to appreciate that locating both the PTC and the coolant pump upstream of the chiller, as illustrated in FIG. 3C, is even more preferred from the standpoint of minimizing the power required for the coolant pump to operate this portion of the systems of the present invention.

### Example 1C—Heat Pump Mode with Inner Evaporator/Condenser in the Loop to Warm Cabin Air and PTC Upstream of the Chiller

As with Example 1A, applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). In addition, Applicants have found that systems of the present invention as described and illustrated herein, particularly in connection with FIG. 3A, can be even further dramatically improved in terms of overall performance with relatively simple and low-cost further modifications involving primarily the relative placement of the chiller, the PTC and the coolant pump. In particular, applicant has come to appreciate that in relatively low ambient temperatures the relative power consumption associated with the operation of the coolant pump located downstream of the PTC, which itself is located downstream of the chiller, as illustrated in FIG. 3A can be undesirably high. This undesirable feature can occur due to the relatively low viscosity at the suction side of the coolant pump, which causes a potentially dramatic and undesirable increase in power consumption in the circuit. In one desirable alternative to this configuration, as illustrated in FIG. 3B, the PTC is moved to a point upstream of the chiller, which results in a reduction in the power consumption associated with the operation of the system. An illustration of a system using the configuration of FIG. 3B in the system as otherwise configured in FIG. 3A is illustrated in FIG. 3G.

### Examples 2-30: Heating and/or Cooling in Ambient Conditions from −35C to 45C and For Several Combinations of Heating and Cooling Needs in an EV

For the purposes of understanding the advantages and features of the present inventive system compared to prior heat pump systems over the relevant range of ambient temperature conditions and over exemplary alternative scenarios relating to heating and/or cooling needs in an operating and/or charging EV, it is noted that typical prior systems would operate in warm temperatures to primarily provide cabin air conditioning to an EV using the typical configuration illustrated by the solid thick lines in Comparative FIG. 2. In this typical prior air conditioning cycle configuration in which cabin air is to be cooled, the OHE 3 is the predominate source for condensing the refrigerant and the evaporator 2 is the cooling unit for cabin air.

Applicants have come to appreciate that while heat pump systems need an evaporative heat (energy) source, EVs also have cooling needs beyond the cooling of cabin air, that is, heat sources that represent waste heat for use as the evaporative source (highly efficient) and that the present improved system has been developed so as to take advantage of these features when possible and to achieve results not previously achievable. In particular, applicants have noted that there are two main areas that may need cooling, depending on conditions, on all EVs:
1. The battery needs cooling during charging and may, at times, need cooling during discharging (vehicle operation). The battery may also need warming initially in very cold weather.
2. The vehicle drive motor(s)/inverter require cooling during vehicle operation. These devices also benefit in efficiency from the possibility of receiving warming in cold weather.
   Unfortunately for systems of prior designs, the cooling needs and/or heating needs, and the ideal temperatures of the battery and motor/inverter, vary greatly depending on the vehicle ambient conditions, on the driving conditions, on stationary battery charging, on how long the vehicle has been off before running or on how long the vehicle has been driving. In some circumstances, one or both of these (battery or motor/inverter) may need cooling while the other does not or may need warming.

Applicants' highly flexible system is able to achieve highly efficient evaporative heat conditions using available heat while not compromising the other sources. The present system provides highly beneficial performance by unique combinations of components, including the possibility to use three evaporative heat source locations (chiller, Outside Heat Exchanger [OHE] or an Inner Heat Exchanger, while at the same time waste heat from the battery during charging and/or discharging can be used at the chiller or the OHE and ambient air can be used at the OHE or the Inner Heat Exchanger as the heat source. In addition, one or both of the above heat sources can be warming up while another is used as the evaporative heat source for the heat pump. In addition, an electrically operated Positive Temperature Coefficient (PTC) heater can also be used alone or in series with the evaporative heat sources at the chiller and/or the OHE. The available evaporative heat sources usable according to the systems of the present invention include those listed below:
1. Air only (at the OHE)
2. Motor and inverter (at the OHE)
3. Motor and inverter (at the chiller)
4. Motor and Inverter and PTC (at the chiller)
5. Battery (at the chiller)
6. Battery and PTC (at the chiller)
7. Battery (at the OHE)
8. Motor, inverter and battery (at the chiller)
9. Motor, inverter, battery and PTC (at the chiller)
10. Motor, inverter, battery (at the OHE)
11. PTC (at the chiller)
12. PTC (at the OHE)
13. Motor, Inverter and PTC (at the OHE)
14. Motor, inverter, battery and PTC (at the OHE)
15. Battery and PTC (at the OHE)
16. Air only (at the chiller)
17. Battery, motor and inverter (at the chiller)
18. Dehumidification (at the evaporator)

Several of many possible applicable system operating modes of the present invention for the evaporative heat sources and their use location are shown in the following Examples (with associated figures), with the relevant ambient temperatures (ambient) as well as the condition of the cabin being hot, cool, cold or acceptable to the passenger (OK). Furthermore, the condition of the battery, motor and inverter are specified as being hot, warm, cool or cold or acceptable (OK) are defined. The driving condition between start and comfort as well as the battery charge being active (Yes) or not active (No) are described. The applicable operating conditions for the different heat sources are indicated. In the Figures, thick lines in the vapor compression system indicate refrigerant flow at relatively high pressure (only line pressure drop from compressor discharge), dashed thick lines in the vapor compression system indicate refrigerant flow at a reduced pressure (after throttling in an expansion valve), and thin lines indicate refrigerant conduits (and corresponding units) that have been bypassed. Similarly, thick lines in the coolant section indicate active coolant flow and thin lines indicate coolant conduits that have been bypassed, while dashed thick lines indicate the coolant could optionally be flowing but is not for the results reported in the example.

### Example 2A—Vehicle Heating Between 0° C. and 15° C.—with Evaporative Heat Source 1—Air only at OHE and under Applicable Conditions of 15° C., 5° C. and −5° C. Using RE1B1

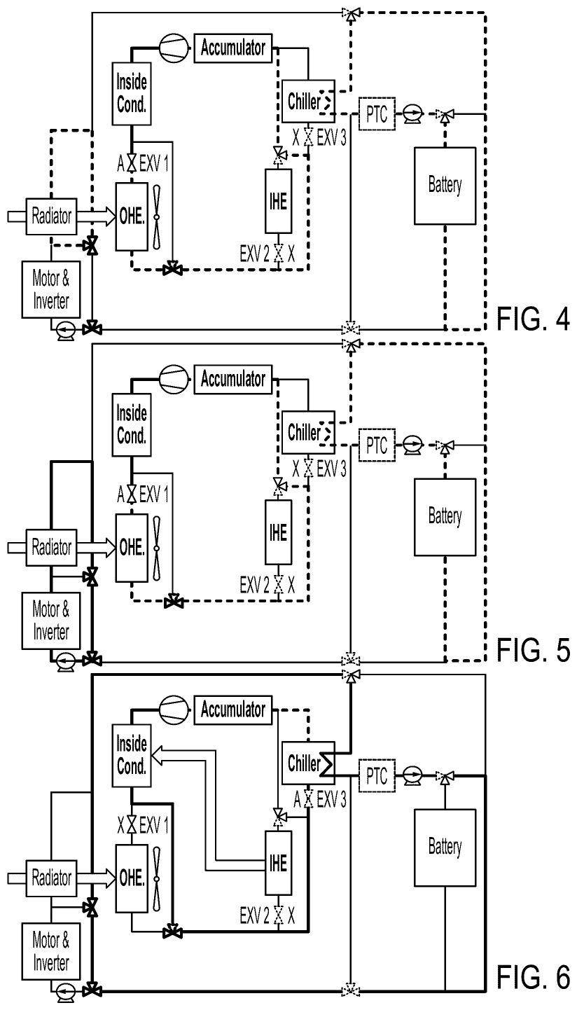

In this example, a system of the present invention is configured for operation to heat cabin air during periods of low ambient temperatures is illustrated in FIG. 4. The pressure data obtained by operating the system of this example with R1234yf and with RE1B1 is reported in the following Table E2A1. The use of Refrigerant RE1B1 (R545C) is reported in Table E2A2 below by using bold type as an indicator for acceptable operation at the indicated locations and for indicated ambient conditions when using identified evaporative heat source(s) being used.

TABLE E2A1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 10.6 | 55.7 | 18.6 | NA |
| RE1B1 | 55.7 | NA | 10.6 | 55.7 | 10.6 | 55.7 | 30.1 | NA |
| (R545C) | | | | | | | | |

TABLE E2A2
Using R545C with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2B—Vehicle Heating Between 0° C. and 15° C.—with Evaporative Heat Source 1—Air only at OHE and under Applicable Conditions of 15° C., 5° C. and −5° C. Using RE1B2

In this example, a system of the present invention is configured for operation to heat cabin air during periods of low ambient temperatures is illustrated in FIG. 4. The temperature amd pressure data obtained by operating the system of this example with R1234yf and with RE1B2 is reported in the following Table E2B1. The use of Refrigerant REIB2 (R455A) is reported in Table E2B2 below by using bold type as an indicator for acceptable operation at the indicated locations and for indicated ambient conditions when using identified evaporative heat source(s) being used.

TABLE E2B1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 10.6 | 55.7 | 18.6 | NA |
| RE1B2 | 55.7 | NA | 10.6 | 55.7 | 10.6 | 55.7 | 33.4 | NA |
| (R455A) | | | | | | | | |

TABLE E2B2
Using R455A with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2C—Vehicle Heating Between 0° C. And 15° C.—with Evaporative Heat Source 1-Air Only at OHE and Under Applicable Conditions of 15° C., 5° C. And −5° C. Using RE1B3

In this example, a system of the present invention is configured for operation to heat cabin air during periods of low ambient temperatures is illustrated in FIG. 4. The pressure data obtained by operating the system of this example with R1234yf and with RE1B3 is reported in the following Table E2C1. The use of Refrigerant REIB3 (R474A) is reported in Table E2C2 below by using bold type as an indicator for acceptable operation at the indicated locations and for indicated ambient conditions when using identified evaporative heat source(s) being used.

TABLE E2C1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 10.6 | 55.7 | 18.6 | NA |
| RE1B3 | 55.7 | NA | 10.6 | 55.7 | 10.6 | 55.7 | 27.0 | NA |
| (R474A) | | | | | | | | |

TABLE E2C2
Using R474A with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2D—Vehicle Heating Between 0° C. and 15° C.—with Evaporative Heat Source 1-Air only at OHE and under Applicable Conditions of 15° C., 5° C. and −5° C. Using RE1B4

In this example, a system of the present invention is configured for operation to heat cabin air during periods of low ambient temperatures is illustrated in FIG. 4. The pressure data obtained by operating the system of this example with R1234yf and with RE1B4 is reported in the following Table E2D1. The use of Refrigerant RE1B4 (R474B) is reported in Table E2D2 below by using bold type as an indicator for acceptable operation at the indicated locations and for indicated ambient conditions when using identified evaporative heat source(s) being used.

TABLE E2D1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 10.6 | 55.7 | 18.6 | NA |
| RE1B4 | 55.7 | NA | 10.6 | 55.7 | 10.6 | 55.7 | 29.3 | NA |
| (R474B) | | | | | | | | |

TABLE E2D2
Using R474B with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2E—Vehicle Heating Between 0° C. and 15° C.—with Evaporative Heat Source 1 —Air only at OHE and under Applicable Conditions of 15° C., 5° C. and −5° C. Using RE1B5

In this example, a system of the present invention is configured for operation to heat cabin air during periods of low ambient temperatures is illustrated in FIG. 4. The pressure data obtained by operating the system of this example with R1234yf and with RE1B5 is reported in the following Table E2E1.

The use of Refrigerant RE1B5 (R516A) is reported in Table E2E2 below by using bold type as an indicator for acceptable operation at the indicated locations and for indicated ambient conditions when using identified evaporative heat source(s) being used.

TABLE E2E1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 18.6 | NA | 4.5 | 18.6 |
| RE1B6 | 55.7 | NA | 10.6 | 55.7 | 19.2 | NA | 4.5 | 19.2 |
| (R516A) | | | | | | | | |

TABLE E2E2
Using R516A with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2F—Vehicle Heating Between 0° C. and 15° C.—with Evaporative Heat Source 1-Air only at OHE and under Applicable Conditions of 15° C., 5° C. and −5° C. Using RE1B2

In this example, a system of the present invention is configured for operation to heat cabin air during periods of low ambient temperatures is illustrated in FIG. 4. The pressure data obtained by operating the system of this example with R1234yf and with RE1B6 is reported in the following Table E2F1. The use of Refrigerant RE1B6 (R444A) is reported in Table E2F2 below by using bold type as an indicator for acceptable operation at the indicated locations and for indicated ambient conditions when using identified evaporative heat source(s) being used.

TABLE E2F1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B6 | 59.0 | NA | 3.4 | 59.0 | 22.8 | NA | 1.8 | 22.8 |
| (R444A) | | | | | | | | |

TABLE E2F2
Using R444A with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2G—Vehicle Heating Between 0° C. And 15° C.—with Evaporative Heat Source 1-Air Only at OHE and Under Applicable Conditions of 15° C., 5° C. And −5° C. Using RE1B7

In this example, a system of the present invention is configured for operation to heat cabin air during periods of low ambient temperatures is illustrated in FIG. 4. The pressure data obtained by operating the system of this example with R1234yf and with RE1B7 is reported in the following Table E2G1. The use of Refrigerant RE1B7 (R457C) is reported in Table E2G2 below by using bold type as an indicator for acceptable operation at the indicated locations and for indicated ambient conditions when using identified evaporative heat source(s) being used.

TABLE E2G1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B7 | 59.0 | NA | 3.4 | 59.0 | 24.7 | NA | 2.5 | 24.7 |
| (R457C) | | | | | | | | |

TABLE E2G2
Using R457C with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 2H—Vehicle Heating Between 0° C. And 15° C.—with Evaporative Heat Source 1-Air Only at OHE and Under Applicable Conditions of 15° C., 5° C. And −5° C. Using RE1B8

In this example, a system of the present invention is configured for operation to heat cabin air during periods of low ambient temperatures is illustrated in FIG. 4. The pressure data obtained by operating the system of this example with R1234yf and with RE1B8 is reported in the following Table E2H1. The use of Refrigerant RE1B8 (R457D) is reported in Table E2H2 below by using bold type as an indicator for acceptable operation at the indicated locations and for indicated ambient conditions when using identified evaporative heat source(s) being used.

TABLE E2H1
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B4 | 59.0 | NA | 3.4 | 59.0 | 22.9 | NA | 2.3 | 22.9 |
| (R457D) | | | | | | | | |

TABLE E2H2
Using R457D with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 3A—Vehicle Heating Between −10° C. and 15° C.—Using R454C with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with RE1B1 is reported in the following Table E3A1. The use of Refrigerant REIB1 (R454C) is reported in Table E3A2 below by using bold type as an indicator for acceptable operation at the indicated locations and for indicated ambient conditions when using the identified evaporative heat source(s).

TABLE E3A1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B1 | 59.0 | NA | 3.4 | 59.0 | 32.1 | NA | 3.1 | 32.1 |
| (R454C) | | | | | | | | |

TABLE E3A2
Using R454C with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3B—Vehicle Heating Between −10° C. and 15° C.—Using R455A with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with RE1B2 is reported in the following Table E3B1. The use of Refrigerant RE1B2 (R455A) is reported in Table E3B2 below by using bold type as an indicator for acceptable operation at the indicated locations and for indicated ambient conditions when using the identified evaporative heat source(s).

TABLE E3B1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B2 | 59.0 | NA | 3.4 | 59.0 | 35.5 | NA | 3.3 | 35.5 |
| (R455A) | | | | | | | | |

TABLE E3B2
Using R455A with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3C—Vehicle Heating Between −10° C. and 15° C.—Using R474A with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with RE1B3 is reported in the following Table E3C1. The use of Refrigerant RE1B3 (R474A) is reported in Table E3C2 below by using bold type as an indicator for acceptable operation at the indicated locations and for indicated ambient conditions when using the identified evaporative heat source(s).

TABLE E3C1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B3 | 59.0 | NA | 3.4 | 59.0 | 28.9 | NA | 2.9 | 28.9 |
| (R474A) | | | | | | | | |

TABLE E3B2
Using R474C with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3D—Vehicle Heating Between −10° C. and 15° C.—Using R474B with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with RE1B4 is reported in the following Table E3D1. The use of Refrigerant RE1B4 (R474B) is reported in Table E3D2 below by using bold type as an indicator for acceptable operation at the indicated locations and for indicated ambient conditions when using the identified evaporative heat source(s).

TABLE E3D1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B4 | 59.0 | NA | 3.4 | 59.0 | 31.3 | NA | 3.3 | 31.3 |
| (R474B) | | | | | | | | |

TABLE E3D2
Using R474D with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3E—Vehicle Heating Between −10° C. and 15° C.—Using R516A with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with RE1B5 is reported in the following Table E3E1. The use of Refrigerant RE1B5 (R516A) is reported in Table E3E2 below by using bold type as an indicator for acceptable operation at the indicated locations and for indicated ambient conditions when using the identified evaporative heat source(s).

TABLE E3E1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B5 | 59.0 | NA | 3.4 | 59.0 | 20.6 | NA | 2.2 | 20.6 |
| (R516A) | | | | | | | | |

TABLE E3E2
Using R516A with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3F—Vehicle Heating Between −10° C. and 15° C.—Using R444A with Evaporative Heat Source 2: Motor and Inverter at OHE Using R444A

In this example, a system of the present invention is configured for operation to heat cabin air during periods of low ambient temperatures is illustrated in FIG. 5. The data obtained by operating the system of this example with R1234yf and with RE1B6 is reported in the following Table E3F1. The use of Refrigerant RE1B6 (R444A) is reported in Table E3B6 below by using bold type as an indicator for acceptable operation at the indicated locations and for indicated ambient conditions when using the identified evaporative heat source(s).

TABLE E3F1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1F2 | 59.0 | NA | 3.4 | 59.0 | 22.8 | NA | 1.8 | 22.8 |
| (R444A) | | | | | | | | |

TABLE E3F2
Using R444A with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3G—Vehicle Heating Between −10° C. and 15° C.—Using R457C with Evaporative Heat Source 2: Motor and Inverter at OHE Using R457C

In this example, a system of the present invention is configured for operation to heat cabin air during periods of low ambient temperatures is illustrated in FIG. 5. The data obtained by operating the system of this example with R1234yf and with RE1B7 is reported in the following Table E3G1. The use of Refrigerant RE1B7 (R457C) is reported in Table E3G2 below by using bold type as an indicator for acceptable operation at the indicated locations and for indicated ambient conditions when using the identified evaporative heat source(s).

TABLE E3G1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B7 | 59.0 | NA | 3.4 | 59.0 | 24.7 | NA | 2.5 | 24.7 |
| (R457C) | | | | | | | | |

TABLE E3B7
Using R457C with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 3H—Vehicle Heating Between −10° C. and 15° C.—Using R457D with Evaporative Heat Source 2: Motor and Inverter at OHE Using R457D

In this example, a system of the present invention is configured for operation to heat cabin air during periods of low ambient temperatures is illustrated in FIG. 5. The data obtained by operating the system of this example with R1234yf and with RE1B4 is reported in the following Table E3H1. The use of Refrigerant RE1B8 (R457D) is reported in Table E3H2 below by using bold type as an indicator for acceptable operation at the indicated locations and for indicated ambient conditions when using the identified evaporative heat source(s).

TABLE E3H1
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B8 | 59.0 | NA | 3.4 | 59.0 | 22.9 | NA | 2.3 | 22.9 |
| (R457D) | | | | | | | | |

TABLE E3H2
Using R457D with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 4A—Vehicle Heating Between −15° C. and 15° C.—Evaporative Heat Source 2: Motor and Inverter at Chiller Using R454C

In this example, a system of the present invention is configured for operation to heat cabin air during periods of low ambient temperatures as illustrated in FIG. 6. The data obtained by operating the system of this example with R1234yf and with RE1B1 produces the results as reported in the following Table E4A1. The use of Refrigerant RE1B1 (R454C) is reported in Table E4A2 below by using bold type as an indicator for acceptable operation at the indicated locations and for indicated ambient conditions when using the identified evaporative heat source(s).

TABLE E4A1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B1 | 62.3 | NA | −13.05 | 62.3 | 34.2 | NA | 2.9 | 34.2 |
| (R454C) | | | | | | | | |

TABLE E4A2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4B—Vehicle Heating Between −15° C. and 15° C.—Evaporative Heat Source 2: Motor and Inverter at Chiller Using R455A

In this example, a system of the present invention is configured for operation to heat cabin air during periods of low ambient temperatures as illustrated in FIG. 6. The data obtained by operating the system of this example with R1234yf and with RE1B2 produces the results as reported in the following Table E4B1. The use of Refrigerant RE1B2 (R455A) is reported in Table E4B2 below by using bold type as an indicator for acceptable operation at the indicated locations and for indicated ambient conditions when using the identified evaporative heat source(s).

TABLE E4B1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B2 | 62.3 | NA | −13.05 | 62.3 | 37.7 | NA | 3.0 | 37.7 |
| (R455A) | | | | | | | | |

TABLE E4B2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4C—Vehicle Heating Between −15° C. and 15° C.—Evaporative Heat Source 2: Motor and Inverter at Chiller Using R474A

In this example, a system of the present invention is configured for operation to heat cabin air during periods of low ambient temperatures as illustrated in FIG. 6. The data obtained by operating the system of this example with R1234yf and with RE1B3 produces the results as reported in the following Table E4C1. The use of Refrigerant RE1B3 (R474A) is reported in Table E4C2 below by using bold type as an indicator for acceptable operation at the indicated locations and for indicated ambient conditions when using the identified evaporative heat source(s).

TABLE E4C1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B3 | 62.3 | NA | −13.05 | 62.3 | 30.8 | NA | 2.7 | 30.8 |
| (R474A) | | | | | | | | |

TABLE E4C2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4D—Vehicle Heating Between −15° C. and 15° C.—Evaporative Heat Source 2: Motor and Inverter at Chiller Using R474B

In this example, a system of the present invention is configured for operation to heat cabin air during periods of low ambient temperatures as illustrated in FIG. 6. The data obtained by operating the system of this example with R1234yf and with RE1B4 produces the results as reported in the following Table E4D1. The use of Refrigerant RE1B4 (R474B) is reported in Table E4D2 below by using bold type as an indicator for acceptable operation at the indicated locations and for indicated ambient conditions when using the identified evaporative heat source(s).

TABLE E4D1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B3 | 62.3 | NA | −13.05 | 62.3 | 30.8 | NA | 2.7 | 30.8 |
| (R474B) | | | | | | | | |

TABLE E4D2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4E—Vehicle Heating Between −15° C. and 15° C.—Evaporative Heat Source 2: Motor and Inverter at Chiller Using R516A

In this example, a system of the present invention is configured for operation to heat cabin air during periods of low ambient temperatures as illustrated in FIG. 6. The data obtained by operating the system of this example with R1234yf and with RE1B5 produces the results as reported in the following Table E4E1. The use of Refrigerant RE1B5 (R516A) is reported in Table E4E2 below by using bold type as an indicator for acceptable operation at the indicated locations and for indicated ambient conditions when using the identified evaporative heat source(s).

TABLE E4E1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B5 | 62.3 | NA | −13.05 | 62.3 | 22.1 | NA | 2.0 | 22.1 |
| (R516A) | | | | | | | | |

TABLE E4E2
Evaporative heat source 2: Motor and Inverter at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4F—Vehicle Heating Between −15° C. and 15° C.—Evaporative Heat Source 2: Motor and Inverter at Chiller Using R444A

In this example, a system of the present invention is configured for operation to heat cabin air during periods of low ambient temperatures as illustrated in FIG. 6. The data obtained by operating the system of this example with R1234yf and with RE1B6 produces the results as reported in the following Table E4F1. The use of Refrigerant RE1B6 (R444A) is reported in Table E4F2 below by using bold type as an indicator for acceptable operation at the indicated locations and for indicated ambient conditions when using the identified evaporative heat source(s).

TABLE E4F1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B6 | 62.3 | NA | −13.05 | 62.3 | 24.4 | NA | 1.7 | 24.4 |
| (R444A) | | | | | | | | |

TABLE E4F2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4G—Vehicle Heating Between −15° C. and 15° C.—Evaporative Heat Source 2: Motor and Inverter at Chiller Using 457C

In this example, a system of the present invention is configured for operation to heat cabin air during periods of low ambient temperatures as illustrated in FIG. 6. The data obtained by operating the system of this example with R1234yf and with RE1B7 produces the results as reported in the following Table E4G1. The use of Refrigerant RE1B7 (R457C) is reported in Table E4G2 below by using bold type as an indicator for acceptable operation at the indicated locations and for indicated ambient conditions when using the identified evaporative heat source(s).

TABLE E4G1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B7 | 62.3 | NA | −13.05 | 62.3 | 26.48 | NA | 2.2 | 26.4 |
| (R457C) | | | | | | | | |

TABLE E4G2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 4H—Vehicle Heating Between −15° C. and 15° C.—Evaporative Heat Source 2: Motor and Inverter at Chiller Using R457D

In this example, a system of the present invention is configured for operation to heat cabin air during periods of low ambient temperatures as illustrated in FIG. 6. The data obtained by operating the system of this example with R1234yf and with RE1B8 produces the results as reported in the following Table E4H1. The use of Refrigerant RE1B8 (R457D) is reported in Table E4D2 below by using bold type as an indicator for acceptable operation at the indicated locations and for indicated ambient conditions when using the identified evaporative heat source(s).

TABLE E4H1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B8 | 62.3 | NA | −13.05 | 62.3 | 24.5 | NA | 2.1 | 24.5 |
| (R457D) | | | | | | | | |

TABLE E4H2
Evaporative heat source 2: Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter are warmed up and need or can tolerate some cooling. It can also be used to cool the motor and inverter in warm weather. It will likely be used when the battery is at an appropriate or acceptable temperature.

### Example 5A—Motor and Inverter Temperature Control While Heating the EV—Evaporative Heat Source 4: Motor, Inverter and PTC at Chiller Using R454C

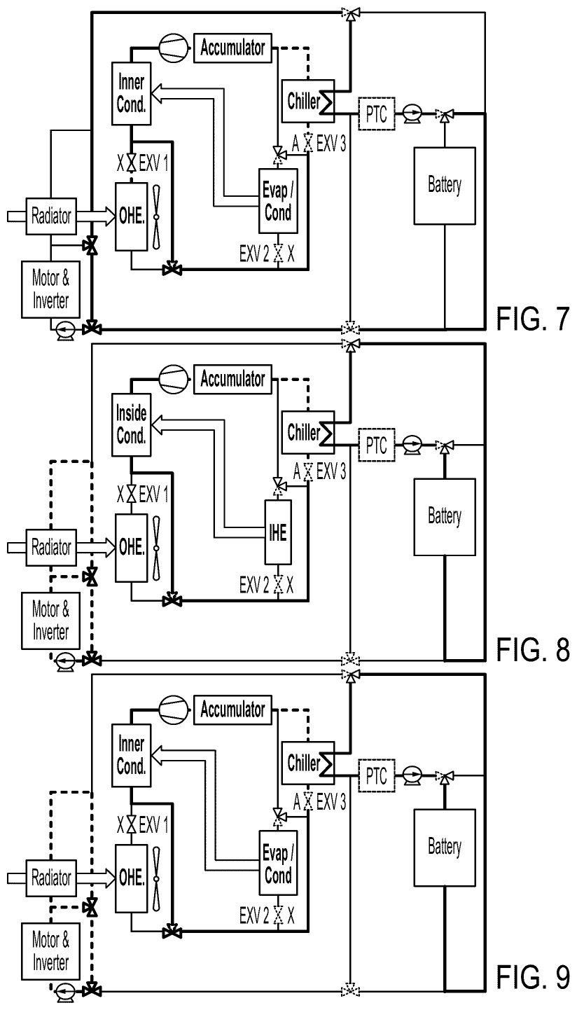

In this example, a system of the present invention configured for operation to heat cabin air during periods of low ambient temperatures as illustrated in FIG. 7. The data obtained by operating the system with R1234yf and with RE1B1 is reported in the following Table E5A1. The use of Refrigerant RE1B1 (R454C) is reported in Table E5A2 below by using bold type as an indicator for acceptable operation at the indicated locations and for indicated ambient conditions when using the identified evaporative heat source(s).

TABLE E5A1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B1 | 62.3 | NA | −13.05 | 62.3 | 34.2 | NA | 2.9 | 34.2 |
| (R454C) | | | | | | | | |

TABLE E5A2
Evaporative Heat Source 4: Motor, Inverter and PTC at chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In this mode the motor and inverter temperature can be maintained while heating the vehicle. In this case, the battery is assumed to be warming up while charging or at an appropriate temperature.

### Example 5B—Motor and Inverter Temperature Control While Heating the EV—Evaporative Heat Source 4: Motor, Inverter and PTC at Chiller Using R455A

In this example, a system of the present invention configured for operation to heat cabin air during periods of low ambient temperatures is illustrated in FIG. 7. The data obtained by operating the system with R1234yf and with RE1B2 is reported in the following Table E5B1. The use of Refrigerant RE1B2 (R455A) is reported in Table E5B2 below by using bold type as an indicator for acceptable operation at the indicated locations and for indicated ambient conditions when using the identified evaporative heat source(s).

TABLE E5B1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B2 | 62.3 | NA | −13.05 | 62.3 | 37.7 | NA | 3.0 | 37.7 |
| (R455A) | | | | | | | | |

In this mode the motor and inverter temperature can be maintained while heating the vehicle. In this case, the battery is assumed to be warming up while charging or at an appropriate temperature.

### Example 5C—Motor and Inverter Temperature Control While Heating the EV—Evaporative Heat Source 4: Motor, Inverter and PTC at Chiller R474A

In this example, a system of the present invention configured for operation to heat cabin air during periods of low ambient temperatures is illustrated in FIG. 7. The data obtained by operating the system with R1234yf and with RE1B3 is reported in the following Table E5C1. The use of Refrigerant RE1C2 (R474A) is reported in Table E5C2 below by using bold type as an indicator for acceptable operation at the indicated locations and for indicated ambient conditions when using the identified evaporative heat source(s).

TABLE E5C1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B3 | 62.3 | NA | −13.05 | 62.3 | 30.8 | NA | 2.7 | 30.8 |
| (R474A) | | | | | | | | |

In this mode the motor and inverter temperature can be maintained while heating the vehicle. In this case, the battery is assumed to be warming up while charging or at an appropriate temperature.

### Example 5D—Motor and Inverter Temperature Control While Heating the EV—Evaporative Heat Source 4: Motor, Inverter and PTC at Chiller Using R474B

In this example, a system of the present invention configured for operation to heat cabin air during periods of low ambient temperatures is illustrated in FIG. 7. The data obtained by operating the system with R1234yf and with RE1B4 is reported in the following Table E5D1. The use of Refrigerant REID2 (R474B) is reported in Table E5D2 below by using bold type as an indicator for acceptable operation at the indicated locations and for indicated ambient conditions when using the identified evaporative heat source(s).

TABLE E5D1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B4 | 62.3 | NA | −13.05 | 62.3 | 33.4 | NA | 3.0 | 33.4 |
| (R474B) | | | | | | | | |

In this mode the motor and inverter temperature can be maintained while heating the vehicle. In this case, the battery is assumed to be warming up while charging or at an appropriate temperature.

### Example 5E—Motor and Inverter Temperature Control While Heating the EV—Evaporative Heat Source 4: Motor, Inverter and PTC at Chiller Using R516A

In this example, a system of the present invention configured for operation to heat cabin air during periods of low ambient temperatures is illustrated in FIG. 7. The data obtained by operating the system with R1234yf and with RE1B5 is reported in the following Table E5E1. The use of Refrigerant RE1B5 (R516A) is reported in Table E5E2 below by using bold type as an indicator for acceptable operation at the indicated locations and for indicated ambient conditions when using the identified evaporative heat source(s).

TABLE E5E1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B5 | 62.3 | NA | −13.05 | 62.3 | 22.1 | NA | 2.0 | 22.1 |
| (R516A) | | | | | | | | |

TABLE E5E2
Evaporative Heat Source 4: Motor, Inverter and PTC at chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In this mode the motor and Inverter temperature can be maintained while heating the vehicle. In this case, the battery is assumed to be warming up while charging or at an appropriate temperature.

### Example 5F—Motor and Inverter Temperature Control While Heating the EV—Evaporative Heat Source 4: Motor, Inverter and PTC at Chiller Using R444A

In this example, a system of the present invention configured for operation to heat cabin air during periods of low ambient temperatures is illustrated in FIG. 7. The data obtained by operating the system with R1234yf and with RE1B6 is reported in the following Table E5F1. The use of Refrigerant RE1B6 (R444A) is reported in Table E5F2 below by using bold type as an indicator for acceptable operation at the indicated locations and for indicated ambient conditions when using the identified evaporative heat source(s).

TABLE E5F1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B6 | 62.3 | NA | −13.05 | 62.3 | 24.4 | NA | 1.7 | 24.4 |
| (R444A) | | | | | | | | |

In this mode the motor and Inverter temperature can be maintained while heating the vehicle. In this case, the battery is assumed to be warming up while charging or at an appropriate temperature.

### Example 5G—Motor and Inverter Temperature Control While Heating the EV—Evaporative Heat Source 4: Motor, Inverter and PTC at Chiller R457C

In this example, a system of the present invention configured for operation to heat cabin air during periods of low ambient temperatures is illustrated in FIG. 7. The data obtained by operating the system with R1234yf and with RE1B7 is reported in the following Table E5G1. The use of Refrigerant RE1B& (R457C) is reported in Table E5G2 below by using bold type as an indicator for acceptable operation at the indicated locations and for indicated ambient conditions when using the identified evaporative heat source(s).

TABLE E5G1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B7 | 62.3 | NA | −13.05 | 62.3 | 26.4 | NA | 2.2 | 36.4 |
| (R457C) | | | | | | | | |

In this mode the motor and inverter temperature can be maintained while heating the vehicle. In this case, the battery is assumed to be warming up while charging or at an appropriate temperature.

### Example 5H—Motor and Inverter Temperature Control While Heating the EV—Evaporative Heat Source 4: Motor, Inverter and PTC at Chiller Using R457D

In this example, a system of the present invention configured for operation to heat cabin air during periods of low ambient temperatures is illustrated in FIG. 7. The data obtained by operating the system with R1234yf and with RE1B8 is reported in the following Table E5H1. The use of Refrigerant RE1B8 (R457D) is reported in Table E5H2 below by using bold type as an indicator for acceptable operation at the indicated locations and for indicated ambient conditions when using the identified evaporative heat source(s).

TABLE E5H1
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.05 | 62.3 | 21.5 | NA | 2.0 | 21.5 |
| RE1B8 | 62.3 | NA | −13.05 | 62.3 | 24.5 | NA | 2.1 | 24.5 |
| (R457D) | | | | | | | | |

In this mode the motor and inverter temperature can be maintained while heating the vehicle. In this case, the battery is assumed to be warming up while charging or at an appropriate temperature.

### Example 6—Vehicle Heating Between −25° C. and 5° C. With Battery Charging

In this example, a system of the present invention configured for operation to heat cabin air during periods of low ambient temperatures is illustrated in FIG. 8 and in FIGS. 3A and 3B. The data obtained by operating the system of this example with R1234yf and with each of RE1B1, RE1B2, RE1B3, RE1B4, RE1B5, RE1B6, RE1B7 and RE1B8 is reported in the following Table E6.

TABLE E6
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.6 | NA | −8.94 | 60.6 | 20.7 | NA | 2.3 | 20.7 |
| RE1B1 | 60.6 | NA | −8.94 | 60.6 | 33.1 | NA | 3.3 | 33.1 |
| (R454C) | | | | | | | | |
| RE1B2 | 60.6 | NA | −8.94 | 60.6 | 36.6 | NA | 3.5 | 36.6 |
| (R455A) | | | | | | | | |
| RE1B3 | 60.6 | NA | −8.94 | 60.6 | 29.8 | NA | 3.1 | 29.8 |
| (R474A) | | | | | | | | |
| RE1B4 | 60.6 | NA | −8.94 | 60.6 | 32.3 | NA | 3.5 | 32.3 |
| (R474B) | | | | | | | | |
| RE1B5 | 60.6 | NA | −8.94 | 60.6 | 21.4 | NA | 2.3 | 21.4 |
| (R516A) | | | | | | | | |
| RE1B6 | 60.6 | NA | −8.94 | 60.6 | 23.6 | NA | 2.0 | 23.6 |
| (R444A) | | | | | | | | |
| RE1B7 | 60.6 | NA | −8.94 | 60.6 | 25.5 | NA | 2.6 | 25.5 |
| (R547C) | | | | | | | | |
| RE1B8 | 60.6 | NA | −8.94 | 60.6 | 23.6 | NA | 2.5 | 23.6 |
| (R547D) | | | | | | | | |

This is an efficient mode for vehicle heating between −25° C. and 5° C. while the battery is charging. Excess heat from charging or from the charging source can be used to heat the vehicle.

### Example 7A—Vehicle Heating with Ambient Between −35° C. and 5° C. With Battery Charging-Evaporative Heat Source 5: Motor, Inverter and PTC at Chiller

In this example, a system of the present invention configured for operation to heat cabin air during periods of low ambient temperatures is illustrated in FIG. 9. This system is operated with R1234yf and with each of RE1B1, RE1B2, RE1B3, RE1B4, RE1B5, RE1B6, RE1B7 and RE1B8 is reported in the following Table E7A1 and produces the results as reported in the following Table E7A2 by using bold type as an indicator for acceptable operation at the indicated locations and for indicated ambient conditions when using the identified evaporative heat source(s).

TABLE E7A1
Temperature and pressure data for Ambient
Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.7 | NA | 5.6 | 60.7 | 20.8 | NA | 3.8 | 20.8 |
| RE1B1 (R454C) | 60.7 | NA | 5.6 | 60.7 | 33.2 | NA | 5.5 | 33.2 |
| RE1B2 (R455A) | 60.7 | NA | 5.6 | 60.7 | 36.7 | NA | 5.8 | 36.7 |
| RE1B3 (R474A) | 60.7 | NA | 5.6 | 60.7 | 29.9 | NA | 5.1 | 29.9 |
| RE1B4 (R474B) | 60.7 | NA | 5.6 | 60.7 | 32.4 | NA | 5.6 | 32.4 |
| RE1B5 (R516A) | 60.7 | NA | 5.6 | 60.7 | 21.4 | NA | 3.9 | 21.4 |
| RE1B6 (R444A) | 60.7 | NA | 5.6 | 60.7 | 23.7 | NA | 3.3 | 23.7 |
| RE1B7 (R457C) | 60.7 | NA | 5.6 | 60.7 | 25.6 | NA | 4.3 | 25.6 |
| RE1B4 (R474D) | 60.7 | NA | 5.6 | 60.7 | 23.7 | NA | 4.1 | 23.7 |

TABLE E7A2
Evaporative Heat Source 5: Motor, Inverter and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating while maintaining the battery temperature between ambient conditions of −35° C. and 5° C. This mode would likely be used at the start of a drive after charging.

### Example 8A—Vehicle Heating with Ambient Between −15° C. and 5° C. With Battery Charging-Evaporative Heat Source 7: Battery, PTC and Air at OHE

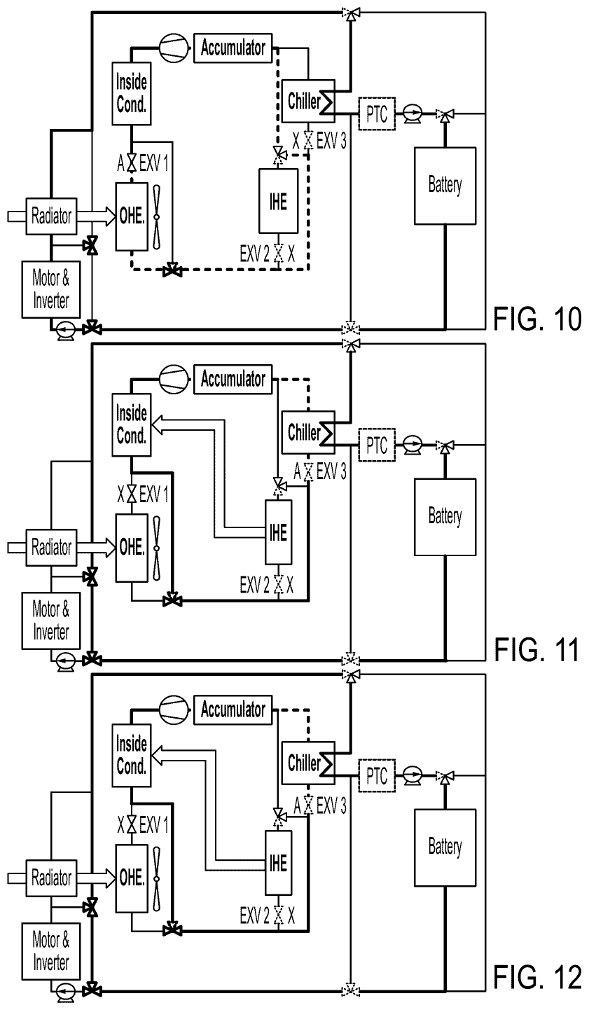

In this example, a system of the present invention configured for operation to heat cabin air during periods of low ambient temperatures is illustrated in FIG. 10. This system is operated with R1234yf and with RE1B1 and produces the results as reported in the following Table E8A1. The use of Refrigerant REIB1 (R454C) is reported in Table E8A2 below by using bold type as an indicator for acceptable operation at the indicated locations and for indicated ambient conditions when using the identified evaporative heat source(s).

TABLE E8A1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | −6.69 | 59.0 | 20.0 | NA | 2.5 | 20.0 |
| RE1B1 | 59.0 | NA | −6.69 | 59.0 | 32.1 | NA | 3.6 | 32.1 |
| (R454C) | | | | | | | | |

TABLE E8A2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8B—Vehicle Heating with Ambient Between −15° C. and 5° C. With Battery Charging-Evaporative Heat Source 7: Battery, PTC and Air at OHE

In this example, a system of the present invention configured for operation to heat cabin air during periods of low ambient temperatures is illustrated in FIG. 10. This system is operated with R1234yf and with RE1B2 and produces the results as reported in the following Table E8B1. The use of Refrigerant RE1B2 (R455A) is reported in Table E8B2 below by using bold type as an indicator for acceptable operation at the indicated locations and for indicated ambient conditions when using the identified evaporative heat source(s).

TABLE E8B1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | −6.69 | 59.0 | 20.0 | NA | 2.5 | 20.0 |
| RE1B2 | 59.0 | NA | −6.69 | 59.0 | 35.5 | NA | 3.8 | 35.5 |
| (R455A) | | | | | | | | |

TABLE E8B2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8C—Vehicle Heating with Ambient Between −15° C. and 5° C. With Battery Charging-Evaporative Heat Source 7: Battery, PTC and Air at OHE

In this example, a system of the present invention configured for operation to heat cabin air during periods of low ambient temperatures is illustrated in FIG. 10. This system is operated with R1234yf and with RE1B3 and produces the results as reported in the following Table E8C1. The use of Refrigerant RE1B3 (R474A) is reported in Table E8C2 below by using bold type as an indicator for acceptable operation at the indicated locations and for indicated ambient conditions when using the identified evaporative heat source(s).

TABLE E8C1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | −6.69 | 59.0 | 20.0 | NA | 2.5 | 20.0 |
| RE1B3 | 59.0 | NA | −6.69 | 59.0 | 28.9 | NA | 3.4 | 28.9 |
| (R474A) | | | | | | | | |

TABLE E8C2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8D—Vehicle Heating with Ambient Between −15° C. and 5° C. With Battery Charging-Evaporative Heat Source 7: Battery, PTC and Air at OHE

In this example, a system of the present invention configured for operation to heat cabin air during periods of low ambient temperatures is illustrated in FIG. 10. This system is operated with R1234yf and with RE1B4 and produces the results as reported in the following Table E8D1. The use of Refrigerant RE1B4 (R474B) is reported in Table E8D2 below by using bold type as an indicator for acceptable operation at the indicated locations and for indicated ambient conditions when using the identified evaporative heat source(s).

TABLE E8D1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | −6.69 | 59.0 | 20.0 | NA | 2.5 | 20.0 |
| RE1B4 | 59.0 | NA | −6.69 | 59.0 | 31.3 | NA | 3.7 | 31.3 |
| (R474B) | | | | | | | | |

TABLE E8D2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8E—Vehicle Heating with Ambient Between −15° C. and 5° C. With Battery Charging-Evaporative Heat Source 7: Battery, PTC and Air at OHE Using R516A

In this example, a system of the present invention configured for operation to heat cabin air during periods of low ambient temperatures is illustrated in FIG. 10. This system is operated with R1234yf and with RE1B5 and produces the results as reported in the following Table E8E1. The use of Refrigerant RE1B5 (R516A) is reported in Table E8E2 below by using bold type as an indicator for acceptable operation at the indicated locations and for indicated ambient conditions when using the identified evaporative heat source(s).

TABLE E8E1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B5 | 59.0 | NA | −6.69 | 59.0 | 20.6 | NA | 2.5 | 20.6 |
| (R516A) | | | | | | | | |

TABLE E8E2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8F—Vehicle Heating with Ambient Between −15° C. and 5° C. With Battery Charging-Evaporative Heat Source 7: Battery, PTC and Air at OHE Using R444A

In this example, a system of the present invention configured for operation to heat cabin air during periods of low ambient temperatures is illustrated in FIG. 10. This system is operated with R1234yf and with RE1B6 and produces the results as reported in the following Table E8F1. The use of Refrigerant RE1B6 (R444A) is reported in Table E8F2 below by using bold type as an indicator for acceptable operation at the indicated locations and for indicated ambient conditions when using the identified evaporative heat source(s).

TABLE E8F1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B6 | 59.0 | NA | −6.69 | 59.0 | 22.8 | NA | 2.1 | 22.8 |
| (R444A) | | | | | | | | |

TABLE E8F2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8G—Vehicle Heating with Ambient Between −15° C. and 5° C. With Battery Charging-Evaporative Heat Source 7: Battery, PTC and Air at OHE Using R457C

In this example, a system of the present invention configured for operation to heat cabin air during periods of low ambient temperatures is illustrated in FIG. 10. This system is operated with R1234yf and with RE1B7 and produces the results as reported in the following Table E8G1. The use of Refrigerant RE1B7 (R457C) is reported in Table E8G2 below by using bold type as an indicator for acceptable operation at the indicated locations and for indicated ambient conditions when using the identified evaporative heat source(s).

TABLE E8G1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B7 | 59.0 | NA | −6.69 | 59.0 | 24.7 | NA | 2.8 | 24.7 |
| (R457C) | | | | | | | | |

TABLE E8G2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 8H—Vehicle Heating with Ambient Between −15° C. and 5° C. With Battery Charging-Evaporative Heat Source 7: Battery, PTC and Air at OHE

In this example, a system of the present invention configured for operation to heat cabin air during periods of low ambient temperatures is illustrated in FIG. 10. This system is operated with R1234yf and with RE1B8 and produces the results as reported in the following Table E8H1. The use of Refrigerant RE1B8 (R457D) is reported in Table E8H2 below by using bold type as an indicator for acceptable operation at the indicated locations and for indicated ambient conditions when using the identified evaporative heat source(s).

TABLE E8H1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B8 | 59.0 | NA | −6.69 | 59.0 | 22.9 | NA | 2.7 | 22.9 |
| (R457D) | | | | | | | | |

TABLE E8H2
Evaporative Heat Source 7: Battery, PTC and Air at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 9A—Vehicle Heating with Ambient Between −15° C. and 15° C. While Driving—Evaporative Heat Source 8: Inverter and Battery at Chiller Using R454C

In this example, a system of the present invention configured for operation to heat cabin air during periods of low ambient temperatures is illustrated in FIG. 11. This system is operated with R1234yf and with RE1B1 and produces the results as reported in the following Table E9A1. The use of Refrigerant REIB1 (R454C) is reported in Table E9A2 below by using bold type as an indicator for acceptable operation at the indicated locations and for indicated ambient conditions when using the identified evaporative heat source(s).

TABLE E9A1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.27 | 62.3 | 21.5 | NA | 2.0 | 21.5 |
| RE1B1 | 62.3 | NA | −13.27 | 62.3 | 34.2 | NA | 2.8 | 34.2 |
| (R454C) | | | | | | | | |

TABLE E9A2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 9B—Vehicle Heating with Ambient Between −15° C. and 15° C. While Driving—Evaporative Heat Source 8: Inverter and Battery at Chiller Using R454C

In this example, a system of the present invention configured for operation to heat cabin air during periods of low ambient temperatures is illustrated in FIG. 11. This system is operated with R1234yf and with RE1B2 and produces the results as reported in the following Table E9B1. The use of Refrigerant RE1B2 (R454C) is reported in Table E9B2 below by using bold type as an indicator for acceptable operation at the indicated locations and for indicated ambient conditions when using the identified evaporative heat source(s).

TABLE E9B1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.27 | 62.3 | 21.5 | NA | 2.0 | 21.5 |
| RE1B2 | 62.3 | NA | −13.27 | 62.3 | 37.7 | NA | 3.0 | 37.7 |
| (R455A) | | | | | | | | |

TABLE E9B2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 9C—Vehicle Heating with Ambient Between −15° C. and 15° C. While Driving—Evaporative Heat Source 8: Inverter and Battery at Chiller Using R474A

In this example, a system of the present invention configured for operation to heat cabin air during periods of low ambient temperatures is illustrated in FIG. 11. This system is operated with R1234yf and with RE1B3 and produces the results as reported in the following Table E9C1. The use of Refrigerant RE1B3 (R474A) is reported in Table E9C2 below by using bold type as an indicator for acceptable operation at the indicated locations and for indicated ambient conditions when using the identified evaporative heat source(s).

TABLE E9C1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.27 | 62.3 | 21.5 | NA | 2.0 | 21.5 |
| RE1B3 | 62.3 | NA | −13.27 | 62.3 | 30.8 | NA | 2.7 | 30.8 |
| (R474A) | | | | | | | | |

TABLE E9C2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 15° C. while driving. Excess heat from the battery and motor and inverter can be used at the chiller. This can also be used with the enhanced heat pump configuration (dotted line).

### Example 9D—Vehicle Heating with Ambient Between −15° C. and 15° C. While Driving—Evaporative Heat Source 8: Inverter and Battery at Chiller Using R474B

In this example, a system of the present invention configured for operation to heat cabin air during periods of low ambient temperatures is illustrated in FIG. 11. This system is operated with R1234yf and with REIB4 and produces the results as reported in the following Table E9D1. The use of Refrigerant RE1B4 (R474B) is reported in Table E9D2 below by using bold type as an indicator for acceptable operation at the indicated locations and for indicated ambient conditions when using the identified evaporative heat source(s).

TABLE E9D1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.27 | 62.3 | 21.5 | NA | 2.0 | 21.5 |
| RE1B4 | 62.3 | NA | −13.27 | 62.3 | 33.4 | NA | 3.0 | 33.4 |
| (R474B) | | | | | | | | |

TABLE E9D2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 9E—Vehicle Heating with Ambient Between −15° C. and 15° C. While Driving—Evaporative Heat Source 8: Inverter and Battery at Chiller Using R516A

In this example, a system of the present invention configured for operation to heat cabin air during periods of low ambient temperatures is illustrated in FIG. 11. This system is operated with R1234yf and with RE1B5 and produces the results as reported in the following Table E9E1. The use of Refrigerant RE1B5 (R516A) is reported in Table E9E2 below by using bold type as an indicator for acceptable operation at the indicated locations and for indicated ambient conditions when using the identified evaporative heat source(s).

TABLE E9E1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B5 | 59.0 | NA | −6.69 | 59.0 | 20.9 | NA | 6.6 | 30.9 |
| (R516A) | | | | | | | | |

TABLE E9E2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 9F—Vehicle Heating with Ambient Between −15° C. and 15° C. While Driving—Evaporative Heat Source 8: Inverter and Battery at Chiller R444A

In this example, a system of the present invention configured for operation to heat cabin air during periods of low ambient temperatures is illustrated in FIG. 11. This system is operated with R1234yf and with RE1B6 and produces the results as reported in the following Table E9F1. The use of Refrigerant RE1B6 (R444A) is reported in Table E9F2 below by using bold type as an indicator for acceptable operation at the indicated locations and for indicated ambient conditions when using the identified evaporative heat source(s).

TABLE E9F1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B6 | 59.0 | NA | −6.69 | 59.0 | 23.1 | NA | 5.9 | 23.1 |
| (R444A) | | | | | | | | |

TABLE E9F2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 15° C. while driving. Excess heat from the battery and motor and inverter can be used at the chiller. This can also be used with the enhanced heat pump configuration (dotted line).

### Example 9G—Vehicle Heating with Ambient Between −15° C. and 15° C. While Driving—Evaporative Heat Source 8: Inverter and Battery at Chiller Using R457C

In this example, a system of the present invention configured for operation to heat cabin air during periods of low ambient temperatures is illustrated in FIG. 11. This system is operated with R1234yf and with RE1B7 and produces the results as reported in the following Table E9G1. The use of Refrigerant RE1B7 (R457C) is reported in Table E9G2 below by using bold type as an indicator for acceptable operation at the indicated locations and for indicated ambient conditions when using the identified evaporative heat source(s).

TABLE E9G1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B7 | 59.0 | NA | −6.69 | 59.0 | 25.0 | NA | 7.3 | 23.2 |
| (R457C) | | | | | | | | |

TABLE E9G2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 9H—Vehicle Heating with Ambient Between −15° C. and 15° C. While Driving—Evaporative Heat Source 8: Inverter and Battery at Chiller Using R457D

In this example, a system of the present invention configured for operation to heat cabin air during periods of low ambient temperatures is illustrated in FIG. 11. This system is operated with R1234yf and with RE1B8 and produces the results as reported in the following Table E9H1. The use of Refrigerant RE1B8 (R457D) is reported in Table E9H2 below by using bold type as an indicator for acceptable operation at the indicated locations and for indicated ambient conditions when using the identified evaporative heat source(s).

TABLE E9H1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B8 | 59.0 | NA | −6.69 | 59.0 | 22.9 | NA | 2.7 | 22.9 |
| (R457D) | | | | | | | | |

TABLE E9H2
Evaporative Heat Source 8: Inverter and Battery at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the chiller. This can also be used with the enhanced heat pump configuration (dotted line).

### Example 10A—Vehicle Heating with Ambient Between −25° C. and 5° C. While Driving—Evaporative Heat Source 9: Motor, Inverter, Battery and PTC at Chiller Using R 454C

In this example, a system of the present invention configured for operation to heat cabin air during periods of low ambient temperatures is illustrated in FIG. 12. This system is operated with R1234yf and with REIB1 and produced the results as reported in the following Table E10A1. The use of Refrigerant RE1B1 (R454C) is reported in Table E10A2 below by using bold type as an indicator for acceptable operation at the indicated locations and for indicated ambient conditions when using the identified evaporative heat source(s).

TABLE E10A1
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.6 | NA | 22.77 | 59.6 | 20.3 | NA | 6.4 | 20.3 |
| RE1B1 | 59.6 | NA | 22.77 | 59.6 | 32.5 | NA | 9.2 | 32.5 |
| (R454C) | | | | | | | | |

TABLE E10A2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10B—Vehicle Heating with Ambient Between −25° C. and 5° C. While Driving—Evaporative Heat Source 9: Motor, Inverter, Battery and PTC at Chiller Using R455A

In this example, a system of the present invention configured for operation to heat cabin air during periods of low ambient temperatures is illustrated in FIG. 12. This system is operated with R1234yf and with RE1B2 and produced the results as reported in the following Table E10B1. The use of Refrigerant RE1B2 (R455A) is reported in Table E10B2 below by using bold type as an indicator for acceptable operation at the indicated locations and for indicated ambient conditions when using the identified evaporative heat source(s).

TABLE E10B1
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.6 | NA | 22.77 | 59.6 | 20.3 | NA | 6.4 | 20.3 |
| RE1B2 | 59.6 | NA | 22.77 | 59.6 | 35.9 | NA | 9.8 | 35.9 |
| (R455A) | | | | | | | | |

TABLE E10B2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10C—Vehicle Heating with Ambient Between −25° C. and 5° C. While Driving—Evaporative Heat Source 9: Motor, Inverter, Battery and PTC at Chiller Using R474A

In this example, a system of the present invention configured for operation to heat cabin air during periods of low ambient temperatures is illustrated in FIG. 12. This system is operated with R1234yf and with RE1B3 and produced the results as reported in the following Table E10C1. The use of Refrigerant RE1B3 (R474A) is reported in Table E10C2 below by using bold type as an indicator for acceptable operation at the indicated locations and for indicated ambient conditions when using the identified evaporative heat source(s).

TABLE E10C1
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.6 | NA | 22.77 | 59.6 | 20.3 | NA | 6.4 | 20.3 |
| RE1B3 | 59.6 | NA | 22.77 | 59.6 | 29.2 | NA | 8.6 | 29.2 |
| (R474A) | | | | | | | | |

TABLE E10C2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10D—Vehicle Heating with Ambient Between −25° C. and 5° C. While Driving—Evaporative Heat Source 9: Motor, Inverter, Battery and PTC at Chiller Using R474B

In this example, a system of the present invention configured for operation to heat cabin air during periods of low ambient temperatures is illustrated in FIG. 12. This system is operated with R1234yf and with RE1B4 and produced the results as reported in the following Table E10D1. The use of Refrigerant RE1B4 (R474B) is reported in Table E10D2 below by using bold type as an indicator for acceptable operation at the indicated locations and for indicated ambient conditions when using the identified evaporative heat source(s).

TABLE E10D1
Temperature and pressure data for Ambient Temperature of −15° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.6 | NA | 22.77 | 59.6 | 20.3 | NA | 6.4 | 20.3 |
| RE1B4 (R474B) | 59.6 | NA | 22.77 | 59.6 | 31.7 | NA | 9.4 | 31.7 |

TABLE E10D2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10E—Vehicle Heating with Ambient Between −25° C. and 5° C. While Driving—Evaporative Heat Source 9: Motor, Inverter, Battery and PTC at Chiller Using R516A

In this example, a system of the present invention configured for operation to heat cabin air during periods of low ambient temperatures is illustrated in FIG. 12. This system is operated with R1234yf and with RE1B5 and produced the results as reported in the following Table E10E1. The use of Refrigerant RE1B5 (R516A) is reported in Table E10E2 below by using bold type as an indicator for acceptable operation at the indicated locations and for indicated ambient conditions when using the identified evaporative heat source(s).

TABLE E10E1
Temperature and pressure data for Ambient Temperature of −15° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.27 | 62.3 | 21.5 | NA | 2.0 | 21.5 |
| RE1B5 (R454C) | 62.3 | NA | −13.27 | 62.3 | 22.1 | NA | 2.0 | 22.1 |

TABLE E10E2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10F—Vehicle Heating with Ambient Between −25° C. and 5° C. While Driving—Evaporative Heat Source 9: Motor, Inverter, Battery and PTC at Chiller Using R444A

In this example, a system of the present invention configured for operation to heat cabin air during periods of low ambient temperatures is illustrated in FIG. 12. This system is operated with R1234yf and with RE1B6 and produced the results as reported in the following Table E10F1. The use of Refrigerant RE1B6 (R444A) is reported in Table E10F2 below by using bold type as an indicator for acceptable operation at the indicated locations and for indicated ambient conditions when using the identified evaporative heat source(s).

TABLE E10F1
Temperature and pressure data for Ambient Temperature of −15° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.27 | 62.3 | 21.5 | NA | 2.0 | 21.5 |
| RE1B6 (R444A) | 62.3 | NA | −13.27 | 62.3 | 24.4 | NA | 1.6 | 24.4 |

TABLE E10F2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10G—Vehicle Heating with Ambient Between −25° C. and 5° C. While Driving—Evaporative Heat Source 9: Motor, Inverter, Battery and PTC at Chiller Using R474A

In this example, a system of the present invention configured for operation to heat cabin air during periods of low ambient temperatures is illustrated in FIG. 12. This system is operated with R1234yf and with RE1B7 and produced the results as reported in the following Table E10G1. The use of Refrigerant RE1B7 (R474A) is reported in Table E10G2 below by using bold type as an indicator for acceptable operation at the indicated locations and for indicated ambient conditions when using the identified evaporative heat source(s).

TABLE E10G1
Temperature and pressure data for Ambient Temperature of −15° C.

| | T4 | T5 | T6 | T7 | pl | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.27 | 62.3 | 21.5 | NA | 2.0 | 21.5 |
| RE1B7 (R457C) | 62.3 | NA | −13.27 | 62.3 | 26.4 | NA | 2.2 | 26.4 |

TABLE E10G2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 10H—Vehicle Heating with Ambient Between −25° C. and 5° C. While Driving—Evaporative Heat Source 9: Motor, Inverter, Battery and PTC at Chiller Using R457D

In this example, a system of the present invention configured for operation to heat cabin air during periods of low ambient temperatures is illustrated in FIG. 12. This system is operated with R1234yf and with RE1B8 and produced the results as reported in the following Table E10H1. The use of Refrigerant RE1B8 (R457D) is reported in Table E10H2 below by using bold type as an indicator for acceptable operation at the indicated locations and for indicated ambient conditions when using the identified evaporative heat source(s).

TABLE E10H1
Temperature and pressure data for Ambient Temperature of −15° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −13.27 | 62.3 | 21.5 | NA | 2.0 | 21.5 |
| RE1B8 (R457D) | 62.3 | NA | −13.27 | 62.3 | 24.5 | NA | 2.1 | 24.5 |

TABLE E10H2
Evaporative Heat Source 9: Motor, Inverter,
Battery and PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 11A—Vehicle Heating with Ambient Between −15° C. and 15° C. While Driving—Evaporative Heat Source 10: Motor, Inverter, Battery at OHE

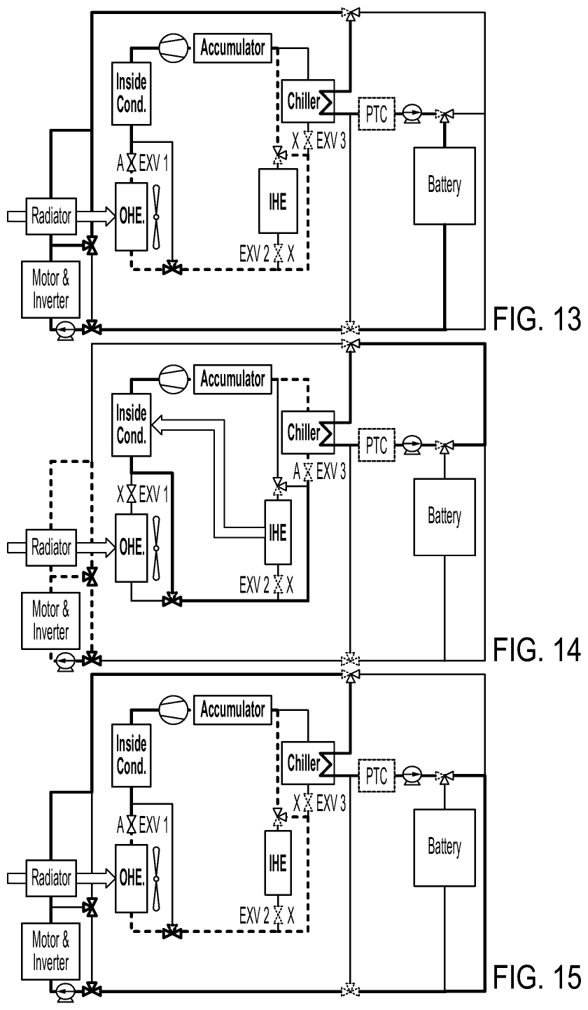

In this example, a system of the present invention configured for operation to heat cabin air during periods of low ambient temperatures is illustrated in FIG. 13. This system is operated with R1234yf and with RE1B1 and produces the results as reported in the following Table E11A1. The use of Refrigerant RE1B1 (R454C) is reported in Table E11A2 below by using bold type as an indicator for acceptable operation at the indicated locations and for indicated ambient conditions when using the identified evaporative heat source(s).

TABLE E11A1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B1 (R454C) | 59.0 | NA | 2.55 | 59.0 | 32.1 | NA | 4.9 | 32.1 |

TABLE E11A2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11B—Vehicle Heating with Ambient Between −15° C. and 15° C. While Driving—Evaporative Heat Source 10: Motor, Inverter, Battery at OHE

In this example, a system of the present invention configured for operation to heat cabin air during periods of low ambient temperatures is illustrated in FIG. 13. This system is operated with R1234yf and with RE1B2 and produces the results as reported in the following Table E11B1. The use of Refrigerant RE1B2 (R455A) is reported in Table E11B2 below by using bold type as an indicator for acceptable operation at the indicated locations and for indicated ambient conditions when using the identified evaporative heat source(s).

TABLE E11B1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B2 (R455A) | 59.0 | NA | 2.55 | 59.0 | 35.5 | NA | 5.3 | 35.5 |

TABLE E11B2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11C—Vehicle Heating with Ambient Between −15° C. and 15° C. While Driving—Evaporative Heat Source 10: Motor, Inverter, Battery at OHE

In this example, a system of the present invention configured for operation to heat cabin air during periods of low ambient temperatures is illustrated in FIG. 13. This system is operated with R1234yf and with RE1B3 and produces the results as reported in the following Table E11C1. The use of Refrigerant RE1B3 (R474A) is reported in Table E11C2 below by using bold type as an indicator for acceptable operation at the indicated locations and for indicated ambient conditions when using the identified evaporative heat source(s).

TABLE E11C1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B3 (R474A) | 59.0 | NA | 2.55 | 59.0 | 28.9 | NA | 4.6 | 28.9 |

TABLE E11C2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11D—Vehicle Heating with Ambient Between −15° C. and 15° C. While Driving—Evaporative Heat Source 10: Motor, Inverter, Battery at OHE

In this example, a system of the present invention configured for operation to heat cabin air during periods of low ambient temperatures is illustrated in FIG. 13. This system is operated with R1234yf and with RE1B4 and produces the results as reported in the following Table E11D1. The use of Refrigerant RE1B4 (R474BA) is reported in Table E11D2 below by using bold type as an indicator for acceptable operation at the indicated locations and for indicated ambient conditions when using the identified evaporative heat source(s).

TABLE E11D1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B4 (R474B) | 59.0 | NA | 2.55 | 59.0 | 31.3 | NA | 5.1 | 31.3 |

TABLE E11D2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 15° C. while driving. Excess heat from the battery and motor and inverter can be used at the OHE. This can also be used to defrost the OHE in the event of freezing.

### Example 11E—Vehicle Heating with Ambient Between −15° C. and 15° C. While Driving—Evaporative Heat Source 10: Motor, Inverter, Battery at OHE Using R454C

In this example, a system of the present invention configured for operation to heat cabin air during periods of low ambient temperatures is illustrated in FIG. 13. This system is operated with R1234yf and with RE1B5 and produces the results as reported in the following Table E11E1. The use of Refrigerant RE1B5 (R454C) is reported in Table E11E2 below by using bold type as an indicator for acceptable operation at the indicated locations and for indicated ambient conditions when using the identified evaporative heat source(s).

TABLE E11E1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B5 (R516A) | 59.0 | NA | 2.55 | 59.0 | 20.6 | NA | 3.5 | 20.6 |

TABLE E11E2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11F—Vehicle Heating with Ambient Between −15° C. and 15° C. While Driving—Evaporative Heat Source 10: Motor, Inverter, Battery at OHE Using R444B

In this example, a system of the present invention configured for operation to heat cabin air during periods of low ambient temperatures is illustrated in FIG. 13. This system is operated with R1234yf and with RE1B6 and produces the results as reported in the following Table E11F1. The use of Refrigerant RE1B6 (R444A) is reported in Table E11F2 below by using bold type as an indicator for acceptable operation at the indicated locations and for indicated ambient conditions when using the identified evaporative heat source(s).

TABLE E11F1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B6 (R455A) | 59.0 | NA | 2.55 | 59.0 | 22.8 | NA | 3.0 | 22.8 |

TABLE E11F2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11G—Vehicle Heating with Ambient Between −15° C. and 15° C. While Driving—Evaporative Heat Source 10: Motor, Inverter, Battery at OHE Using R457C

In this example, a system of the present invention configured for operation to heat cabin air during periods of low ambient temperatures is illustrated in FIG. 13. This system is operated with R1234yf and with REIB3 and produces the results as reported in the following Table E11G1. The use of Refrigerant RE1B7 (R457C) is reported in Table E11G2 below by using bold type as an indicator for acceptable operation at the indicated locations and for indicated ambient conditions when using the identified evaporative heat source(s).

TABLE E11G1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B7 (R457C) | 59.0 | NA | 2.55 | 59.0 | 24.7 | NA | 3.9 | 24.7 |

TABLE E11G2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 11H—Vehicle Heating with Ambient Between −15° C. and 15° C. While Driving—Evaporative Heat Source 10: Motor, Inverter, Battery at OHE Using R457D

In this example, a system of the present invention configured for operation to heat cabin air during periods of low ambient temperatures is illustrated in FIG. 13. This system is operated with R1234yf and with RE1B8 and produces the results as reported in the following Table E11H1. The use of Refrigerant RE1B8 (R457D) is reported in Table E11H2 below by using bold type as an indicator for acceptable operation at the indicated locations and for indicated ambient conditions when using the identified evaporative heat source(s).

TABLE E11H1
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 59.0 | NA | 2.55 | 59.0 | 20.0 | NA | 3.4 | 20.0 |
| RE1B8 (R457D) | 59.0 | NA | 2.55 | 59.0 | 22.9 | NA | 3.7 | 22.9 |

TABLE E11H2
Evaporative Heat Source 10: Motor, inverter, battery at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Excess heat from the battery and motor and inverter can be used at the OHE. This can also be used to defrost the OHE in the event of freezing.

### Example 12A—Vehicle Heating with Ambient Between −35° C. and 5° C. With Battery Charging-Evaporative Heat Source 11: PTC at Chiller Using R454C

In this example, a system of the present invention configured for operation to heat cabin air during periods of low ambient temperatures is illustrated in FIG. 14. This system is operated with R1234yf and with REIB1 and produces the results as reported in the following Table E12A1. The use of Refrigerant REIB1 (R454C) is reported in Table E12A2 below by using bold type as an indicator for acceptable operation at the indicated locations and for indicated ambient conditions when using the identified evaporative heat source(s).

TABLE E12A1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B1 (R454C) | 60.9 | NA | −7.04 | 60.9 | 33.3 | NA | 3.6 | 33.3 |

TABLE E12A2
Evaporative Heat Source 11: PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12B—Vehicle Heating with Ambient Between −35° C. and 5° C. With Battery Charging-Evaporative Heat Source 11: PTC at Chiller Using R455A

In this example, a system of the present invention configured for operation to heat cabin air during periods of low ambient temperatures is illustrated in FIG. 14. This system is operated with R1234yf and with RE1B2 and produces the results as reported in the following Table E12B1. The use of Refrigerant RE1B2 (R455A) is reported in Table E12B2 below by using bold type as an indicator for acceptable operation at the indicated locations and for indicated ambient conditions when using the identified evaporative heat source(s).

TABLE E12B1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B2 (R455A) | 60.9 | NA | −7.04 | 60.9 | 36.8 | NA | 3.8 | 36.8 |

TABLE E12B2
Evaporative Heat Source 11: PTC at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12C—Vehicle Heating with Ambient Between −35° C. and 5° C. With Battery Charging-Evaporative Heat Source 11: PTC at Chiller Using R474A

In this example, a system of the present invention configured for operation to heat cabin air during periods of low ambient temperatures is illustrated in FIG. 14. This system is operated with R1234yf and with RE1B3 and produces the results as reported in the following Table E12C1. The use of Refrigerant RE1B3 (R474A) is reported in Table E12C2 below by using bold type as an indicator for acceptable operation at the indicated locations and for indicated ambient conditions when using the identified evaporative heat source(s).

TABLE E12C1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B3 (R474A) | 60.9 | NA | −7.04 | 60.9 | 30.0 | NA | 3.3 | 30.0 |

TABLE E12C2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12D—Vehicle Heating with Ambient Between −35° C. and 5° C. With Battery Charging-Evaporative Heat Source 11: PTC at Chiller Using R474B

In this example, a system of the present invention configured for operation to heat cabin air during periods of low ambient temperatures is illustrated in FIG. 14. This system is operated with R1234yf and with RE1B4 and produces the results as reported in the following Table E12D1. The use of Refrigerant REIB4 (R474B) is reported in Table E12D2 below by using bold type as an indicator for acceptable operation at the indicated locations and for indicated ambient conditions when using the identified evaporative heat source(s).

TABLE E12D1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B4 (R474B) | 60.9 | NA | −7.04 | 60.9 | 32.5 | NA | 3.7 | 32.5 |

TABLE E12D2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12E—Vehicle Heating with Ambient Between −35° C. and 5° C. With Battery Charging-Evaporative Heat Source 11: PTC at Chiller Using R516A

In this example, a system of the present invention configured for operation to heat cabin air during periods of low ambient temperatures is illustrated in FIG. 14. This system is operated with R1234yf and with RE1B5 and produces the results as reported in the following Table E12E1. The use of Refrigerant RE1B5 (R516A) is reported in Table E12E2 below by using bold type as an indicator for acceptable operation at the indicated locations and for indicated ambient conditions when using the identified evaporative heat source(s).

TABLE E12E1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B5 (R454C) | 60.9 | NA | −7.04 | 60.9 | 21.5 | NA | 2.5 | 21.5 |

TABLE E12E2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12F—Vehicle Heating with Ambient Between −35° C. and 5° C. With Battery Charging-Evaporative Heat Source 11: PTC at Chiller Using R444B

In this example, a system of the present invention configured for operation to heat cabin air during periods of low ambient temperatures is illustrated in FIG. 14. This system is operated with R1234yf and with RE1B6 and produces the results as reported in the following Table E12F1. The use of Refrigerant RE1B6 (R444A) is reported in Table E12F2 below by using bold type as an indicator for acceptable operation at the indicated locations and for indicated ambient conditions when using the identified evaporative heat source(s).

TABLE E12F1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B6 (R444A) | 60.9 | NA | −7.04 | 60.9 | 23.7 | NA | 2.1 | 23.7 |

TABLE E12F2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12G—Vehicle Heating with Ambient Between −35° C. and 5° C. With Battery Charging-Evaporative Heat Source 11: PTC at Chiller Using R 457C

In this example, a system of the present invention configured for operation to heat cabin air during periods of low ambient temperatures is illustrated in FIG. 14. This system is operated with R1234yf and with RE1B7 and produces the results as reported in the following Table E12G1. The use of Refrigerant RE1B7 (R457C) is reported in Table E12G2 below by using bold type as an indicator for acceptable operation at the indicated locations and for indicated ambient conditions when using the identified evaporative heat source(s).

TABLE E12G1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B7 (R457C) | 60.9 | NA | −7.04 | 60.9 | 25.7 | NA | 2.8 | 25.7 |

TABLE E12G2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 12H—Vehicle Heating with Ambient Between −35° C. and 5° C. With Battery Charging-Evaporative Heat Source 11: PTC at Chiller

In this example, a system of the present invention configured for operation to heat cabin air during periods of low ambient temperatures is illustrated in FIG. 14. This system is operated with R1234yf and with RE1B8 and produces the results as reported in the following Table E12H1. The use of Refrigerant RE1B8 (R457D) is reported in Table E12H2 below by using bold type as an indicator for acceptable operation at the indicated locations and for indicated ambient conditions when using the identified evaporative heat source(s).

TABLE E12H1
Temperature and pressure data for Ambient Temperature of −25° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 60.9 | NA | −7.04 | 60.9 | 20.8 | NA | 2.5 | 20.8 |
| RE1B8 (R457D) | 60.9 | NA | −7.04 | 23.8 | NA | 2.7 | 23.8 | 23.8 |

TABLE E12H2
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 13A—Vehicle Heating with Ambient Between −15° C. and 5° C. With Battery Charging or Driving-Evaporative Heat Source 12: PTC at OHE

In this example, a system of the present invention configured for operation to heat cabin air during periods of low ambient temperatures is illustrated in FIG. 15. This system is operated with R1234yf and with RE1B1 and produces the results as reported in the following Table E13A1. The use of Refrigerant REIB1 (R454C) is reported in Table E13A2 below by using bold type as an indicator for acceptable operation at the indicated locations and for indicated ambient conditions when using the identified evaporative heat source(s).

TABLE E13A1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C] | [C] | [C] | [C] | [bar] | [bar] | [bar] | [bar] |
| R-1234yf | 62.3 | NA | −7.27 | 62.3 | 21.5 | NA | 2.4 | 21.5 |
| RE1B1 (R454C) | 62.3 | NA | −7.27 | 62.3 | 34.2 | NA | 3.5 | 34.2 |

TABLE E13A2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13B—Vehicle Heating with Ambient Between −15° C. and 5° C. With Battery Charging or Driving-Evaporative Heat Source 12: PTC at OHE

In this example, a system of the present invention configured for operation to heat cabin air during periods of low ambient temperatures is illustrated in FIG. 15. This system is operated with R1234yf and with RE1B2 and produces the results as reported in the following Table E13B1. The use of Refrigerant RE1B2 (R455A) is reported in Table E13B2 below by using bold type as an indicator for acceptable operation at the indicated locations and for indicated ambient conditions when using the identified evaporative heat source(s).

TABLE E13B1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B2 | 62.3 | NA | −7.27 | 62.3 | 37.7 | NA | 3.8 | 37.7 |
| (R455A) | | | | | | | | |

TABLE E13B2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13C—Vehicle Heating with Ambient Between −15° C. and 5° C. With Battery Charging or Driving-Evaporative Heat Source 12: PTC at OHE

In this example, a system of the present invention configured for operation to heat cabin air during periods of low ambient temperatures is illustrated in FIG. 15. This system is operated with R1234yf and with RE1B3 and produces the results as reported in the following Table E13C1. The use of Refrigerant RE1B3 (R474A) is reported in Table E13C2 below by using bold type as an indicator for acceptable operation at the indicated locations and for indicated ambient conditions when using the identified evaporative heat source(s).

TABLE E13C1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B3 | 62.3 | NA | −7.27 | 62.3 | 30.8 | NA | 3.3 | 30.8 |
| (R474A) | | | | | | | | |

TABLE E13C2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13D—Vehicle Heating with Ambient Between −15° C. and 5° C. With Battery Charging or Driving-Evaporative Heat Source 12: PTC at OHE

In this example, a system of the present invention configured for operation to heat cabin air during periods of low ambient temperatures is illustrated in FIG. 15. This system is operated with R1234yf and with RE1B4 and produces the results as reported in the following Table E13D1. The use of Refrigerant RE1B4 (R474B) is reported in Table E13D2 below by using bold type as an indicator for acceptable operation at the indicated locations and for indicated ambient conditions when using the identified evaporative heat source(s).

TABLE E13D1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B4 | 62.3 | NA | −7.27 | 62.3 | 33.4 | NA | 3.7 | 33.4 |
| (R474B) | | | | | | | | |

TABLE E13D2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13E—Vehicle Heating with Ambient Between −15° C. and 5° C. With Battery Charging or Driving-Evaporative Heat Source 12: PTC at OHE Using R516A

In this example, a system of the present invention configured for operation to heat cabin air during periods of low ambient temperatures is illustrated in FIG. 15. This system is operated with R1234yf and with RE1B5 and produces the results as reported in the following Table E13E1. The use of Refrigerant RE1B5 (R516A) is reported in Table E13E2 below by using bold type as an indicator for acceptable operation at the indicated locations and for indicated ambient conditions when using the identified evaporative heat source(s).

TABLE E13E1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B5 | 62.3 | NA | −7.27 | 62.3 | 22.2 | NA | 2.5 | 22.2 |
| (R454C) | | | | | | | | |

TABLE E13E2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13F—Vehicle Heating with Ambient Between −15° C. and 5° C. With Battery Charging or Driving-Evaporative Heat Source 12: PTC at OHE Using R444B

In this example, a system of the present invention configured for operation to heat cabin air during periods of low ambient temperatures is illustrated in FIG. 15. This system is operated with R1234yf and with RE1B2 and produces the results as reported in the following Table E13F1. The use of Refrigerant RE1B6 (R444A) is reported in Table E13F2 below by using bold type as an indicator for acceptable operation at the indicated locations and for indicated ambient conditions when using the identified evaporative heat source(s).

TABLE E13F1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B6 | 62.3 | NA | −7.27 | 62.3 | 24.4 | NA | 2.1 | 24.4 |
| (R444A) | | | | | | | | |

TABLE E13F2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13G—Vehicle Heating with Ambient Between −15° C. and 5° C. With Battery Charging or Driving-Evaporative Heat Source 12: PTC at OHE Using R444B

In this example, a system of the present invention configured for operation to heat cabin air during periods of low ambient temperatures is illustrated in FIG. 15. This system is operated with R1234yf and with RE1B7 and produces the results as reported in the following Table E13G1. The use of Refrigerant RE1B7 (R457C) is reported in Table E13G2 below by using bold type as an indicator for acceptable operation at the indicated locations and for indicated ambient conditions when using the identified evaporative heat source(s).

TABLE E13G1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B7 | 62.3 | NA | −7.27 | 62.3 | 26.4 | NA | 2.8 | 26.4 |
| (R457C) | | | | | | | | |

TABLE E13G2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 13H—Vehicle Heating with Ambient Between −15° C. and 5° C. With Battery Charging or Driving-Evaporative Heat Source 12: PTC at OHE Using R457D

In this example, a system of the present invention configured for operation to heat cabin air during periods of low ambient temperatures is illustrated in FIG. 15. This system is operated with R1234yf and with RE1B8 and produces the results as reported in the following Table E13H1. The use of Refrigerant RE1B8 (R457D) is reported in Table E13H2 below by using bold type as an indicator for acceptable operation at the indicated locations and for indicated ambient conditions when using the identified evaporative heat source(s).

TABLE E13H1
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B8 | 62.3 | NA | −7.27 | 62.3 | 24.5 | NA | 2.6 | 24.5 |
| (R457D) | | | | | | | | |

TABLE E13H2
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 14A—Vehicle Heating with Ambient Between −15° C. and 5° C.—Evaporative Heat Source 13: Motor, Inverter and PTC at OHE Using R454C

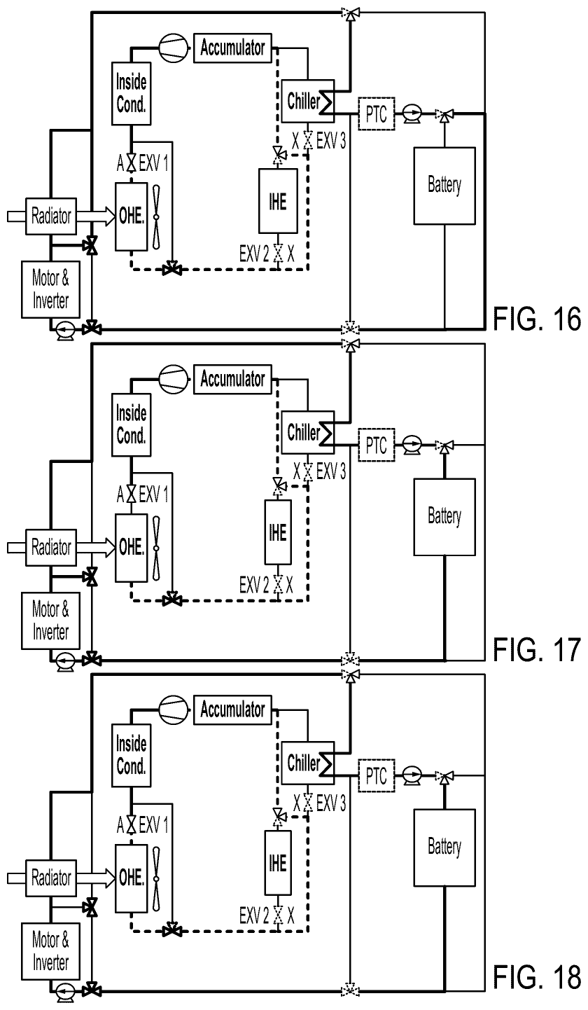

In this example, a system of the present invention configured for operation to heat cabin air during periods of low ambient temperatures is illustrated in FIG. 16 and is operated with R1234yf and with REIB1. The use of Refrigerant REIB1 (R454C) is reported in Table E14A below by using bold type as an indicator for acceptable operation at the indicated locations and for indicated ambient conditions when using the identified evaporative heat source(s).

TABLE E14A
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14B—Vehicle Heating with Ambient Between −15° C. and 5° C.—Evaporative Heat Source 13: Motor, Inverter and PTC at OHE

In this example, a system of the present invention configured for operation to heat cabin air during periods of low ambient temperatures is illustrated in FIG. 16 and is operated with R1234yf and with RE1B2. The use of Refrigerant RE1B2 (R455A) is reported in Table E14B below by using bold type as an indicator for acceptable operation at the indicated locations and for indicated ambient conditions when using the identified evaporative heat source(s).

TABLE E14B
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14C—Vehicle Heating with Ambient Between −15° C. and 5° C.—Evaporative Heat Source 13: Motor, Inverter and PTC at OHE Using R474A

In this example, a system of the present invention configured for operation to heat cabin air during periods of low ambient temperatures is illustrated in FIG. 16 and is operated with R1234yf and with RE1B3. The use of Refrigerant RE1B3 (R474A) is reported in Table E14C below by using bold type as an indicator for acceptable operation at the indicated locations and for indicated ambient conditions when using the identified evaporative heat source(s).

TABLE E14C
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14D—Vehicle Heating with Ambient Between −15° C. and 5° C.—Evaporative Heat Source 13: Motor, Inverter and PTC at OHE Using R474B

In this example, a system of the present invention configured for operation to heat cabin air during periods of low ambient temperatures is illustrated in FIG. 16 and is operated with R1234yf and with RE1B4. The use of Refrigerant RE1B4 (R474B) is reported in Table E14D below by using bold type as an indicator for acceptable operation at the indicated locations and for indicated ambient conditions when using the identified evaporative heat source(s).

TABLE E14D
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14E—Vehicle Heating with Ambient Between −15° C. and 5° C.—Evaporative Heat Source 13: Motor, Inverter and PTC at OHE Using R516A

In this example, a system of the present invention configured for operation to heat cabin air during periods of low ambient temperatures is illustrated in FIG. 16 and is operated with R1234yf and with RE1B5. The use of Refrigerant RE1B5 (R516A) is reported in Table E14E below by using bold type as an indicator for acceptable operation at the indicated locations and for indicated ambient conditions when using the identified evaporative heat source(s).

TABLE E14E
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14F—Vehicle Heating with Ambient Between −15° C. and 5° C.—Evaporative Heat Source 13: Motor, Inverter and PTC at OHE Using R444A

In this example, a system of the present invention configured for operation to heat cabin air during periods of low ambient temperatures is illustrated in FIG. 16 and is operated with R1234yf and with RE1B6. The use of Refrigerant RE1B6 (R444A) is reported in Table E14F below by using bold type as an indicator for acceptable operation at the indicated locations and for indicated ambient conditions when using the identified evaporative heat source(s).

TABLE E14F
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14G—Vehicle Heating with Ambient Between −15° C. and 5° C.—Evaporative Heat Source 13: Motor, Inverter and PTC at OHE Using R457C

In this example, a system of the present invention configured for operation to heat cabin air during periods of low ambient temperatures is illustrated in FIG. 16 and is operated with R1234yf and with RE1B7. The use of Refrigerant RE1B7 (R457C) is reported in Table E14G below by using bold type as an indicator for acceptable operation at the indicated locations and for indicated ambient conditions when using the identified evaporative heat source(s).

TABLE E14G
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 14H—Vehicle Heating with Ambient Between −15° C. and 5° C.—Evaporative Heat Source 13: Motor, Inverter and PTC at OHE Using R457D

In this example, a system of the present invention configured for operation to heat cabin air during periods of low ambient temperatures is illustrated in FIG. 16 and is operated with R1234yf and with RE1B8. The use of Refrigerant RE1B8 (R457D) is reported in Table E14H below by using bold type as an indicator for acceptable operation at the indicated locations and for indicated ambient conditions when using the identified evaporative heat source(s).

TABLE E14H
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 15A—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with REIB1. The use of Refrigerant RE1B1 (R454C) is reported in Table E15A below by using bold type as an indicator for acceptable operation at the indicated locations and for indicated ambient conditions when using the identified evaporative heat source(s).

TABLE E15A
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15B—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B2. The use of Refrigerant RE1B2 (R455A) is reported in Table E15B below by using bold type as an indicator for acceptable operation at the indicated locations and for indicated ambient conditions when using the identified evaporative heat source(s).

TABLE E15B
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15C—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B3. The use of Refrigerant RE1B3 (R474A) is reported in Table E15C below by using bold type as an indicator for acceptable operation at the indicated locations and for indicated ambient conditions when using the identified evaporative heat source(s).

TABLE E15C
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15D—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B4. The use of Refrigerant RE1B4 (R474B) is reported in Table E15D below by using bold type as an indicator for acceptable operation at the indicated locations and for indicated ambient conditions when using the identified evaporative heat source(s).

TABLE E15D
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15E—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B5. The use of Refrigerant RE1B5 (R516A) is reported in Table E15E below by using bold type as an indicator for acceptable operation at the indicated locations and for indicated ambient conditions when using the identified evaporative heat source(s).

TABLE E15E
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15F—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B6. The use of Refrigerant RE1B6 (R444A) is reported in Table E15F below by using bold type as an indicator for acceptable operation at the indicated locations and for indicated ambient conditions when using the identified evaporative heat source(s).

TABLE E15F
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15G—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B7. The use of Refrigerant RE1B7 (R457C) is reported in Table E15G below by using bold type as an indicator for acceptable operation at the indicated locations and for indicated ambient conditions when using the identified evaporative heat source(s).

TABLE E15G
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 15H—Vehicle Heating with Ambient Between −15° C. and 5° C. With Battery Charging-Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B8. The use of Refrigerant RE1B8 (R457D) is reported in Table E15H below by using bold type as an indicator for acceptable operation at the indicated locations and for indicated ambient conditions when using the identified evaporative heat source(s).

TABLE E15H
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16A—Vehicle Heating with Ambient Between −15° C. and 15° C. With Component Warm Up-Evaporative Heat Source 15: Battery and PTC at OHE Using R454C

In this example, a system of the present invention is configured for operation to heat cabin air during periods of low ambient temperatures is illustrated in FIG. 18 and is operated with R1234yf and with RE1B1. The use of Refrigerant REIB1 (R454C) is reported in Table E16A below by using bold type as an indicator for acceptable operation at the indicated locations and for indicated ambient conditions when using the identified evaporative heat source(s).

TABLE E16A
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16B—Vehicle Heating with Ambient Between −15° C. and 15° C. With Component Warm Up-Evaporative Heat Source 15: Battery and PTC at OHE Using R455A

In this example, a system of the present invention is configured for operation to heat cabin air during periods of low ambient temperatures is illustrated in FIG. 18 and is operated with R1234yf and with RE1B2. The use of Refrigerant RE1B2 (R455A) is reported in Table E16B below by using bold type as an indicator for acceptable operation at the indicated locations and for indicated ambient conditions when using the identified evaporative heat source(s).

TABLE E16B
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16C—Vehicle Heating with Ambient Between-15° C. and 15° C. With Component Warm Up-Evaporative Heat Source 15: Battery and PTC at OHE Using R474A

In this example, a system of the present invention is configured for operation to heat cabin air during periods of low ambient temperatures is illustrated in FIG. 18 and is operated with R1234yf and with RE1B3. The use of Refrigerant RE1B3 (R474A) is reported in Table E16C below by using bold type as an indicator for acceptable operation at the indicated locations and for indicated ambient conditions when using the identified evaporative heat source(s).

TABLE E16C
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16D—Vehicle Heating with Ambient Between −15° C. and 15° C. With Component Warm Up-Evaporative Heat Source 15: Battery and PTC at OHE Using R474B

In this example, a system of the present invention is configured for operation to heat cabin air during periods of low ambient temperatures is illustrated in FIG. 18 and is operated with R1234yf and with RE1B4. The use of Refrigerant RE1B4 (R474B) is reported in Table E16D below by using bold type as an indicator for acceptable operation at the indicated locations and for indicated ambient conditions when using the identified evaporative heat source(s).

TABLE E16D
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16E—Vehicle Heating with Ambient Between −15° C. and 15° C. With Component Warm Up-Evaporative Heat Source 15: Battery and PTC at OHE Using R516A

In this example, a system of the present invention is configured for operation to heat cabin air during periods of low ambient temperatures is illustrated in FIG. 18 and is operated with R1234yf and with RE1B5. The use of Refrigerant RE1B5 (R516A) is reported in Table E16E below by using bold type as an indicator for acceptable operation at the indicated locations and for indicated ambient conditions when using the identified evaporative heat source(s).

TABLE E16E
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16F—Vehicle Heating with Ambient Between −15° C. and 15° C. With Component Warm Up-Evaporative Heat Source 15: Battery and PTC at OHE Using R444A

In this example, a system of the present invention is configured for operation to heat cabin air during periods of low ambient temperatures is illustrated in FIG. 18 and is operated with R1234yf and with REIB6. The use of Refrigerant RE1B2 (R444A) is reported in Table E16F below by using bold type as an indicator for acceptable operation at the indicated locations and for indicated ambient conditions when using the identified evaporative heat source(s).

TABLE E16F
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16G—Vehicle Heating with Ambient Between −15° C. and 15° C. With Component Warm Up-Evaporative Heat Source 15: Battery and PTC at OHE

In this example, a system of the present invention is configured for operation to heat cabin air during periods of low ambient temperatures is illustrated in FIG. 18 and is operated with R1234yf and with RE1B7. The use of Refrigerant RE1B7 (R457C) is reported in Table E16G below by using bold type as an indicator for acceptable operation at the indicated locations and for indicated ambient conditions when using the identified evaporative heat source(s).

TABLE E16G
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 16H—Vehicle Heating with Ambient Between −15° C. and 15° C. With Component Warm Up-Evaporative Heat Source 15: Battery and PTC at OHE Using R457D

In this example, a system of the present invention is configured for operation to heat cabin air during periods of low ambient temperatures is illustrated in FIG. 18 and is operated with R1234yf and with RE1B8. The use of Refrigerant RE1B4 (R457D) is reported in Table E16H below by using bold type as an indicator for acceptable operation at the indicated locations and for indicated ambient conditions when using the identified evaporative heat source(s).

TABLE E16H
Evaporative Heat Source 15: Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 17A—Vehicle Heating with Ambient Between −15° C. and 5° C.—Evaporative Heat Source 16: Radiator (Air) at Chiller Using R454C

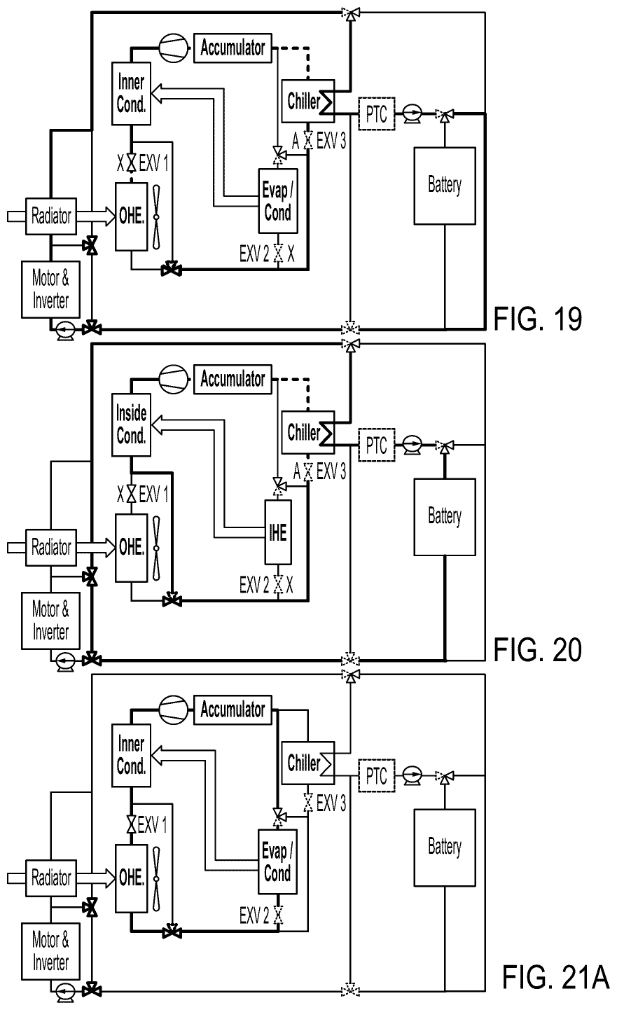

In this example, a system of the present invention is configured for operation to heat cabin air during periods of low ambient temperatures is illustrated in FIG. 19 and is operated with R1234yf and with RE1B1. The use of Refrigerant REIB1 (R454C) is reported in Table E17A below by using bold type as an indicator for acceptable operation at the indicated locations and for indicated ambient conditions when using the identified evaporative heat source(s).

TABLE E17A
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17B—Vehicle Heating with Ambient Between −15° C. and 5° C.—Evaporative Heat Source 16: Radiator (Air) at Chiller Using R455A

In this example, a system of the present invention is configured for operation to heat cabin air during periods of low ambient temperatures is illustrated in FIG. 19 and is operated with R1234yf and with RE1B2. The use of Refrigerant RE1B2 (R455A) is reported in Table E17B below by using bold type as an indicator for acceptable operation at the indicated locations and for indicated ambient conditions when using the identified evaporative heat source(s).

TABLE E17B
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17C—Vehicle Heating with Ambient Between −15° C. and 5° C.—Evaporative Heat Source 16: Radiator (Air) at Chiller Using R 474A

In this example, a system of the present invention is configured for operation to heat cabin air during periods of low ambient temperatures is illustrated in FIG. 19 and is operated with R1234yf and with REIB3. The use of Refrigerant REIB3 (R474A) is reported in Table E17C below by using bold type as an indicator for acceptable operation at the indicated locations and for indicated ambient conditions when using the identified evaporative heat source(s).

TABLE E17C
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17D—Vehicle Heating with Ambient Between −15° C. and 5° C.—Evaporative Heat Source 16: Radiator (Air) at Chiller Using R474B

In this example, a system of the present invention is configured for operation to heat cabin air during periods of low ambient temperatures is illustrated in FIG. 19 and is operated with R1234yf and with RE1B4. The use of Refrigerant RE1B4 (R474B) is reported in Table E17D below by using bold type as an indicator for acceptable operation at the indicated locations and for indicated ambient conditions when using the identified evaporative heat source(s).

TABLE E17D
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17E—Vehicle Heating with Ambient Between −15° C. and 5° C.—Evaporative Heat Source 16: Radiator (Air) at Chiller Using R 416A

In this example, a system of the present invention is configured for operation to heat cabin air during periods of low ambient temperatures is illustrated in FIG. 19 and is operated with R1234yf and with RE1B5. The use of Refrigerant RE1B5 (R416A) is reported in Table E17E below by using bold type as an indicator for acceptable operation at the indicated locations and for indicated ambient conditions when using the identified evaporative heat source(s).

TABLE E17E
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17F—Vehicle Heating with Ambient Between −15° C. and 5° C.—Evaporative Heat Source 16: Radiator (Air) at Chiller Using R444A

In this example, a system of the present invention is configured for operation to heat cabin air during periods of low ambient temperatures is illustrated in FIG. 19 and is operated with R1234yf and with RE1B6. The use of Refrigerant RE1B6 (R444A) is reported in Table E17E below by using bold type as an indicator for acceptable operation at the indicated locations and for indicated ambient conditions when using the identified evaporative heat source(s).

TABLE E17E
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17G—Vehicle Heating with Ambient Between −15° C. and 5° C.—Evaporative Heat Source 16: Radiator (Air) at Chiller Using R457C

In this example, a system of the present invention is configured for operation to heat cabin air during periods of low ambient temperatures is illustrated in FIG. 19 and is operated with R1234yf and with RE1B7. The use of Refrigerant RE1B7 (R457C) is reported in Table E17G below by using bold type as an indicator for acceptable operation at the indicated locations and for indicated ambient conditions when using the identified evaporative heat source(s).

TABLE E17G
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 17H—Vehicle Heating with Ambient Between −15° C. and 5° C.—Evaporative Heat Source 16: Radiator (Air) at Chiller

In this example, a system of the present invention is configured for operation to heat cabin air during periods of low ambient temperatures is illustrated in FIG. 19 and is operated with R1234yf and with RE1B8. The use of Refrigerant RE1B8 (R457D) is reported in Table E17H below by using bold type as an indicator for acceptable operation at the indicated locations and for indicated ambient conditions when using the identified evaporative heat source(s).

TABLE E17H
Evaporative Heat Source 16: Radiator (Air) at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 18A—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B1. The use of Refrigerant RE1B1 (R454C) is reported in Table E18A below by using bold type as an indicator for acceptable operation at the indicated locations and for indicated ambient conditions when using the identified evaporative heat source(s).

TABLE E18A
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18B—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B2. The use of Refrigerant RE1B2 (R455A) is reported in Table E18B below by using bold type as an indicator for acceptable operation at the indicated locations and for indicated ambient conditions when using the identified evaporative heat source(s).

TABLE E18B
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18C—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B3. The use of Refrigerant RE1B3 (R474A) is reported in Table E18C below by using bold type as an indicator for acceptable operation at the indicated locations and for indicated ambient conditions when using the identified evaporative heat source(s).

TABLE E18C
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18D—Vehicle Heating with Ambient Between-15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B4. The use of Refrigerant RE1B4 (R474B) is reported in Table E18D below by using bold type as an indicator for acceptable operation at the indicated locations and for indicated ambient conditions when using the identified evaporative heat source(s).

TABLE E18D
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18E—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B5. The use of Refrigerant RE1B5 (R516A) is reported in Table E18E below by using bold type as an indicator for acceptable operation at the indicated locations and for indicated ambient conditions when using the identified evaporative heat source(s).

TABLE E18E
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18F—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B6. The use of Refrigerant RE1B6 (R444A) is reported in Table E18F below by using bold type as an indicator for acceptable operation at the indicated locations and for indicated ambient conditions when using the identified evaporative heat source(s).

TABLE E18F
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18G—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B7. The use of Refrigerant RE1B7 (R457C) is reported in Table E18G below by using bold type as an indicator for acceptable operation at the indicated locations and for indicated ambient conditions when using the identified evaporative heat source(s).

TABLE E18G
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 18H—Vehicle Heating with Ambient Between −15° C. and 5° C. After Component Warm-Up-Evaporative Heat Source 17: Battery, Motor and Inverter at Chiller

In this example, a system of the present invention is configured for operation to heat cabin air during periods of low ambient temperatures is illustrated in FIG. 20 and is operated with R1234yf and with RE1B8. The use of Refrigerant RE1B8 (R457D) is reported in Table E18D below by using bold type as an indicator for acceptable operation at the indicated locations and for indicated ambient conditions when using the identified evaporative heat source(s).

TABLE E18H
Evaporative Heat Source 17: Battery, Motor and Inverter at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −15° C. and 15° C. after the motor and inverter and battery are warmed up and need (or can tolerate) some cooling. It can also be used to cool the motor and inverter and battery in warm weather.

### Example 19A1-De-humidification-Evaporative Heat Source 18: Dehumidification at Evaporator

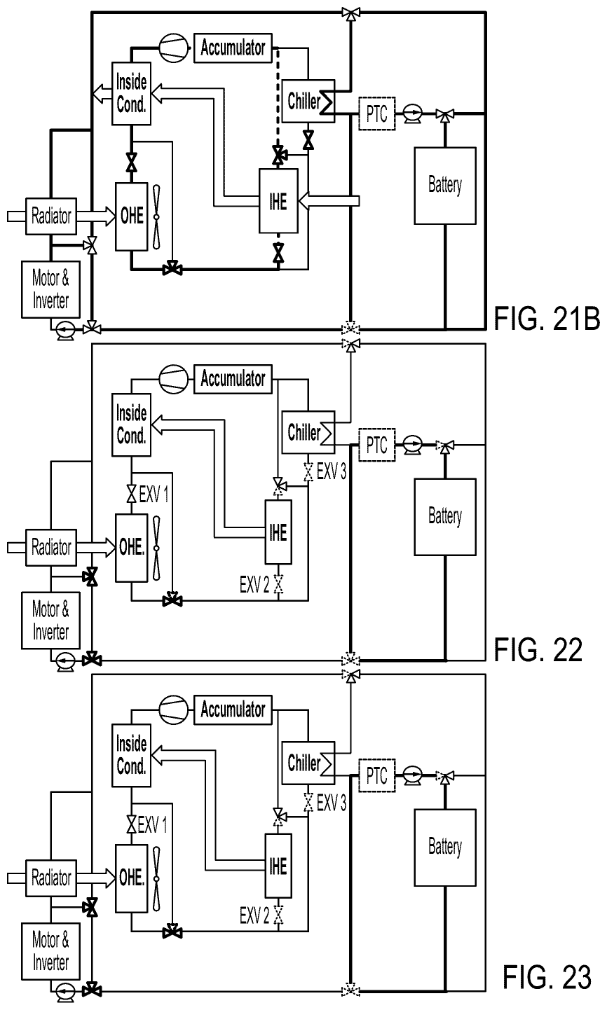

In this example, a system of the present invention configured for operation to heat cabin air during periods of normal ambient temperatures is illustrated in FIG. 21A. This system is operated with R1234yf and with RE1B1 and produces the results as reported in the following Table E19A11. The use of Refrigerant RE1B1 (R454C) is reported in Table E19A12 below by using bold type as an indicator for acceptable operation at the indicated locations and for indicated ambient conditions when using the identified evaporative heat source(s).

TABLE E19A11
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B1 | 25.0 | 17.04 | NA | 35.0 | 15.3 | NA | 7.8 | 15.3 |
| (R454C) | | | | | | | | |

TABLE E19A12
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19A2-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B2 and produces the results as reported in the following Table E19A21. The use of Refrigerant RE1B2 (R455A) is reported in Table E19A22 below by using bold type as an indicator for acceptable operation at the indicated locations and for indicated ambient conditions when using the identified evaporative heat source(s).

TABLE E19A21
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B2 | 25.0 | 17.04 | NA | 35.0 | 17.6 | NA | 8.3 | 17.6 |
| (R455A) | | | | | | | | |

TABLE E19A22
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Example 19A3-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B3 and produces the results as reported in the following Table E19A31. The use of Refrigerant RE1B3 (R474A) is reported in Table E19A32 below by using bold type as an indicator for acceptable operation at the indicated locations and for indicated ambient conditions when using the identified evaporative heat source(s).

TABLE E19A31
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B3 | 25.0 | 17.04 | NA | 35.0 | 13.7 | NA | 7.3 | 13.7 |
| (R474A) | | | | | | | | |

TABLE E19A32
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19A4-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B4 and produces the results as reported in the following Table E19A41. The use of Refrigerant RE1B4 (R474B) is reported in Table E19A42 below by using bold type as an indicator for acceptable operation at the indicated locations and for indicated ambient conditions when using the identified evaporative heat source(s).

TABLE E19A41
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B4 | 25.0 | 17.04 | NA | 35.0 | 14.9 | NA | 8.0 | 14.9 |
| (R474B) | | | | | | | | |

TABLE E19A42
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19E1-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B5 and produces the results as reported in the following Table E19E1A. The use of Refrigerant RE1B5 (R516A) is reported in Table E19E1B below by using bold type as an indicator for acceptable operation at the indicated locations and for indicated ambient conditions when using the identified evaporative heat source(s).

TABLE E19E1A
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B5 | 25.0 | 17.04 | NA | 35.0 | 9.2 | NA | 5.5 | 9.2 |
| (R516A) | | | | | | | | |

TABLE E19E1B
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19F1-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B6 and produces the results as reported in the following Table E19F1A. The use of Refrigerant RE1B6 (R444A) is reported in Table E19F1A below by using bold type as an indicator for acceptable operation at the indicated locations and for indicated ambient conditions when using the identified evaporative heat source(s).

TABLE E19F1A
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B6 | 25.0 | 17.04 | NA | 35.0 | 10.6 | NA | 4.9 | 10.6 |
| (R444A) | | | | | | | | |

TABLE E19F1A
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Example 19G1-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B7 and produces the results as reported in the following Table E19G1A. The use of Refrigerant RE1B7 (R457C) is reported in Table E19G1B below by using bold type as an indicator for acceptable operation at the indicated locations and for indicated ambient conditions when using the identified evaporative heat source(s).

TABLE E19G1A
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B3 | 25.0 | 17.04 | NA | 35.0 | 11.4 | NA | 6.2 | 11.4 |
| (R457C) | | | | | | | | |

TABLE E19G1A
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19H1-De-humidification-Evaporative Heat Source 18: Dehumidification at Evaporator

In this example, a system of the present invention configured for operation to heat cabin air during periods of normal ambient temperatures is illustrated in FIG. 21A. This system is operated with R1234yf and with RE1B8 and produces the results as reported in the following Table E19H1A. The use of Refrigerant RE1B8 (R457D) is reported in Table E19H1A below by using bold type as an indicator for acceptable operation at the indicated locations and for indicated ambient conditions when using the identified evaporative heat source(s).

TABLE E19H1A
Temperature and pressure data for Ambient Temperature of 25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B8 | 25.0 | 17.04 | NA | 35.0 | 10.5 | NA | 5.9 | 10.5 |
| (R457D) | | | | | | | | |

TABLE E19H1A
Evaporative Heat Source 18: Dehumidification at Evaporator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19B1-De-humidification-Using Inside Condenser for Dehumidification Reheat

In this example, a system of the present invention is configured for operation to heat cabin air during periods of normal ambient temperatures is illustrated in FIG. 21B and is operated with RE1B1 (R454C).

### Example 19B2-De-humidification-Using Inside Condenser for Dehumidification Reheat

In this example, a system of the present invention is configured for operation to heat cabin air during periods of normal ambient temperatures is illustrated in FIG. 21B and is operated with RE1B2 (R455A).

### Example 19B3-De-humidification-Using Inside Condenser for Dehumidification Reheat

In this example, a system of the present invention is configured for operation to heat cabin air during periods of normal ambient temperatures is illustrated in FIG. 21B and is operated with RE1B3 (R474A).

### Example 19B4-De-humidification-Using Inside Condenser for Dehumidification Reheat

In this example, a system of the present invention is configured for operation to heat cabin air during periods of normal ambient temperatures is illustrated in FIG. 21B and is operated with RE1B4 (R474B).

### Example 19B5-De-humidification-Using Inside Condenser for Dehumidification Reheat

In this example, a system of the present invention is configured for operation to heat cabin air during periods of normal ambient temperatures is illustrated in FIG. 21B and is operated with RE1B5 (R516A).

### Example 19B6-De-humidification-Using Inside Condenser for Dehumidification Reheat

In this example, a system of the present invention is configured for operation to heat cabin air during periods of normal ambient temperatures is illustrated in FIG. 21B and is operated with RE1B6 (R444A).

### Example 19B7-De-humidification-Using Inside Condenser for Dehumidification Reheat

In this example, a system of the present invention is configured for operation to heat cabin air during periods of normal ambient temperatures is illustrated in FIG. 21B and is operated with RE1B7 (R457C).

### Example 19B8-De-humidification-Using Inside Condenser for Dehumidification Reheat

In this example, a system of the present invention is configured for operation to heat cabin air during periods of normal ambient temperatures is illustrated in FIG. 21B and is operated with RE1B8 (R457D).

### Examples 20-27

In addition to the evaporative heat source flexibility provided by the present invention, several energy saving, warming and cooling configurations are advantageously provided.

The configurations shown on the following page show energy saving opportunities for many conditions.
Warming the battery with self-heating
Warming the battery with PTC heating
Warming the motor and inverter with self-heating
Warming the motor and inverter with PTC
Warming the battery, motor and inverter with self-heating
Warming the battery, motor and inverter with PTC
Cooling the motor and inverter at the radiator Cooling the motor and inverter @ the radiator (Battery @ chiller)
Cooling the battery at the radiator
Cooling the motor, inverter and battery at the radiator

### Example 20A—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B1.

The use of Refrigerant RE1B1 (R454C) is reported in Table E20A below by using bold type as an indicator for acceptable operation at the indicated locations and for indicated ambient conditions when using the identified evaporative heat source(s).

TABLE E20A
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20B—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B2.

The use of Refrigerant RE1B2 (R455A) is reported in Table E20B below by using bold type as an indicator for acceptable operation at the indicated locations and for indicated ambient conditions when using the identified evaporative heat source(s).

TABLE E20B
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20C—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B3.

The use of Refrigerant RE1B3 (R474A) is reported in Table E20C below by using bold type as an indicator for acceptable operation at the indicated locations and for indicated ambient conditions when using the identified evaporative heat source(s).

TABLE E20C
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20D—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B4.

The use of Refrigerant RE1B4 (R474B) is reported in Table E20D below by using bold type as an indicator for acceptable operation at the indicated locations and for indicated ambient conditions when using the identified evaporative heat source(s).

TABLE E20D
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20E—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B5.

The use of Refrigerant RE1B5 (R516A) is reported in Table E20E below by using bold type as an indicator for acceptable operation at the indicated locations and for indicated ambient conditions when using the identified evaporative heat source(s).

TABLE E20E
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20F—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B6.

The use of Refrigerant RE1B6 (R444A) is reported in Table E20F below by using bold type as an indicator for acceptable operation at the indicated locations and for indicated ambient conditions when using the identified evaporative heat source(s).

TABLE E20F
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20G—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B7.

The use of Refrigerant RE1B7 (R457C) is reported in Table E20G below by using bold type as an indicator for acceptable operation at the indicated locations and for indicated ambient conditions when using the identified evaporative heat source(s).

TABLE E20G
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 20H—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B8.

The use of Refrigerant RE1B8 (R457D) is reported in Table E20H below by using bold type as an indicator for acceptable operation at the indicated locations and for indicated ambient conditions when using the identified evaporative heat source(s).

TABLE E20H
Warming the Battery (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 21A—Batter Heating—Very Cold Ambient—Warming the Battery with PTC

In this example, a system of the present invention configured for operation to heat cabin air during periods of very low ambient temperatures is illustrated in FIG. 23 and is operated with REIB1. The use of Refrigerant RE1B1 (R454C) is reported in Table E21A below by using bold type as an indicator for acceptable operation at the indicated locations and for indicated ambient conditions when using the identified evaporative heat source(s).

TABLE E21A
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21B—Batter Heating—Very Cold Ambient—Warming the Battery with PTC

In this example, a system of the present invention configured for operation to heat cabin air during periods of very low ambient temperatures is illustrated in FIG. 23 and is operated with RE1B2. The use of Refrigerant RE1B2 (R455A) is reported in Table E21B below by using bold type as an indicator for acceptable operation at the indicated locations and for indicated ambient conditions when using the identified evaporative heat source(s).

TABLE E21B
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21C—Batter Heating—Very Cold Ambient—Warming the Battery with PTC

In this example, a system of the present invention configured for operation to heat cabin air during periods of very low ambient temperatures is illustrated in FIG. 23 and is operated with RE1B3. The use of Refrigerant RE1B3 (R474A) is reported in Table E21C below by using bold type as an indicator for acceptable operation at the indicated locations and for indicated ambient conditions when using the identified evaporative heat source(s).

TABLE E21C
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21D—Batter Heating—Very Cold Ambient—Warming the Battery with PTC

In this example, a system of the present invention configured for operation to heat cabin air during periods of very low ambient temperatures is illustrated in FIG. 23 and is operated with RE1B4. The use of Refrigerant RE1B4 (R474B) is reported in Table E21D below by using bold type as an indicator for acceptable operation at the indicated locations and for indicated ambient conditions when using the identified evaporative heat source(s).

TABLE E21D
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21E—Battery Heating—Very Cold Ambient—Warming the Battery with PTC

In this example, a system of the present invention configured for operation to heat cabin air during periods of very low ambient temperatures is illustrated in FIG. 23 and is operated with RE1B5. The use of Refrigerant RE1B5 (R516A) is reported in Table E2E1E below by using bold type as an indicator for acceptable operation at the indicated locations and for indicated ambient conditions when using the identified evaporative heat source(s).

TABLE E21E
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21F—Battery Heating—Very Cold Ambient—Warming the Battery with PTC

In this example, a system of the present invention configured for operation to heat cabin air during periods of very low ambient temperatures is illustrated in FIG. 23 and is operated with RE1B6. The use of Refrigerant RE1B6 (R444A) is reported in Table E21F below by using bold type as an indicator for acceptable operation at the indicated locations and for indicated ambient conditions when using the identified evaporative heat source(s).

TABLE E21F
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21G—Batter Heating—Very Cold Ambient—Warming the Battery with PTC

In this example, a system of the present invention configured for operation to heat cabin air during periods of very low ambient temperatures is illustrated in FIG. 23 and is operated with RE1B7. The use of Refrigerant RE1B7 (R457C) is reported in Table E21G below by using bold type as an indicator for acceptable operation at the indicated locations and for indicated ambient conditions when using the identified evaporative heat source(s).

TABLE E21G
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 21H—Batter Heating—Very Cold Ambient—Warming the Battery with PTC

In this example, a system of the present invention configured for operation to heat cabin air during periods of very low ambient temperatures is illustrated in FIG. 23 and is operated with RE1B8. The use of Refrigerant RE1B8 (R457D) is reported in Table E21H below by using bold type as an indicator for acceptable operation at the indicated locations and for indicated ambient conditions when using the identified evaporative heat source(s).

TABLE E21H
Warming the Battery with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 22A—Motor and Inverter Self Heating—Warming the Motor and Inverter (Self-Heating)

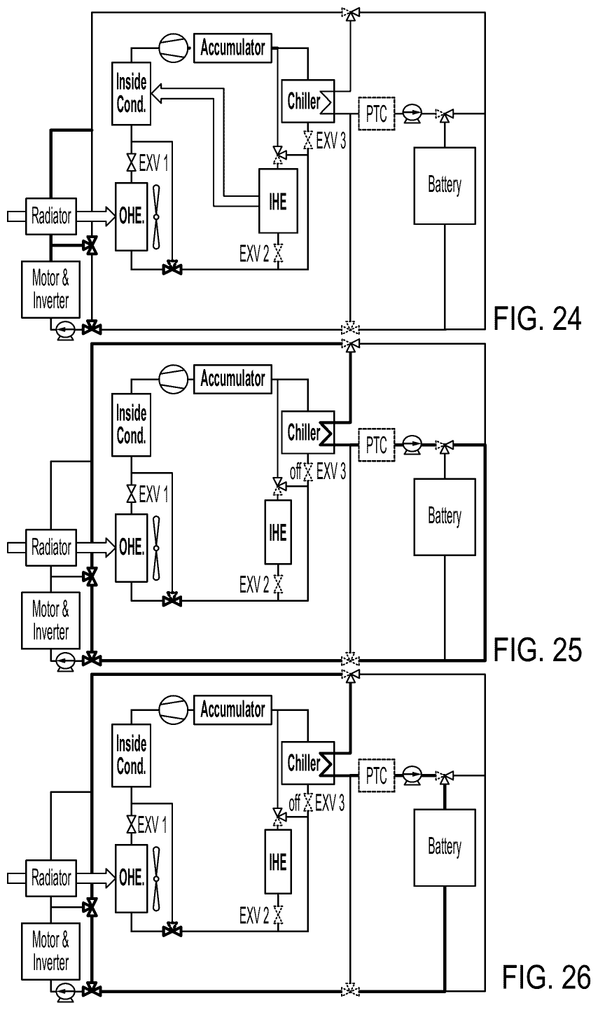

In this example, a system of the present invention configured for operation to heat cabin air during periods of low ambient temperatures is illustrated in FIG. 24 and is operated with RE1B1. The use of Refrigerant REIB1 (R454C) is reported in Table E22A below by using bold type as an indicator for acceptable operation at the indicated locations and for indicated ambient conditions when using the identified evaporative heat source(s).

TABLE E22A
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22B—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B2. The use of Refrigerant RE1B2 (R455A) is reported in Table E22B below by using bold type as an indicator for acceptable operation at the indicated locations and for indicated ambient conditions when using the identified evaporative heat source(s).

TABLE E22B
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22C—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B3. The use of Refrigerant RE1B3 (R474A) is reported in Table E22C below by using bold type as an indicator for acceptable operation at the indicated locations and for indicated ambient conditions when using the identified evaporative heat source(s).

TABLE E22C
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22C—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B4. The use of Refrigerant RE1B4 (R474B) is reported in Table E22D below by using bold type as an indicator for acceptable operation at the indicated locations and for indicated ambient conditions when using the identified evaporative heat source(s).

TABLE E22D
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22E—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B5. The use of Refrigerant RE1B5 (R516A) is reported in Table E22E below by using bold type as an indicator for acceptable operation at the indicated locations and for indicated ambient conditions when using the identified evaporative heat source(s).

TABLE E22E
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22F—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B6. The use of Refrigerant RE1B6 (R444A) is reported in Table E22F below by using bold type as an indicator for acceptable operation at the indicated locations and for indicated ambient conditions when using the identified evaporative heat source(s).

TABLE E22F
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22G—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B7. The use of Refrigerant RE1B7 (R457C) is reported in Table E22G below by using bold type as an indicator for acceptable operation at the indicated locations and for indicated ambient conditions when using the identified evaporative heat source(s).

TABLE E22G
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 22H—Motor and Inverter Self Heating—Warming the Motor and Inverter (Self-Heating)

In this example, a system of the present invention configured for operation to heat cabin air during periods of low ambient temperatures is illustrated in FIG. 24 and is operated with RE1B8. The use of Refrigerant RE1B8 (R457D) is reported in Table E22H below by using bold type as an indicator for acceptable operation at the indicated locations and for indicated ambient conditions when using the identified evaporative heat source(s).

TABLE E22H
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. Coolant can be circulated without removing heat.

### Example 23A—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B1. The use of Refrigerant RE1B1 (R454C) is reported in Table E23A below by using bold type as an indicator for acceptable operation at the indicated locations and for indicated ambient conditions when using the identified evaporative heat source(s).

TABLE E23A
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23B—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B2. The use of Refrigerant RE1B2 (R455A) is reported in Table E23B below by using bold type as an indicator for acceptable operation at the indicated locations and for indicated ambient conditions when using the identified evaporative heat source(s).

TABLE E23B
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23C—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B3. The use of Refrigerant RE1B3 (R474A) is reported in Table E23C below by using bold type as an indicator for acceptable operation at the indicated locations and for indicated ambient conditions when using the identified evaporative heat source(s).

TABLE E23C
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23D—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B4. The use of Refrigerant RE1B4 (R474B) is reported in Table E23D below by using bold type as an indicator for acceptable operation at the indicated locations and for indicated ambient conditions when using the identified evaporative heat source(s).

TABLE E23D
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23E—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B5. The use of Refrigerant RE1B5 (R516A) is reported in Table E23E below by using bold type as an indicator for acceptable operation at the indicated locations and for indicated ambient conditions when using the identified evaporative heat source(s).

TABLE E23E
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup.

This may improve vehicle efficiency after charging and just prior to drive start. Example 23F—Motor and Inverter Self Heating—Warming the Motor and Inverter (Self-Heating) In this example, a system of the present invention configured for operation to heat cabin air during periods of low ambient temperatures is illustrated in FIG. 25 and is operated with RE1B6. The use of Refrigerant RE1B6 (R444A) is reported in Table E23F below by using bold type as an indicator for acceptable operation at the indicated locations and for indicated ambient conditions when using the identified evaporative heat source(s).

TABLE E23F
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23G—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B7. The use of Refrigerant RE1B7 (R457C) is reported in Table E23G below by using bold type as an indicator for acceptable operation at the indicated locations and for indicated ambient conditions when using the identified evaporative heat source(s).

TABLE E23G
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 23H—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B8. The use of Refrigerant RE1B8 (R457D) is reported in Table E23H below by using bold type as an indicator for acceptable operation at the indicated locations and for indicated ambient conditions when using the identified evaporative heat source(s).

TABLE E23H
Warming the Motor and Inverter (Self-Heating)

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 24A—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B1.

The use of Refrigerant RE1B1 (R454C) is reported in Table E24A below by using bold type as an indicator for acceptable operation at the indicated locations and for indicated ambient conditions when using the identified evaporative heat source(s).

TABLE E24A
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24B—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B2. The use of Refrigerant RE1B2 (R455A) is reported in Table E24B below by using bold type as an indicator for acceptable operation at the indicated locations and for indicated ambient conditions when using the identified evaporative heat source(s).

TABLE E24B
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24C—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B3. The use of Refrigerant RE1B3 (R474A) is reported in Table E24C below by using bold type as an indicator for acceptable operation at the indicated locations and for indicated ambient conditions when using the identified evaporative heat source(s).

TABLE E24C
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24D—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B4. The use of Refrigerant RE1B4 (R474B) is reported in Table E24D below by using bold type as an indicator for acceptable operation at the indicated locations and for indicated ambient conditions when using the identified evaporative heat source(s).

TABLE E24D
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24E—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B5.

The use of Refrigerant RE1B5 (R516A) is reported in Table E24E below by using bold type as an indicator for acceptable operation at the indicated locations and for indicated ambient conditions when using the identified evaporative heat source(s).

TABLE E24E
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24F—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B6. The use of Refrigerant RE1B6 (R444A) is reported in Table E24F below by using bold type as an indicator for acceptable operation at the indicated locations and for indicated ambient conditions when using the identified evaporative heat source(s).

TABLE E24F
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24G—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B7. The use of Refrigerant RE1B7 (R457C) is reported in Table E24G below by using bold type as an indicator for acceptable operation at the indicated locations and for indicated ambient conditions when using the identified evaporative heat source(s).

TABLE E24G
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 24H—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B8. The use of Refrigerant RE1B8 (R457D) is reported in Table E24H below by using bold type as an indicator for acceptable operation at the indicated locations and for indicated ambient conditions when using the identified evaporative heat source(s).

TABLE E24H
Warming the Battery, Motor and Inverter with Self Heating

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. This would likely be used during charging until cooling is necessary for the battery. It could also be used during driving to warm the battery until the desired temperature is reached when the battery would be removed from the loop.

### Example 25A—Battery, Motor and Inverter Self Heating—Warming the Battery, Motor and Inverter with PTC

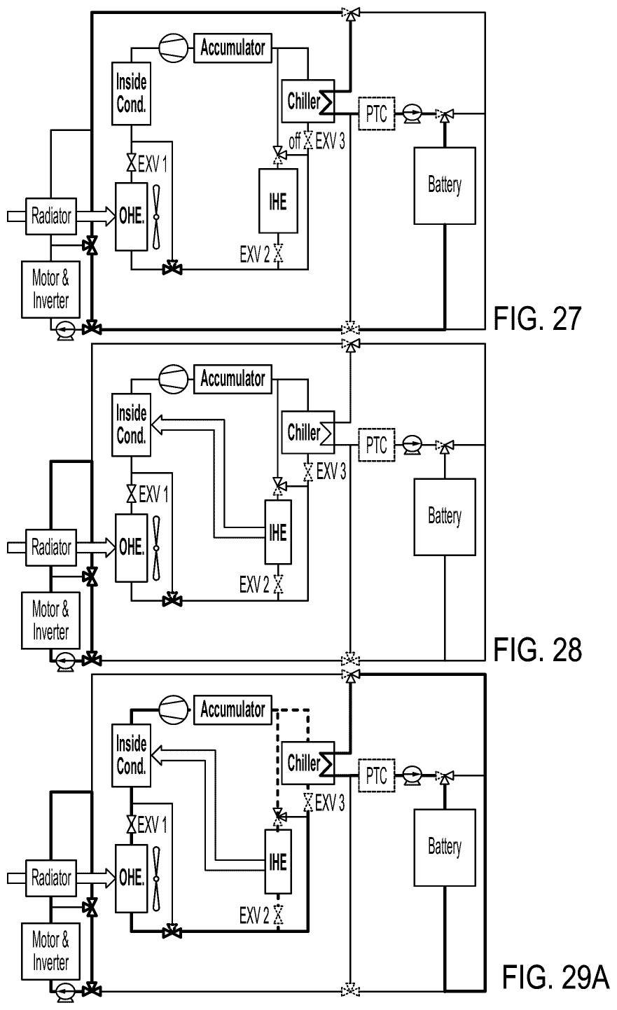

In this example, a system of the present invention configured for operation to heat cabin air during periods of low ambient temperatures is illustrated in FIG. 27 and is operated with RE1B1. The use of Refrigerant REIB1 (R454C) is reported in Table E25A below by using bold type as an indicator for acceptable operation at the indicated locations and for indicated ambient conditions when using the identified evaporative heat source(s).

TABLE E25A
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25B—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B2. The use of Refrigerant RE1B2 (R455A) is reported in Table E25B below by using bold type as an indicator for acceptable operation at the indicated locations and for indicated ambient conditions when using the identified evaporative heat source(s).

TABLE E25B
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25C—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B3. The use of Refrigerant RE1B3 (R474A) is reported in Table E25C below by using bold type as an indicator for acceptable operation at the indicated locations and for indicated ambient conditions when using the identified evaporative heat source(s).

TABLE E25C
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25D—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B4. The use of Refrigerant RE1B4 (R474B) is reported in Table E25D below by using bold type as an indicator for acceptable operation at the indicated locations and for indicated ambient conditions when using the identified evaporative heat source(s).

TABLE E25D
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25E—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B5. The use of Refrigerant RE1B5 (R516A) is reported in Table E25E below by using bold type as an indicator for acceptable operation at the indicated locations and for indicated ambient conditions when using the identified evaporative heat source(s).

TABLE E25RE
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25F—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B6. The use of Refrigerant RE1B6 (R444A) is reported in Table E25F below by using bold type as an indicator for acceptable operation at the indicated locations and for indicated ambient conditions when using the identified evaporative heat source(s).

TABLE E25F
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25G—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B7. The use of Refrigerant RE1B7 (R457C) is reported in Table E25G below by using bold type as an indicator for acceptable operation at the indicated locations and for indicated ambient conditions when using the identified evaporative heat source(s).

TABLE E25G
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 25H—Battery, Motor and Inverter Self Heating—Warming the Battery, Motor and Inverter with PTC

In this example, a system of the present invention configured for operation to heat cabin air during periods of low ambient temperatures is illustrated in FIG. 27 and is operated with RE1B8. The use of Refrigerant RE1B8 (R457D) is reported in Table E25H below by using bold type as an indicator for acceptable operation at the indicated locations and for indicated ambient conditions when using the identified evaporative heat source(s).

TABLE E25H
Warming the Battery, Motor and Inverter with PTC

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 26A—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B1. The use of Refrigerant REIB1 (R454C) is reported in Table E26A below by using bold type as an indicator for acceptable operation at the indicated locations and for indicated ambient conditions when using the identified evaporative heat source(s).

TABLE E26A
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26B—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B2. The use of Refrigerant RE1B2 (R455A) is reported in Table E26B below by using bold type as an indicator for acceptable operation at the indicated locations and for indicated ambient conditions when using the identified evaporative heat source(s).

TABLE E26B
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26C—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B3. The use of Refrigerant RE1B3 (R474A) is reported in Table E26C below by using bold type as an indicator for acceptable operation at the indicated locations and for indicated ambient conditions when using the identified evaporative heat source(s).

TABLE E26C
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26D—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B4. The use of Refrigerant RE1B4 (R474B) is reported in Table E26D below by using bold type as an indicator for acceptable operation at the indicated locations and for indicated ambient conditions when using the identified evaporative heat source(s).

TABLE E26D
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26E—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B5. The use of Refrigerant RE1B5 (R516A) is reported in Table E26E below by using bold type as an indicator for acceptable operation at the indicated locations and for indicated ambient conditions when using the identified evaporative heat source(s).

TABLE E26E
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26F—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B6. The use of Refrigerant RE1B6 (R444A) is reported in Table E26F below by using bold type as an indicator for acceptable operation at the indicated locations and for indicated ambient conditions when using the identified evaporative heat source(s).

TABLE E26F
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26G—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B7. The use of Refrigerant RE1B7 (R457C) is reported in Table E26G below by using bold type as an indicator for acceptable operation at the indicated locations and for indicated ambient conditions when using the identified evaporative heat source(s).

TABLE E26G
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 26H—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B8. The use of Refrigerant RE1B8 (R457D) is reported in Table E26H below by using bold type as an indicator for acceptable operation at the indicated locations and for indicated ambient conditions when using the identified evaporative heat source(s).

TABLE E26H
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 27A—Motor and Inverter Self Heating

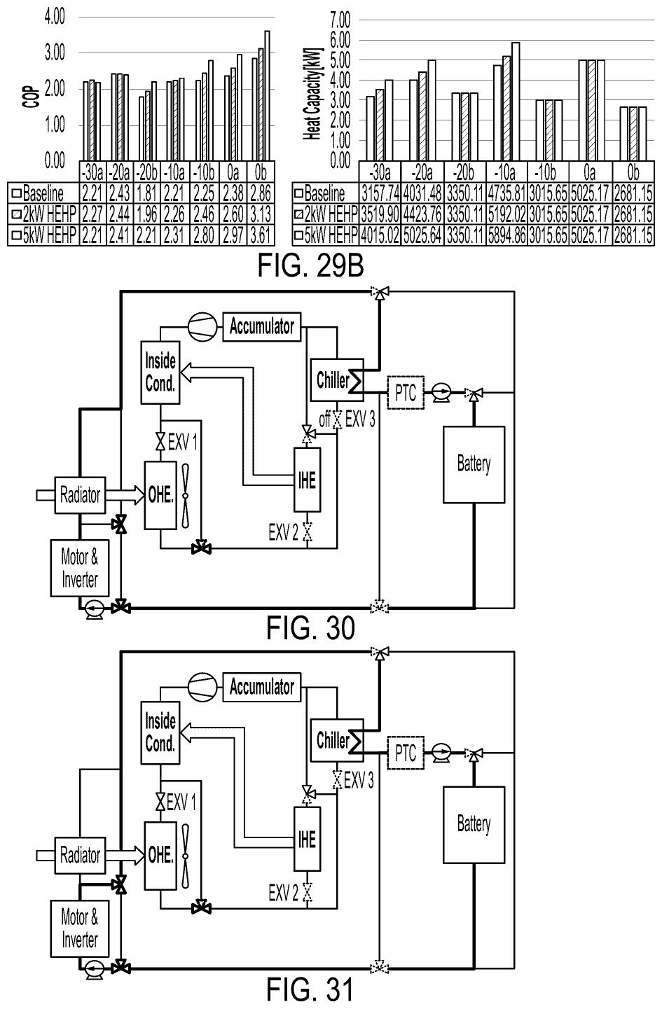

In this example, a system of the present invention configured for operation to heat cabin air during periods of low ambient temperatures is illustrated in FIG. 29A and is operated with RE1B1. The use of Refrigerant RE1B1 (R454C) is reported in Table E27A below by using bold type as an indicator for acceptable operation at the indicated locations and for indicated ambient conditions when using the identified evaporative heat source(s).

TABLE E27A
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

The COP and heat capacity of the system operating in three modes according to this example is approximated by the results shown in FIG. 29B.

### Example 27B—Motor and Inverter Self Heating

In this example, a system of the present invention configured for operation to heat cabin air during periods of low ambient temperatures is illustrated in FIG. 29A and is operated with RE1B2. The use of Refrigerant RE1B2 (R455A) is reported in Table E27B below by using bold type as an indicator for acceptable operation at the indicated locations and for indicated ambient conditions when using the identified evaporative heat source(s).

TABLE E27B
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

The COP and heat capacity of the system operating in three modes according to this example is approximated by the results shown in FIG. 29B.

### Example 27C—Motor and Inverter Self Heating

In this example, a system of the present invention configured for operation to heat cabin air during periods of low ambient temperatures is illustrated in FIG. 29A and is operated with RE1B3. The use of Refrigerant RE1B3 (R474A) is reported in Table E27C below by using bold type as an indicator for acceptable operation at the indicated locations and for indicated ambient conditions when using the identified evaporative heat source(s).

TABLE E27C
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

The COP and heat capacity of the system operating in three modes according to this example is approximated by the results shown in FIG. 29B.

### Example 27D—Motor and Inverter Self Heating

In this example, a system of the present invention configured for operation to heat cabin air during periods of low ambient temperatures is illustrated in FIG. 29A and is operated with RE1B4. The use of Refrigerant RE1B4 (R474B) is reported in Table E27D below by using bold type as an indicator for acceptable operation at the indicated locations and for indicated ambient conditions when using the identified evaporative heat source(s).

TABLE E27D
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

The COP and heat capacity of the system operating in three modes according to this example is approximated by the results shown in FIG. 29B.

### Example 27E—Motor and Inverter Self Heating

In this example, a system of the present invention configured for operation to heat cabin air during periods of low ambient temperatures is illustrated in FIG. 29A and is operated with RE1B5. The use of Refrigerant RE1B5 (R516A) is reported in Table E27E below by using bold type as an indicator for acceptable operation at the indicated locations and for indicated ambient conditions when using the identified evaporative heat source(s).

TABLE E27E
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

### Example 27F—Motor and Inverter Self Heating

In this example, a system of the present invention configured for operation to heat cabin air during periods of low ambient temperatures is illustrated in FIG. 29A and is operated with RE1B6. The use of Refrigerant RE1B6 (R444A) is reported in Table E27F below by using bold type as an indicator for acceptable operation at the indicated locations and for indicated ambient conditions when using the identified evaporative heat source(s).

TABLE E27F
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

### Example 27G—Motor and Inverter Self Heating

In this example, a system of the present invention configured for operation to heat cabin air during periods of low ambient temperatures is illustrated in FIG. 29A and is operated with RE1B7. The use of Refrigerant RE1B7 (R457C) is reported in Table E27G below by using bold type as an indicator for acceptable operation at the indicated locations and for indicated ambient conditions when using the identified evaporative heat source(s).

TABLE E27G
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

### Example 27H—Motor and Inverter Self Heating

In this example, a system of the present invention configured for operation to heat cabin air during periods of low ambient temperatures is illustrated in FIG. 29A and is operated with RE1B8. The use of Refrigerant RE1B8 (R457D) is reported in Table E27H below by using bold type as an indicator for acceptable operation at the indicated locations and for indicated ambient conditions when using the identified evaporative heat source(s).

TABLE E27H
Cooling the Motor and Inverter at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

### Example 28A—Battery Cooling—Cooling of the Battery at the Radiator

In this example, a system of the present invention configured for operation to heat cabin air during periods of low ambient temperatures is illustrated in FIG. 30 and is operated with RE1B1. The use of Refrigerant RE1B1 (R454C) is reported in Table E28A below by using bold type as an indicator for acceptable operation at the indicated locations and for indicated ambient conditions when using the identified evaporative heat source(s).

TABLE E28A
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28B—Battery Cooling—Cooling of the Battery at the Radiator

In this example, a system of the present invention configured for operation to heat cabin air during periods of low ambient temperatures is illustrated in FIG. 30 and is operated with RE1B2. The use of Refrigerant RE1B2 (R455A) is reported in Table E28B below by using bold type as an indicator for acceptable operation at the indicated locations and for indicated ambient conditions when using the identified evaporative heat source(s).

TABLE E28B
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28C—Battery Cooling—Cooling of the Battery at the Radiator

In this example, a system of the present invention configured for operation to heat cabin air during periods of low ambient temperatures is illustrated in FIG. 30 and is operated with RE1B3. The use of Refrigerant RE1B3 (R474A) is reported in Table E28C below by using bold type as an indicator for acceptable operation at the indicated locations and for indicated ambient conditions when using the identified evaporative heat source(s).

TABLE E28C
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28D—Battery Cooling—Cooling of the Battery at the Radiator

In this example, a system of the present invention configured for operation to heat cabin air during periods of low ambient temperatures is illustrated in FIG. 30 and is operated with RE1B4. The use of Refrigerant RE1B4 (R474B) is reported in Table E28D below by using bold type as an indicator for acceptable operation at the indicated locations and for indicated ambient conditions when using the identified evaporative heat source(s).

TABLE E28D
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28E—Battery Cooling—Cooling of the Battery at the Radiator

In this example, a system of the present invention configured for operation to heat cabin air during periods of low ambient temperatures is illustrated in FIG. 30 and is operated with RE1B5. The use of Refrigerant RE1B5 (R516A) is reported in Table E28E below by using bold type as an indicator for acceptable operation at the indicated locations and for indicated ambient conditions when using the identified evaporative heat source(s).

TABLE E28E
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28F—Battery Cooling—Cooling of the Battery at the Radiator

In this example, a system of the present invention configured for operation to heat cabin air during periods of low ambient temperatures is illustrated in FIG. 30 and is operated with RE1B6. The use of Refrigerant RE1B6 (R444A) is reported in Table E28F below by using bold type as an indicator for acceptable operation at the indicated locations and for indicated ambient conditions when using the identified evaporative heat source(s).

TABLE E28F
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28G—Battery Cooling—Cooling of the Battery at the Radiator

In this example, a system of the present invention configured for operation to heat cabin air during periods of low ambient temperatures is illustrated in FIG. 30 and is operated with RE1B7. The use of Refrigerant RE1B7 (R457C) is reported in Table E28G below by using bold type as an indicator for acceptable operation at the indicated locations and for indicated ambient conditions when using the identified evaporative heat source(s).

TABLE E28G
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 28H—Battery Cooling—Cooling of the Battery at the Radiator

In this example, a system of the present invention configured for operation to heat cabin air during periods of low ambient temperatures is illustrated in FIG. 30 and is operated with RE1B8. The use of Refrigerant RE1B8 (R457D) is reported in Table E28H below by using bold type as an indicator for acceptable operation at the indicated locations and for indicated ambient conditions when using the identified evaporative heat source(s).

TABLE E28H
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 29A—Battery, Motor and Inverter Self Heating-Cooling of the Battery at the Radiator

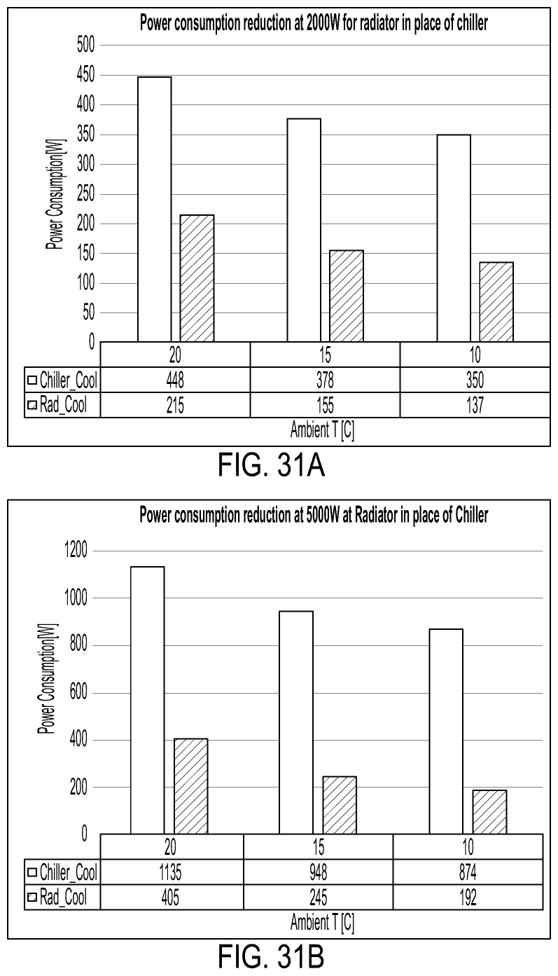

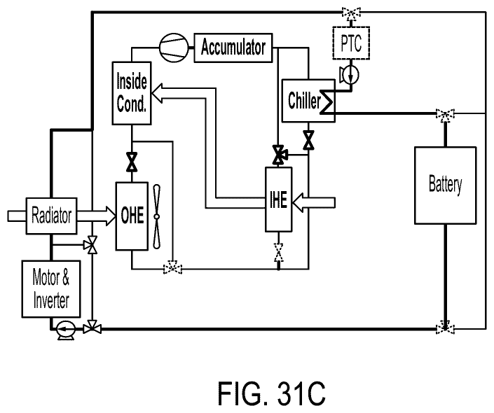

In this example, a system of the present invention configured for operation to heat cabin air during periods of low ambient temperatures is illustrated in FIG. 31 and is operated with RE1B1. The use of Refrigerant RE1B1 (R454C) is reported in Table E29A below by using bold type as an indicator for acceptable operation at the indicated locations and for indicated ambient conditions when using the identified evaporative heat source(s).

TABLE E29A
Cooling of the Battery at the Radiator

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29B—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B2. The use of Refrigerant RE1B2 (R455A) is reported in Table E29B below by using bold type as an indicator for acceptable operation at the indicated locations and for indicated ambient conditions when using the identified evaporative heat source(s).

TABLE E29B
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29C—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B3. The use of Refrigerant RE1B3 (R474A) is reported in Table E29C below by using bold type as an indicator for acceptable operation at the indicated locations and for indicated ambient conditions when using the identified evaporative heat source(s).

TABLE E29C
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29D—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B4. The use of Refrigerant RE1B4 (R474B) is reported in Table E29D below by using bold type as an indicator for acceptable operation at the indicated locations and for indicated ambient conditions when using the identified evaporative heat source(s).

TABLE E29D
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29E—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B5. The use of Refrigerant RE1B5 (R516A) is reported in Table E29E below by using bold type as an indicator for acceptable operation at the indicated locations and for indicated ambient conditions when using the identified evaporative heat source(s).

TABLE E29E
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29F—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B6. The use of Refrigerant RE1B6 (R444A) is reported in Table E29F below by using bold type as an indicator for acceptable operation at the indicated locations and for indicated ambient conditions when using the identified evaporative heat source(s).

TABLE E29F
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29G—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B7. The use of Refrigerant RE1B7 (R457C) is reported in Table E29G below by using bold type as an indicator for acceptable operation at the indicated locations and for indicated ambient conditions when using the identified evaporative heat source(s).

TABLE E29G
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 29H—Battery, Motor and Inverter Self Heating-Cooling of the Battery at the Radiator

In this example, a system of the present invention configured for operation to heat cabin air during periods of low ambient temperatures is illustrated in FIG. 31 and is operated with RE1B8. The use of Refrigerant RE1B8 (R457D) is reported in Table E29H below by using bold type as an indicator for acceptable operation at the indicated locations and for indicated ambient conditions when using the identified evaporative heat source(s).

TABLE E29H
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 30A—Embodiments—Enhanced Efficiency without Compressor—Cooling of the Battery at the Radiator

In this example, a system of the present invention configured for operation to heat cabin air during periods of low ambient temperatures as illustrated in FIG. 31 and is operated with RE1B1. The use of Refrigerant REIB1 (R454C) is reported in Table E30A below by using bold type as an indicator for acceptable operation at the indicated locations and for indicated ambient conditions when using the identified evaporative heat source(s).

TABLE E30A
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 31A and 31B.

### Example 30B—Embodiments—Enhanced Efficiency without Compressor—Cooling of the Battery at the Radiator

In this example, a system of the present invention configured for operation to heat cabin air during periods of low ambient temperatures as illustrated in FIG. 31C and in FIG. 3D is provided. In accordance with FIG. 3D, heat removal occurs at the radiator, that is, the relative positions of the of the second cooling pump and the radiator and the motor/inverter are configured to achieve overall improvement in system efficiency and at the same time providing excellent and preferred control of battery and motor/inverter temperatures. In particular, a second coolant pump is located down stream of the battery and upstream of the motor/inverter and directs the coolant through the radiator and back to the first liquid pump. In preferred embodiments, with piping and valving preferably arranged to allow the options of allowing at least a portion and possibly all (in which case the second liquid pump would not need to be in operation) of the coolant to be diverted around the motor inverter and directly to the radiator. In preferred embodiments, the coolant in such an arrangement is able to cool the battery to within a temperature range of about 25° C.-35° C. and to cool motor/inverter temperatures to within about 40° C. to about 65° C. For operation in which ambient air is at about 15° C., the coolant (preferably water/glycol) would exit the radiator and return to the first liquid pump (with the chiller and the PTC not operating as heat transfer devices in this mode) at a temperature of about 20° C. An exemplary version of this configuration is illustrated in FIG. 31C, showing the use of hot radiator air at the OHE and/or the IHE and/or the inner condenser in order to provide necessary heating to the cabin air.

In this example, the system is operated with RE1B2. The use of Refrigerant RE1B2 (R455A) is reported in Table E30B below by using bold type as an indicator for acceptable operation at the indicated locations and for indicated ambient conditions when using the identified evaporative heat source(s).

TABLE E30B
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 31A and 31B.

### Example 30C—Enhanced Efficiency without Compressor—Cooling of the Battery at the Radiator

In this example, a system of the present invention configured for operation to heat cabin air during periods of low ambient temperatures as illustrated in FIG. 31 and FIG. 3D1, and in particular showing heat removal at the radiator being in accordance with preferred embodiments. That is, the relative positions of the of the second cooling pump and the radiator and the motor/inverter achieve overall improvement in system efficiency and at the same time providing excellent and preferred control of battery and motor/inverter temperatures. In particular, a second coolant pump is located downstream of the battery and upstream of the motor/inverter and directs the coolant through the radiator and back to the first liquid pump. In preferred embodiments, with piping and valving preferably arranged to allow the options of allowing at least a portion and possibly all (in which case the second liquid pump would not need to be in operation) of the coolant to be diverted around the motor inverter and directly to the radiator. In preferred embodiments, the coolant in such an arrangement is able to cool the battery to within a temperature range of about 25° C.-35° C. and to cool motor/inverter temperatures to within about 40° C. to about 65° C. For operation in which ambient air is at about 15° C., the coolant (preferably water/glycol) would exit the radiator and return to the first liquid pump (with the chiller and the PTC not operating as heat transfer devices in this mode) at a temperature of about 20° C. An exemplary version of this configuration is illustrated in FIG. 31C, with the additional optional enhancement of using hot radiator air at the OHE and/or the IHE and/or the inner condenser in order to provide necessary heating to the cabin air. and is operated with RE1B3. The use of Refrigerant RE1B3 (R474A) is reported in Table E30C below by using bold type as an indicator for acceptable operation at the indicated locations and for indicated ambient conditions when using the identified evaporative heat source(s).

TABLE E30C
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 32A and 32B.

### Example 30D—Embodiments—Enhanced Efficiency without Compressor—Cooling of the Battery at the Radiator

In this example, a system of the present invention configured for operation to heat cabin air during periods of low ambient temperatures as illustrated in FIG. 31C, with heat removal at the radiator being adjusted in accordance with the configuration illustrated in FIG. 3D1 In particular, the relative positions of the of the second cooling pump and the radiator and the motor/inverter are changed to achieve overall improvement in system efficiency and at the same time providing excellent and preferred control of battery and motor/inverter temperatures. In particular, a second coolant pump is located downstream of the battery and upstream of the motor/inverter and directing the coolant through the radiator and back to the first liquid pump. In preferred embodiments, with piping and valving is preferably arranged to allow the options of allowing at least a portion and possibly all (in which case the second liquid pump would not need to be in operation) of the coolant to be diverted around the motor inverter and directly to the radiator. In preferred embodiments, the coolant in such an arrangement is able to cool the battery to within a temperature range of about 25° C.-35° C. and to cool motor/inverter temperatures to within about 40° C. to about 65° C. For operation in which ambient air is at about 15° C., the coolant (preferably water/glycol) would exit the radiator and return to the first liquid pump (with the chiller and the PTC not operating as heat transfer devices in this mode) at a temperature of about 20° C. An exemplary version of this configuration is illustrated in FIG. 31C, with the additional optional enhancement of using hot radiator air at the OHE and/or the IHE and/or the inner condenser in order to provide necessary heating to the cabin air. In this example the system is operated with RE1B4. The use of Refrigerant RE1B4 (R474B) is reported in Table E30D below by using bold type as an indicator for acceptable operation at the indicated locations and for indicated ambient conditions when using the identified evaporative heat source(s).

TABLE E30D
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 31A and 31B.

### Example 30E—Enhanced Efficiency without Compressor—Cooling of the Battery at the Radiator

In this example, a system of the present invention configured for operation to heat cabin air during periods of low ambient temperatures as illustrated in FIG. 31C and FIG. 3D1 and is operated with RE1B5. The use of Refrigerant RE1B5 (R516A) is reported in Table E30E below by using bold type as an indicator for acceptable operation at the indicated locations and for indicated ambient conditions when using the identified evaporative heat source(s).

TABLE E30E
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30A as shown in FIGS. 31A and 31B.

### Example 30F—Enhanced Efficiency without Compressor—Cooling of the Battery at the Radiator

In this example, a system of the present invention configured for operation to heat cabin air during periods of low ambient temperatures as illustrated in FIG. 31C and FIG. 3D1 and is operated with RE1B6. The use of Refrigerant RE1B2 (R444A) is reported in Table E30F below by using bold type as an indicator for acceptable operation at the indicated locations and for indicated ambient conditions when using the identified evaporative heat source(s).

TABLE E30F
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30B as shown in FIGS. 31A and 31B.

### Example 30G—Enhanced Efficiency without Compressor—Cooling of the Battery at the Radiator

In this example, a system of the present invention configured for operation to heat cabin air during periods of low ambient temperatures as illustrated in FIG. 31C and FIG. 3D1 and is operated with RE1B7. The use of Refrigerant RE1B7 (R457C) is reported in Table E30G below by using bold type as an indicator for acceptable operation at the indicated locations and for indicated ambient conditions when using the identified evaporative heat source(s).

TABLE E30G
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 31A and 31B.

### Example 30H—Embodiments—Enhanced Efficiency without Compressor—Cooling of the Battery at the Radiator

In this example, a system of the present invention configured for operation to heat cabin air during periods of low ambient temperatures as illustrated in FIG. 31C and FIG. 3D1 and is operated with RE1B8. The use of Refrigerant RE1B8 (R457D) is reported in Table E30H below by using bold type as an indicator for acceptable operation at the indicated locations and for indicated ambient conditions when using the identified evaporative heat source(s).

TABLE E30H
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 31A and 31B.

What is claimed is:

1. A heat transfer system to alternatively and/or simultaneously provide heating and/or cooling in a mobile vehicle that includes an electrical power source requiring heating and/or cooling during charging and/or operation and that includes a cabin that requires heat input during low temperature ambient conditions, said system comprising:
a) a vapor compression refrigeration circuit located in said mobile vehicle comprising:
(i) a heat transfer composition comprising a first refrigerant,
(ii) a compressor for compressing said first refrigerant in the vapor state from a first pressure to a higher second pressure,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first OCE connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first OCE and downstream of said outside heat exchanger for selectively routing said refrigerant from said inner condenser and/or from said outside heat exchanger (1) around said first expansion device and to either (A) a second OCE fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first OCE operating in the expansion mode through said outside heat exchanger; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

2. The system of claim 1 wherein said first refrigerant comprises 2,3,3,3-tetrafluoropropene (R1234yf).

3. The system of claim 2 wherein said first refrigerant further comprises from about 20% to about 35% by weight of a second component selected from R32, R134a, R1132E, CO₂ and combinations of two or more of these.

4. The system of claim 1 wherein said first refrigerant comprises trans-1,3,3,3-tetrafluoropropene (R1234ze(E)).

5. The system of claim 1 wherein said first refrigerant comprises from about 65% to about 80% by weight of 2,3,3,3-tetrafluoropropene (R1234yf) and from about 20% to about 35% by weight of a second component selected from R32, R1132E and combinations of these.

6. The system of claim 1 further comprising a refrigerant accumulator, wherein said compressor is being connected upstream to said refrigerant accumulator.

7. The system of claim 1 wherein said refrigerant comprises R-1234yf and R32.

8. The system of claim 1 wherein said refrigerant comprises from about 75% to about 89% by weight of R-1234yf and about 21% by weight of R32.

9. The system of claim 8 wherein said refrigerant further comprises CO₂.

10. The system of claim 1 wherein said refrigerant comprises R-1234yf and R1132(E).

11. The system of claim 1 wherein said refrigerant comprises about 23% by weight of R1132(E).

12. The system of claim 1 wherein the heat exchange network comprises a coolant circuit that comprises a coolant that absorbs waste heat from an electrical power source located in said vehicle during low temperature ambient conditions and rejects heat to said refrigerant in said chiller.

13. A mobile vehicle having one or more electric traction motors and one or more batteries and/or capacitors providing electric current to said one or more traction motors comprising a heat transfer system carried by said mobile vehicle to alternatively and/or simultaneously provide heating and cooling in said mobile vehicle, wherein heating and/or cooling is provided to said one or more batteries and/or capacitors during charging and/or operation and that includes a cabin that requires heat input during low temperature ambient conditions, wherein said heat transfer system comprises:
a) a vapor compression refrigeration circuit located in said mobile vehicle comprising:
(i) a first refrigerant comprising from about 65% to about 80% by weight of 2,3,3,3-tetrafluoropropene (R1234yf) and from about 20% to about 35% by weight of a second component selected from R32, R1132E and combinations of these,
(ii) a compressor for compressing said first refrigerant in the vapor state from a first pressure to a higher second pressure, said compressor being connected upstream to a refrigerant accumulator,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

14. The system of claim 13 wherein said refrigerant comprises R-1234yf and R32.

15. The system of claim 13 wherein said refrigerant comprises from about 75% to about 89% by weight of R-1234yf and about 21% by weight of R32.

16. The system of claim 15 wherein said refrigerant further comprises CO₂, vehicle.

17. The system of claim 13 wherein said refrigerant comprises R-1234yf and R1132(E).

18. The system of claim 13 wherein said refrigerant comprises about 23% by weight of R1132(E).

19. The system of claim 13 wherein said refrigerant comprises R-1234ze(E).

20. The system of claim 13 wherein the heat exchange network comprises a coolant circuit that comprises a coolant that absorbs waste heat from an electrical power source located in said vehicle during low temperature ambient conditions and rejects heat to said refrigerant in said chiller.
